(19) United States
(12) Patent Application Publication
(10) Pub. No.: US 2007/0111692 A1
(43) Pub. Date: May 17, 2007

(54) RADIO-FREQUENCY RECEIVER DEVICE, RADIO-FREQUENCY COMMUNICATION DEVICE, AND INTERROGATOR

(76) Inventors: Katsuyuki Kuramoto, Mizuho-ku, Nagoya-shi, Aichi-ken (JP); Takuya Nagai, Mizuho-ku, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/611,742

(22) Filed: Dec. 15, 2006

Related U.S. Application Data
(63) Continuation-in-part of application No. PCT/JP05/08922, filed on May 16, 2005.

(30) Foreign Application Priority Data
Jun. 15, 2004 (JP) 2004-176437
Jun. 16, 2004 (JP) 2004-178043
Jul. 27, 2004 (JP) 2004-218924

(51) Int. Cl. H04B 1/06; H04B 7/00

(52) U.S. Cl. 455/277.1

(57) ABSTRACT

A radio-frequency receiver device including a plurality of receiver antenna elements for receiving information from a desired communication object, the radio-frequency receiver device including an antenna switching portion configured to select at least one of the plurality of receiver antenna elements which receives a set of information transmitted from the desired communication object, a received-information memory portion configured to store sets of information received by the plurality of receiver antenna elements sequentially selected by the antenna switching portion, and a received-information combining portion configured to read out the sets of information from the received-information memory portion, and to combine together the read out sets of information read out from the received-information memory portion.

The present application is a Continuation-in-Part of International Application No. PCT/JP2005/008922 filed May 16, 2005, which claims the benefits of Japanese Patent Application Nos. 2004-176437, 2004-178043 and 2004-218924 which were respectively filed Jun. 15, Jun. 16 and Jul. 27, 2004.

### BACKGROUND OF THE INVENTION

1. Field of the Invention

The present invention relates to improvements of a radio-frequency receiver device provided with a plurality of antenna elements arranged to receive a signal transmitted from a desired communication object, a radio-frequency communication device operable for radio communication with an external device, and an interrogator in a radio-frequency communication system such as a radio-frequency tag communication system.

2. Description of the Related Art

There is known a radio-frequency identification system (an RFID system) including small-sized radio-frequency tags (transponders) storing predetermined information, and a radio-frequency tag communication device (interrogator) arranged to read desired information from the radio-frequency tags in a non-contact fashion. The radio-frequency communication device of this RFID system is capable of reading out the information from the radio-frequency tags, by radio communication with the radio-frequency tags, even where the radio-frequency tags are soiled or located at invisible places. For this reason, the RFID system is expected to be used in various fields such as management and inspection of commodities.

Such a radio-frequency tag communication device includes a radio-frequency receiver device provided with a plurality of receiver antenna elements arranged to receive signals transmitted from communication objects in the form of radio-frequency tags. The radio-frequency receiver device is operable to combine together the received signals and control the direction of reception of the signals from each radio-frequency tag. JP-2003-28341A and JP-2002-280945A (paragraphs 0036-0069, and FIG. 1) disclose examples of a method of control of the direction of reception of signals from each radio-frequency tag. In the method disclosed in these publications, the radio-frequency receiver device is provided with an array antenna device including a plurality of antenna elements, and an adaptive array processing portion operable to multiply the signal received by each of the receiver antenna elements, by a suitable weight, so that the direction of reception of the array antenna device is controlled to receive the signal from the desired communication object in the form of the desired radio-frequency tag.

An adaptive control implemented by the adaptive array processing portion requires information regarding the phase of the signals received by the respective receiver antenna elements, and therefore requires transformation of each received signal into a complex signal. Usually, the received signal is a digital signal consisting of only a real-number portion of a complex signal which consists of the real-number portion and an imaginary-number portion. Publication entitled “Digital Signal Processing in Communication systems”, Marvin E. Frerking, Kluwer Academic Publishers describes on pages 138-149 Hilbert transformation of the received signal, to generate the imaginary-number portion.

However, the conventional adaptive control technique requires receiver circuits the number of which is equal to the number of the receiver antenna elements. The conventional adaptive control technique further requires canceling circuits corresponding to the respective receiver antenna elements, to eliminate a leakage signal which is a part of a transmitted signal from a transmitter antenna device, which part is received by the receiver antenna elements. Accordingly, the radio-frequency receiver device tends to be complex in construction and to have a high cost of manufacture. Further, the conventional adaptive control technique requires a complicated processing such as the Hilbert transformation to generate the imaginary-number portion not included in the signals received by the receiver antenna elements. Accordingly, a central processing unit (CPU) of an interrogator used by the radio-frequency communication device or radio-frequency tag communication system is required to perform an excessively large volume of arithmetic operation and an accordingly long time for the arithmetic operation, which undesirably cause difficulty of control of the radio communication with the radio-frequency tags, and difficulty to improve the operating reliability of the radio-frequency tag communication device.

The above-described conventional arrangement to change a weight vector so as to reduce an error between the received signal demodulated by a demodulating circuit and a reference signal usually requires the demodulating circuit to be provided with a filter having a large number of taps, and accordingly requires a relatively long time for a filtering processing by the filter, undesirably causing a delay from the moment of reception of the signal by the receiver antenna element to the moment of generation of a decoded signal on the basis of the received signal, so that the updating interval of the weight is inevitably equal to or longer than a time length of the delay, unfavorably resulting in an increase of the time required for calculation of convergence of the weight. Where the received signal includes a comparatively short length of information identifying the desired radio-frequency tag, in particular, the adaptive array processing of the received signal may not be completed while the received information is active, so that there is a risk of failure to sufficiently accurately demodulate the received information. Thus, the conventional radio-frequency communication device does not have a high degree of operating reliability.

Namely, there have been needs of developing a radio-frequency receiver device including a plurality of receiver antenna elements for receiving signals transmitted from a desired communication object, a radio-frequency communication device capable of effecting radio communication with an external device, and an interrogator for a radio-frequency communication system such as a radio-frequency tag communication system, which receiver device, communication device and interrogator are simple in construction and are capable of effecting radio communication with the desired communication object with a high degree of operating reliability.

### SUMMARY OF THE INVENTION

The present invention was made in view of the background art described above. Accordingly, it is a first object of the present invention to provide a radio-frequency receiver device which is simple in construction and which is capable of effecting radio communication with a desired communication object with a high degree of operating reliability. It is a second object of the invention to provide a radio-frequency communication device which is simple in construction and which is capable of effecting radio communication with a desired communication object with a high degree of operating reliability. It is a third object of the invention to provide an interrogator which is simple in construction and which is capable of effecting radio communication with a desired communication object with a high degree of operating reliability.

The first object may be achieved according to any one of the following modes (1)-(9), and the second object may be achieved according to any one of the following modes (10)-(17), while the third object may be achieved according to any one of the following modes (18)-(36).

(1) A radio-frequency receiver device including a plurality of receiver antenna elements for receiving information from a desired communication object, the radio-frequency receiver device comprising (a) an antenna switching portion operable to select at least one of the plurality of receiver antenna elements which receives a set of information transmitted from the desired communication object, (b) a received-information memory portion operable to store sets of information received by the plurality of receiver antenna elements sequentially selected by the antenna switching portion, and (c) a received-information combining portion operable to read out the sets of information from the received-information memory portion, and to combine together the sets of information read out from the received-information memory portion.

In the radio-frequency receiver device according to the above-described mode (1) which includes the antenna switching portion, the received-information memory portion and the received-information combining portion, as described above, the sets of information are sequentially received by the sequentially selected receiver antenna elements, so that the required number of receiver circuits of the radio-frequency receiver device connected to the receiver antenna elements can be reduced. Accordingly, the present radio-frequency receiver device arranged to combine together the sequentially received sets of information can be simplified in construction, but is capable of controlling the directivity of reception of the sets of information.

(2) The radio-frequency receiver device according to the above-described mode (1), wherein the antenna switching portion selects one of the plurality of receiver antenna elements which receives the information from the desired communication objects at one time, so that the sets of information sequentially transmitted from the desired communication object are sequentially received by the plurality of receiver antenna elements.

In the above-described mode (2), the number of the receiver circuits required by the radio-frequency receiver device 35 can be minimized.

(3) The radio-frequency receiver device according to the above-described mode (1) or (2), the received-information combining portion includes a phase control portion operable to control a phase of each of the sets of information read out from the received-information memory portion, and is operable to effect a phased array processing of the sets of information. In this mode (3), the directivity of reception of the sets of information from the communication object can be effectively controlled.

(4) The radio-frequency receiver device according to the above-described mode (1) or (2), the received-information combining portion includes a weight control portion operable to control weights to be given to the sets of information read out from the received-information memory portion, and is operable to effect an adaptive array processing of the sets of information. In this mode (4), the directivity of reception of the sets of information from the communication object can be efficiently received.

(5) The radio-frequency receiver device according to any one of the above-described modes (1)-(4), the antenna switching portion sequentially selects the plurality of receiver antenna elements so that the sets of information sequentially transmitted from the desired communication objects are sequentially received by the sequentially selected receiver antenna elements. In this mode (5), composite information obtained by the received-information combining portion by combining together the sets of information sequentially received by the sequentially selected receiver antenna elements is equivalent to composite information obtained by combining together sets of information which are concurrently received by the receiver antenna elements.

(6) The radio-frequency receiver device according to any one of the above-described modes (1)-(5), the received-information memory portion stores sets of phase information included in the respective sets of information received by the plurality of receiver antenna elements. In this mode (6), the phase information is subjected to the adaptive array processing or a phased array processing, and the volume of information to be stored in the received-information memory portion can be reduced.

(7) The radio-frequency receiver device according to any one of the above-described modes (1)-(6), further comprising at least one receiver circuit operable to process the sets of information received by the plurality of receiver antenna elements, and wherein a number of the at least one receiver circuit is smaller than a number of the plurality of antenna elements. In this mode (7), the required number of the receiver circuit or circuits can be reduced, and the radio-frequency receiver device can be simplified in construction.

(8) The radio-frequency receiver device according to any one of the above-described modes (1)-(6), the at least one receiver circuit is a single receiver circuit. In this mode (8) wherein only one receiver circuit is connected to the plurality of receiver antenna elements, the radio-frequency receiver device can be most simplified in construction.

(9) The radio-frequency receiver device according to any one of the above-described modes (1)-(8), the desired communication object is a radio-frequency tag capable of transmitting a reply signal in response to a transmitted signal received from a radio-frequency communication device provided with the radio-frequency receiver device. In this mode (9), the radio-frequency receiver device included in the radio-frequency communication device operable for radio communication with the radio-frequency tag can be simplified in construction, but is capable of controlling the directivity of reception of the sets of information from the radio-frequency tag. In addition, the volume of information to be transmitted between the radio-frequency communication device and the radio-frequency tag can be reduced, and the length of time required for the radio communication by a plurality of number of times can be shortened. Further, the radio-frequency communication device can function as an interrogator which transmits an interrogating signal toward the radio-frequency tag at a plurality of different timings, so that a reply signal is transmitted from the radio-frequency tag in response to the interrogating signals, namely, at different timings of transmission of the interrogating signal from the interrogator.

(10) A radio-frequency communication device A radio-frequency communication device comprising: a plurality of antenna elements operable to receive in a non-contact fashion modulated signals which are transmitted from a signal transmitter device and which have a frequency f; a memory portion operable to sequentially sample sets of data of the modulated signal received by the plurality of antenna elements, or a signal converted from the modulated signal and having a frequency fi, at a rate of 4nf or 4nfi (where n is a positive integer), and sequentially store the sampled sets of data, such that the last sampled set of data and a preceding set of data sampled an n-number of sampling cycles prior to the last sampled set of data are readable from the memory portion; a transforming portion operable to obtain data of a complex signal by transformation from the last sampled set of data and the preceding set of data which are respectively used as a real-number portion and an imaginary-number portion of the complex signal; and a control portion operable to change a directivity of the plurality of antenna elements on the basis of the data of the complex signal obtained by the transforming portion, such that the plurality of antenna elements have a maximum sensitivity of reception of the modulated signal from the signal transmitter device.

Generally, a periodic waveform such as a sine wave has an imaginary-number portion the phase of which is delayed by 90° with respect to a real-number portion. Based on this property of the periodic waveform, the radio-frequency communication device according to the above-described mode (10) is arranged such that the memory portion sequentially samples sets of data of the received modulated signal at the rate of 4nf or 4nfi, and sequentially store the sampled sets of data, so that the last sampled set of data and the preceding set of data which has been sampled the n-number of sampling cycles prior to the last sampled set of data (the phase of which is delayed by 90° with respect to that of the last sampled set of data) are readable from the memory portion and applied to the transforming portion. The transforming portion is arranged to obtain data of the complex signal by transformation from the last sampled set of data and the preceding set of data which are respectively used as the real-number portion and the imaginary-number portion of the complex signal. The control portion is arranged to effect a so-called adaptive control of changing the directivity of the plurality of antenna elements on the basis of the data of the complex signal obtained by the transforming portion, such that the plurality of antenna elements have a maximum sensitivity of reception of the modulated signal from the signal transmitter device. The imaginary-number portion necessary for obtaining the complex signal data by transformation can be readily obtained by using the preceding set of data the phase of which is delayed by 90° with respect to that of the last sampled set of data. Thus, the present radio-frequency communication device does not require the conventional cumbersome signal processing technique such as the Hilbert transformation, so that the arithmetic operation required for controlling the directivity of reception of the antenna elements can be simplified, so that the required amount of arithmetic operation to be performed by a central processing unit serving as the memory portion, transforming portion and control portion, for example, can be reduced. Accordingly, the present radio-frequency communication device has a high degree of operating reliability.

(11) The radio-frequency communication device according to the above-described mode (10), wherein the control portion includes: a weight determining portion operable to receive a signal based on a composite signal obtained by combining together the sets of data stored in the memory portion, a predetermined target output signal and the data of the complex signal, and to determine weights to be given to the respective last sampled sets of data that are combined together to generate the composite signal, such that the generated composite signal approaches the target output signal; and a composite-signal generating portion operable to generate the composite signal by using the weights determined by the weight determining portion. In this mode (11), the weight determining portion determines the weights such that the composite signal generated by the composite-signal generating portion approaches the target output signal, and the composite-signal generating portion generates the composite signal by using the determined weights. The thus generated composite signal is fed back to the weight determining portion, so that the directivity of the plurality of antenna elements from the signal transmitter device can be changed to maximize the sensitivity of reception of the modulated signals from the signal transmitter device.

(12) The radio-frequency communication device according to the above-described mode (10) or (11), the memory portion is a shift register operable to store the last sampled set of data and the preceding set of data such that the last sampled and preceding sets of data are sequentially read out from the memory portion. In this mode (12), the last sampled set of data and the preceding set of data sampled n-number of sampling cycles prior to the last sampled set of data can be read out into the transforming portion.

(13) The radio-frequency communication device according to the above-described mode (10) or (11), the memory portion has a first memory portion and a second memory portion, which alternately perform a first operation wherein the last sampled set of data is stored in the first memory portion such that the last sampled set of data is read out into the transforming portion as the real-number portion of the complex signal, while the preceding set of data is stored in the second memory portion such that the preceding set of data is read out into the transforming portion as the imaginary-number portion of the complex signal, and a second operation wherein the last sampled set of data is stored in the second memory portion such that the last sampled set of data is read out into the transforming portion as the real-number portion, while the preceding set of data is stored in the first memory portion such that the preceding set of data is read out into said transforming portion as the imaginary-number portion. In this mode (13), the last sampled set of data stored in one of the first and second memory portions, and the preceding set of data stored in the other of the first and second memory portions are read out into the transforming portion, each time the last sampled set of data is stored in the first or second memory portion.

(14) The radio-frequency communication device according to the above-described mode (11), wherein the composite-signal generating portion generates the composite signal by using the last sampled sets of data and the weights determined by the weight determining portion. In this mode (14), the composite signal in the form of a real-number signal is generated from the last sampled sets of data in the form of the real-number signal, and the weights determined by the weight determining portions.

(15) The radio-frequency communication device according to the above-described mode (14), further comprising a coefficient multiplying portion operable to multiply the data of the composite signal obtained by the transforming portion, by a predetermined coefficient, and to apply the composite signal multiplied by the coefficient, to the control portion. On this mode (15), the composite signal in the form of a real number can be generated by the composite-signal generating portion by multiplying the last sampled sets of data read out from the memory portion, by the weights determined by the weight determining portion.

(16) The radio-frequency communication device according to the above-described mode (11), wherein the composite-signal generating portion generates the composite signal in the form of a complex signal by using the complex signals obtained by the transforming portion by transformation from the last sampled sets of data read out the memory portion, and the weights determined by the weight determining portion. In this mode (16), the composite signal in the form of the complex signal can be generated by using the last sampled sets of data each transformed into the complex signal, and the weights determined by the weight determining portion.

(17) The radio-frequency communication device according to any one of the above-described modes (14)-(16), further comprising a demodulating portion operable to demodulate the composite signal generated by the composite-signal generating portion. That is, the weight determining portion receives the composite signal generated by the composite-signal generating portion before the composite signal is demodulated by the demodulating portion, and determines the weights such that the composite signal approaches the target output signal. In this mode (17), the weights can be determined in a simpler manner and the amount of arithmetic operation required for the determination can be made smaller, than in the case where the weight are determined on the basis of the composite signal after the composite signal is modulated.

(18) An interrogator of a radio-frequency tag communication system, comprising: a plurality of antenna elements operable to receive in a non-contact fashion modulated signals which are transmitted from an IC-circuit portion of a circuit element of a radio-frequency tag and which have a frequency f; a memory portion operable to sequentially sample sets of data of the modulated signal received by the plurality of antenna elements or a signal obtained by conversion from the modulated signal and having a frequency fi, at a rate of 4nf or 4nfi (where n is a positive integer), and sequentially store the sampled sets of data, such that the last sampled set of data and a preceding set of data sampled an n-number of sampling cycles prior to the last sampled set of data are readable from the memory portion; a transforming portion operable to obtain data of a complex signal by transformation from the last sampled set of data and the preceding set of data which are respectively used as a real-number portion and an imaginary-number portion of the complex signal; and a control portion operable to change a directivity of the plurality of antenna elements on the basis of the data of the complex signal obtained by the transforming portion, such that the plurality of antenna elements have a maximum sensitivity of reception of the modulated signal from the signal transmitter device.

In the interrogator constructed according to the above-described mode (18), the memory portion sequentially samples sets of data of the received modulated signal at the rate of 4nf or 4nfi, and sequentially store the sampled sets of data, so that the last sampled set of data and the preceding set of data which has been sampled the n-number of sampling cycles prior to the last sampled set of data (the phase of which is delayed by 90° with respect to that of the last sampled set of data) are readable from the memory portion and applied to the transforming portion. The transforming portion is arranged to obtain data of the complex signal by transformation from the last sampled set of data and the preceding set of data which are respectively used as the real-number portion and the imaginary-number portion of the complex signal. The control portion is arranged to effect a so-called adaptive control of changing the directivity of the plurality of antenna elements on the basis of the data of the complex signal obtained by the transforming portion, such that the plurality of antenna elements have a maximum sensitivity of reception of the modulated signal from the signal transmitter device. The imaginary-number portion necessary for obtaining the complex signal data by transformation can be readily obtained by using the preceding set of data the phase of which is delayed by 90° with respect to that of the last sampled set of data. Thus, the present radio-frequency communication device does not require the conventional cumbersome signal processing technique such as the Hilbert transformation, so that the arithmetic operation required for controlling the directivity of reception of the antenna elements can be simplified, so that the required amount of arithmetic operation to be performed by a central processing unit serving as the memory portion, transforming portion and control portion, for example, can be reduced. Accordingly, the present radio-frequency communication device has a high degree of operating reliability.

(19) The interrogator according to the above-described mode (18), wherein the control portion includes: a weight determining portion operable to receive a signal based on a composite signal obtained by combining together the last sampled sets of data read out from the memory portion, a predetermined target output signal and the data of the complex signal, and to determine weights to be given to the respective sets of data that are combined together to generate the composite signal, such that the composite signal approaches the target output signal; and a composite-signal generating portion operable to generate the composite signal by using the weights determined by the weight determining portion. In this mode (19), the weight determining portion determines the weights such that the composite signal generated by the composite-signal generating portion approaches the target output signal, and the composite-signal generating portion generates the composite signal by using the determined weights. The thus generated composite signal is fed back to the weight determining portion, so that the directivity of the plurality of antenna elements from the signal transmitter device can be changed to maximize the sensitivity of reception of the modulated signals from the signal transmitter device.

(20) An interrogator of a radio-frequency communication system, comprising: a plurality of antenna elements operable to receive reply signals transmitted from a transponder; a weighted-signal generating portion operable to generate a weighted signal by multiplying the received signals received by the plurality of antenna elements, by respective weights for controlling a directivity of the plurality of antenna elements so as to maximize a sensitivity of reception of the received signals by the plurality of antenna elements in a direction toward the transponder; and a weight determining portion operable to determine the weights to be given to the weighted-signal generating portion such that a level of the weighted signal approaches a predetermined level of a target signal.

In the interrogator constructed according to the above-described mode (20), the received signals received by the plurality of antenna elements from the transponder are multiplied by the weighted-signal generating portion, by the weights determined by the weight determining portion, for controlling the directivity of the antenna elements so as to maximize the sensitivity of reception of the received signals by the antenna elements in the direction toward the transponder. Thus, the present interrogator is arranged to perform a so-called “adaptive control”. Described in detail, the weight determining portion determines the weights such that the level (absolute value) of the weighted signal approaches the predetermined level (absolute value) of the target signal. The present adaptive control in which the level of the weighted signal is compared with the level of the target signal permits a shorter length of time before the weights are converged to optimum values, than the conventional adaptive control in which the waveform of a demodulated signal obtained by demodulation of the received signals multiplied by the weights is compared with the waveform of a reference signal, to determine the weights such that the waveform of the demodulated signal approaches the waveform of the reference signal. The conventional adaptive control requires a large volume of arithmetic operation for obtaining the demodulated signal, thereby requiring a longer length of time before the weights are converged. Unlike the conventional adaptive control, the adaptive control according to the present embodiment makes it possible to minimize the time required for updating the weights before the weights are converged to the optimum values. Accordingly, the present interrogator permits significant reduction of the time for controlling the directivity of the antenna elements, and has a high degree of operating reliability for radio communication with the transponder.

(21) The interrogator according to the above-described mode (20), further comprising a target-signal-level setting portion operable to set said predetermined level of said target signal. In this mode (21), the level of the target signal is set by the target-signal-level setting portion. Therefore, the level of the target signal can be set or changed according to an external signal, or the received signals received by the antenna elements.

(22) The interrogator according to the above-described mode (21), further comprising an edge detecting portion operable to detect a rising or falling edge of an envelope of the received signals received by the plurality of antenna elements, and wherein the target-signal-level setting portion determines the predetermined level of the target signal according to a result of detection of the raising or falling edge by the edge detecting portion. In this mode (22), the predetermined level of the target signal is set by the target-signal-level setting portion, when the edge of the envelope of the received signals is detected by the edge-detecting portion. Accordingly, the moments at which the adaptive control is initiated and terminated can be accurately recognized. Thus, the present interrogator in which the level of the weighted signal is compared with the level of the target signal assures a higher degree of accuracy of the adaptive control, than the conventional interrogator in which the waveform of the demodulated signal is compared with the waveform of the reference signal.

(23) The interrogator according to the above-described mode (21) or (22), the target-signal-level setting portion sets a plurality of levels of the target signal respectively corresponding to a plurality of levels of an envelope of the weighted signal, and the weight determining portion determines the weights such that the plurality of levels of the envelope respectively approach the plurality of levels of the target signal. In this mode (23) wherein the weights are determined such that the plurality of levels of the envelope approach the respective levels of the target signal set by the target-signal-level setting portion, the adaptive control is effected with a higher degree of accuracy to optimize the directivity of the plurality of antenna elements with a higher degree of efficiency.

(24) The interrogator according to any one of the above-described modes (21)-(23), the target-signal-level setting portion sets increased levels of the target signal corresponding to a high-amplitude portion of an envelope of the weighted signal, and reduced levels of the target signal corresponding to a low-amplitude portion of the envelope, and the weight determining portion determines the weights such that levels of the high-amplitude portion approach the increased levels of the target signal, while levels of the low-amplitude portion approach the reduced levels of the target signal. In this mode (24) wherein the weights are determined such that the levels of the high-amplitude portion of the envelope approach the respective increased levels of the target signal while the levels of the low-amplitude portion approach the respective reduced levels of the target signal, the adaptive control is effected with a higher degree of accuracy to optimize the directivity of the plurality of antenna elements with a higher degree of efficiency.

(25) The interrogator according to the above-described mode (24), the target-signal-level setting portion sets, as the increased levels of the target signal, an increased level of a positive value of the target signal corresponding to a positive value of the high-amplitude portion and an increased level of a negative value of the target signal corresponding to a negative value of the high-amplitude portion, and as the reduced levels of the target signal, a reduced level of a positive value of the target signal corresponding to a positive value of the low-amplitude portion and a reduced level of a negative value of the target signal corresponding to a negative value of the low-amplitude portion, and the weight determining portion determines the weights such that the positive and negative values of the high-amplitude portion respectively approach the increased levels of the positive and negative values of the target signal, while the positive and negative values of the low-amplitude portion respectively approach the reduced levels of the positive and negative values of the target signal. In this mode (25) wherein the weights are determined according to the increased levels of the positive and negative values of the target signal corresponding to the positive and negative values of the high-amplitude portion and the reduced levels of the positive and negative values of the target signal corresponding to the positive and negative values of the low-amplitude portion, the adaptive control is effected with a further increased degree of accuracy to optimize the directivity of the plurality of antenna elements with a further increased degree of efficiency.

(26) The interrogator according to the above-described mode (25), further comprising a sampling portion operable to obtain samples of the received signals received by the plurality of antenna elements from said transponder, at a predetermined time interval, such that the sampled received signals are sequentially applied to the weight determining portion, and wherein the weight determining portion determines the weights such that levels of the samples corresponding to the high-amplitude portion approach the increased levels of the positive and negative values of the target signal corresponding to the positive and negative values of the high-amplitude portion, while levels of the samples corresponding to the low-amplitude portion approach the reduced levels of the positive and negative values of the target signal corresponding to the positive and negative values of the low-amplitude portion. In this mode (26) wherein the samples obtained at the predetermined time interval are sequentially applied to the weight determining portion, the weights are determined such that the levels of the samples corresponding to the high-amplitude portion approach the corresponding increased levels of the target signal, while the levels of the samples corresponding to the low-amplitude portion approach the corresponding reduced levels of the target signal.

(27) The interrogator according to the above-described mode (26), further comprising a memory portion operable to store sets of data of the samples obtained by the sampling portion, such that the sets of data are readable from the memory portion. In this mode (26) wherein the samples obtained by the sampling portion are read out from the memory portion at a suitable time interval, the weight determining portion is operated according to the levels of the read-out samples as compared with the increased and reduced levels of the target signal corresponding to the high-amplitude and low-amplitude portions of the envelope.

(28) The interrogator according to the above-described mode (26), the sampling portion obtains said samples at a time interval of (½n) T, wherein “T” represents a period of the received signals received by the plurality of antenna elements from the transponder, and “n” represents a positive integer. In this mode (28), intermediate-frequency signals obtained by conversion from the received signals received by the antenna elements are sampled at the time interval of (½n)T by the sampling portion, for example. The thus obtained samples are sequentially applied to the weight determining portion, to determine the weights such that the levels of the samples corresponding to the high-amplitude and low-amplitude portions of the weighted signal approach the increased and reduced levels of the target signal corresponding to the high-amplitude and low-amplitude portions.

(29) The interrogator according to the above-described mode (28), wherein the sampling portion obtaining samples of intermediate signals which are obtained by conversion form the received signals having the period T and which have a frequency lower than that of the received signals. In this mode (29) wherein the intermediate-frequency signals are sampled at the time interval of (½n)T. The thus obtained samples are sequentially applied to the weight determining portion, to determine the weights such that the levels of the samples corresponding to the high-amplitude and low-amplitude portions of the weighted signal approach the increased and reduced levels of the target signal corresponding to the high-amplitude and low-amplitude portions.

(30) The interrogator according to the above-described mode (28) or (29), the target-signal-level setting portion sets the increased or reduced level of the positive value of the target signal corresponding to a positive value of one of the samples, which one sample is obtained in the period T as the high-amplitude or low-amplitude portion, and the increased or reduced level of the negative value of the target signal corresponding to a negative value of another of the samples, which another sample is obtained in the period T as the high-amplitude or low-amplitude portion, such that a predetermined number of the samples exist between the above-indicated one sample and the above-indicated another sample. Where the samples obtained in the period T correspond to the high-amplitude portion of the weighted signal, the increased level of the positive value of the target signal is set for the positive value of one of the samples obtained in the period T, and the increased level of the negative value of the target signal is set for the negative value of another of the samples obtained in the period T. Where the samples obtained in the period T correspond to the low-amplitude portion of the weighted signal, the reduced level of the positive value of the target signal is set for the positive value of one of the samples obtained in the period T, and the reduced level of the negative value of the target signal is set for the negative value of another of the samples obtained in the period T. The thus set increased or reduced levels of the target signal are used to determine the weights such that the levels of the samples corresponding to the high-amplitude and low-amplitude portions of the weighted signal approach the increased and reduced levels of the target signal corresponding to the high-amplitude and low-amplitude portions.

(31) The interrogator according to the above-described mode (30), the target-signal-level setting portion determines whether each of the samples obtained in said period T has one of predetermined identification numbers of the above-indicated one sample and the above-indicated another sample, and sets the increased or reduced levels of the target signal in relation to the predetermined identification numbers of those samples. In this mode (31), the increased or reduced levels of the target signal are set for the positive and negative values of the two samples having the predetermined identification numbers. The thus set increased or reduced levels of the target signal are used to determine the weights such that the levels of the samples corresponding to the high-amplitude and low-amplitude portions of the weighted signal approach the increased and reduced levels of the target signal corresponding to the high-amplitude and low-amplitude portions.

(32) The interrogator according to the above-described mode (30), the target-signal-level setting portion sets the increased or reduced level of the positive value of the target signal corresponding to a largest one of average absolute values of the positive value of the samples obtained in the period T or for a predetermined time period equal to a multiple of the period, and the increased or reduced level of the negative value of the target signal corresponding to a largest one of average absolute values of the negative value of the samples obtained in the period or for said predetermined time period. In this mode (32), the increased or reduced levels of the target signal are set for the largest ones of the average absolute values of the positive and negative values of the samples for the time period equal to the period T or a multiple of the period. The thus set increased or reduced levels of the target signal are used to determine the weights such that the levels of the samples corresponding to the high-amplitude and low-amplitude portions of the weighted signal approach the increased and reduced levels of the target signal corresponding to the high-amplitude and low-amplitude portions.

(33) The interrogator according to any one of the above-described modes (30)-(32), wherein the sampling portion obtains the samples at a time interval of (½n) T, and the target-signal-level setting portion zeroes the level of the target signal corresponding to a value intermediate or in the midpoint between the positive and negative values of the samples obtained in said period T. In this mode (33), the level of the target signal is zeroed for the intermediate or middle value between the positive and negative values of the samples obtained in each period T. The zeroed level of the target signal is used to determine the weights such that the levels of the samples are reduced toward zero.

(34) The interrogator according to the above-described mode (21), wherein the target-signal-level setting portion sets the levels of positive and negative values of the target signal corresponding to respective positive and negative values of a low-amplitude portion of an envelope of the weighted signal, such that the levels of the positive and negative values of the target signal are respectively changed toward the negative and positive values of the low-amplitude portion, to substantially reverse the phase of said low-amplitude portion. In this mode (34), the level of the positive value of the target signal for the low-amplitude portion is changed toward the original negative value of the low-amplitude portion, and the level of the negative value of the target signal is changed toward the original positive value of the low-amplitude portion, which original positive value has the same absolute value as the original negative value. The thus set levels of the target signal are used to determine the weights, so that the amplitude of the low-amplitude portion can be reduced more rapidly, whereby the directivity of the antenna elements can be optimized in a shorter time.

(35) The interrogator according to the above described mode (34), wherein the weight determining portion terminates determination of the weights when a ratio of a signal component which is reflected from the transponder and which is included in the weighted signal has been increased to a predetermined threshold. If the levels of the positive and negative values of the reference signal for the low-amplitude portion were respectively reduced and increased toward the negative values even after the weights are changed to the optimum: values, the ratio of the reflected wave component of the weighted signal would become lower than the highest ratio at which the weights are optimum. To avoid this drawback, the weight determining portion in this mode (35) is arranged to monitor the radio of the reflected wave component, and to terminate the determination or calculation of the weight when the ratio of the reflected wave component has been increased to the predetermined threshold value, that is, when the optimum weight values have been established. Thus, the directivity of the antenna elements can be optimized in a shorter time, so as to avoid the drawback indicated above.

(36) The interrogator according to any one of the above-described modes (20)-(35), wherein the transponder is a radio-frequency tag, further comprising a transmitter antenna device operable to transmit a transmitted signal toward the radio-frequency tag, and wherein the above-described plurality of antenna elements cooperate to function as a receiver antenna device operable to receive a reply signal transmitted from the radio-frequency tag in response to the transmitted signal, whereby radio communication is effected between the interrogator and the radio-frequency tag. In this mode (36), the reply signal transmitted from the radio-frequency tag is received by the receiver antenna device, and the weighted-signal generating portion generates the weighted signal by multiplying the reply signals received by the antenna elements of the receiver antenna device, by the weights determined by the weight determining portion to perform the adaptive control such that the directivity of reception of the receiver antenna device is controlled to maximize the sensitivity of reception of the reply signals.

### BRIEF DESCRIPTION OF THE DRAWING

The above and other objects, features and industrial significance of this invention will be better understood by reading the following detailed description of preferred embodiments of the invention, when considered in connection with the accompanying drawings in which:

FIG. 1 is a view showing a communication system including a radio-frequency tag communication device provided with a radio-frequency receiver device constructed according to one embodiment of the present invention is applicable;

FIG. 2 is a block diagram showing the radio-frequency tag communication device of the communication device of FIG. 1;

FIG. 3 is a block diagram showing an arrangement of a communication object in the form of a radio-frequency tag from which the radio-frequency receiver device receives a reply signal;

FIG. 4 is a view illustrating sets of received information which are stored in a received-information memory portion of the radio-frequency-tag communication device of FIG. 2, at respective timings;

FIG. 5 is a view for explaining a manner in which different sets of received information read out from the received-information memory portion are combined together;

FIG. 6 is a flow chart illustrating a radio-frequency tag communication control routine executed by a DSP of the radio-frequency tag communication device of FIG. 2, to effect radio communication with the radio-frequency tag of FIG. 3;

FIG. 7 is a flow chart illustrating a portion of the radio-frequency tag communication control routine of FIG. 6, that is, step SB for combining together sets of information received by respective receiver antenna elements;

FIG. 8 is a block diagram showing an arrangement of a radio-frequency tag communication device including a radio-frequency receiver device constructed according to a second embodiment of this invention;

FIG. 9 is a view showing a general arrangement of a radio-frequency tag communication system constructed according to a third embodiment of this invention;

FIG. 10 is a block diagram showing functional elements of an interrogator of the radio-frequency tag communication system of FIG. 9;

FIG. 11 is a flow chart illustrating an adaptive processing operation performed by a DSP shown in FIG. 10;

FIG. 12 is a view for schematically explaining a method of transformation of a received signal into a complex signal;

FIG. 13 is a view indicating a functional arrangement of a memory show in FIG. 10;

FIG. 14 is a block diagram showing major functional elements of a modified interrogator in the system of FIG. 9, wherein an AM-demodulating portion is separate from a phase-amplitude control portion;

FIG. 15 is a view schematically showing two memory portions of a modified memory usable in the system of FIG. 9, when the memory is in a first state;

FIG. 16 is a view schematically showing the two memory portions of the modified memory of FIG. 15, when the memory is in a second state;

FIG. 17 is a block diagram showing functional elements of an interrogator of a radio-frequency communication system, which interrogator is constructed according to a fourth embodiment of this invention;

FIG. 18 is a view for explaining an operation of an adaptive array processing portion shown in FIG. 17 to detect the start point of an input information signal;

FIG. 19 is a view for schematically showing a method of adaptive array processing in the fourth embodiment of FIG. 17;

FIGS. 20A and 20B are views indicating an example of a behavior of convergence of an updated weight;

FIG. 21 is a view indicating an example of sampling of a received signal by a received-signal A/D converting portion during the adaptive array processing operation wherein a reference signal level is set as a target signal level;

FIG. 22 is a flow chart illustrating an adaptive array processing routine of the adaptive array processing portion;

FIG. 23 is a flow chart showing details of step S20 of the routine of FIG. 22;

FIG. 24 is a flow chart showing details of step S30 of the routine of FIG. 22;

FIG. 25 is a flow chart showing details of step S40 of the routine of FIG. 22;

FIG. 26 is a flow chart illustrating an adaptive array processing routine executed by a modified adaptive array processing portion, wherein a reference signal level is set in relation to one of sampled values which has the largest absolute value;

FIG. 27 is a flow chart illustrating an adaptive array processing routine executed by another modified adaptive processing portion, wherein the reference signal level is zeroed for a value intermediate or in the midpoint between one positive value and one negative value in the period;

FIG. 28 is a flow chart showing details of step S40′ of the routine of FIG. 27;

FIG. 29 is a flow chart illustrating an adaptive array processing routine executed by a further modified adaptive array processing portion, wherein weight values determined last in the present sampling operation are set as initial weight values in the next sampling operation;

FIG. 30 is a flow chart showing details of step S57 of the routine of FIG. 29;

FIG. 31 is a view for explaining a method of adaptive array processing operation of a still further modified adaptive array processing portion, wherein the phase of a low-amplitude portion of a composite output signal is reversed;

FIGS. 32A, 32B and 32C are views indicating an example of change of the weight; and

FIG. 33 is a flow chart illustrating an adaptive array processing routine executed by the modified adaptive array processing portion of FIG. 31.

### DETAILED DESCRIPTION OF THE PREFERRED EMBODIMENTS

The preferred embodiments of this invention will be described in detail by reference to the accompanying drawings.

### Embodiment 1

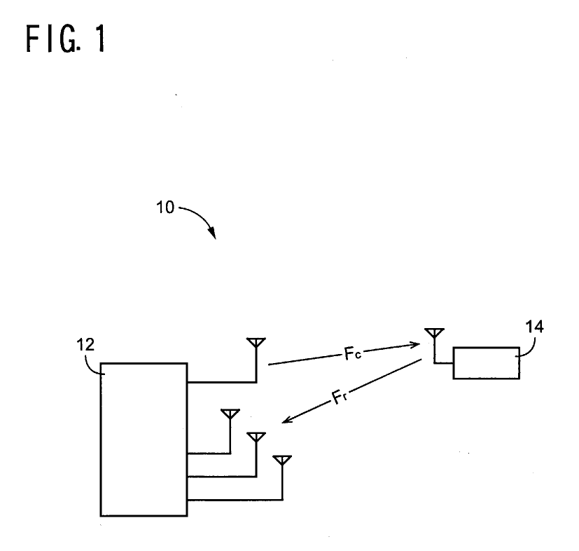

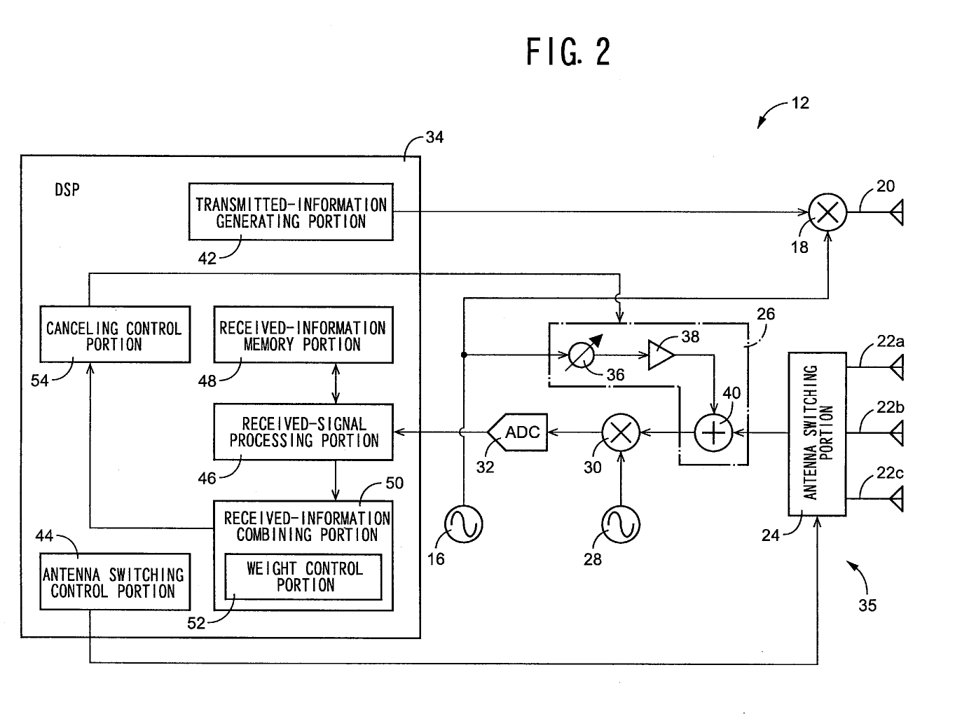

Referring to FIG. 1, there is shown an arrangement of a communication system 10 including a radio-frequency receiver device constructed according to a first embodiment of this invention. This communication system 10 is a so-called RFID (radio-frequency identification) system which consists of a radio-frequency tag communication device 12 incorporating the above-indicated radio-frequency receiver device 35 (shown in FIG. 2), and at least one communication object each in the form of a radio-frequency tag 14 (only one tag 14 shown in FIG. 1). The radio-frequency tag communication device 12 functions as an interrogator of the RFID system 0, while each radio-frequency tag 14 functions as a transponder of the RFID system 10. Described in detail, the radio-frequency tag communication device 12 is arranged to transmit an interrogating wave Fc (transmitted signal) toward the radio-frequency tag 14, and the radio-frequency tag 14 which has received the interrogating wave Fc modulates the received interrogating wave Fc according to a desired information signal (data), and transmits the modulated wave as a reply wave Fr (reply signal) toward the radio-frequency tag communication device 12. The reply wave Fr is received by a plurality of receiver antenna elements of the radio-frequency tag communication device 12. Thus, radio communication is effected between the radio-frequency tag communication device 12 and the radio-frequency tag 14.

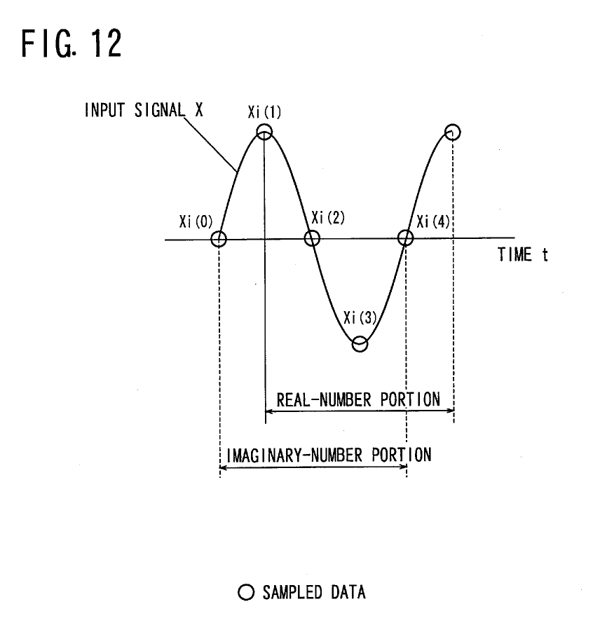

Referring next to the block diagram of FIG. 2, there is shown an arrangement of the radio-frequency tag communication device 12. As shown in FIG. 12, the radio-frequency tag communication device 12 is arranged to effect radio communication with the radio-frequency tag 14, for writing information on the radio-frequency tag 14, or for detecting the direction in which the radio-frequency tag 14 is located. The radio-frequency tag communication device 12 includes: a carrier generating portion 16 operable to generate a carrier wave of the transmitted signal indicated above; a transmitted-signal generating portion 18 operable to combine together the carrier wave generated by the carrier generating portion 16, and a desired information signal (transmitted data), for thereby generating the transmitted signal; a transmitter antenna device in the form of a transmitter antenna element 20 arranged to transmit the transmitted signal generated by the transmitted-signal generating portion 18, as an interrogating wave Fc, toward the radio-frequency tag 14; a receiver antenna device in the form of a plurality of receiver antenna elements (three receiver antenna elements 22a, 22b, 22c in the example of FIG. 2, which are hereinafter collectively referred to as “receiver antenna elements 22”, unless otherwise specified) arranged to receive the reply wave Fr transmitted from the radio-frequency tag 14 in response to the interrogating wave Fc; an antenna switching portion 24 operable to selectively at least one of the plurality of receiver antenna elements 22 which receives the reply wave Fr from the radio-frequency tag 14; a canceling portion or circuit 26 operable to eliminate or cancel a leakage signal which is a part of the transmitted signal transmitted from the transmitter antenna element 20 and which is received by the receiver antenna elements 22; a local-signal generating portion 28 operable to generate a predetermined local signal; an intermediate-signal generating portion 30 operable to generate an intermediate signal by multiplying the received signal processed by the canceling portion 26, by the local signal generated by the local-signal generating portion 28; an A/D converter 32 operable to convert the intermediate signal generated by the intermediate-signal generating portion 30, into a digital signal, and to apply the digital signal to a DSP (digital signal processor) 34; and the DSP 34 operable to control the radio communication of the radio-frequency tag communication device 12 with the radio-frequency tag 14. The antenna switching portion 24 is preferably arranged to select one of the plurality of receiver antenna elements 22 which receives the reply wave Fr from the radio-frequency tag 14. It will be understood that the above-described canceling portion 26, intermediate-signal generating portion 30 and A/D converter 32 cooperate to constitute a receiver circuit operable to process the received signals received by the receiver antenna elements 22.

The canceling portion 26 includes a cancel-signal-phase control portion 36 operable to control the phase of the carrier wave received from the carrier generating portion 16, and a cancel-signal-amplitude control portion 38 operable to control the amplitude of the carrier wave. On the basis of the carrier wave, the cancel-signal-phase control portion 36 and the cancel-signal-amplitude control portion 38 generate the cancel signal for eliminating or canceling the leakage signal which is a part of the transmitted signal transmitted from the transmitter antenna element 20 and which is received by the receiver antenna elements 22. Thus, the canceling portion 26 functions as a cancel-signal generating portion operable to generate the cancel signal for eliminating the leakage signal. The canceling portion 26 further includes a signal combining portion 40 operable to combine together the cancel signal generated from the cancel-signal-amplitude control portion 38, and the signals received by the receiver antenna elements 22, so that the leakage signal included in the received signals is offset by the cancel signal, whereby the leakage signal is eliminated.

The DSP 34 is a so-called microcomputer system which incorporates a CPU, a ROM and a RAM and which operates to perform digital signal processing operations according to a control program stored in the ROM, while utilizing a temporary data storage function of the RAM. The DSP 34 has functional portions including a transmitted-information generating portion 42, an antenna switching control portion 44, a received-signal processing portion 46, a received-information memory portion 48, a received-information combining portion 50, a weight control portion 50, and a canceling control portion 52. The digital signal processing operations performed by the DSP 34 include: an operation to supply the transmitted-signal generating portion 18 with predetermined transmitted information; an operation to control the antenna switching portion 24; an operation to control the canceling portion 26; and an operation to demodulate the reply signal received from the radio-frequency tag 14 through the A/D converter 32. The receiver antenna elements 22, antenna switching portion 24, canceling portion 26, intermediate-signal generating portion 30 and A/D converter 32 cooperate with the antenna switching control portion 44, received-signal processing portion 46, received-information memory portion 48, received-information combining portion 50 and canceling control portion 54 of the DSP 34, to constitute the above-indicated radio-frequency receiver device 35.

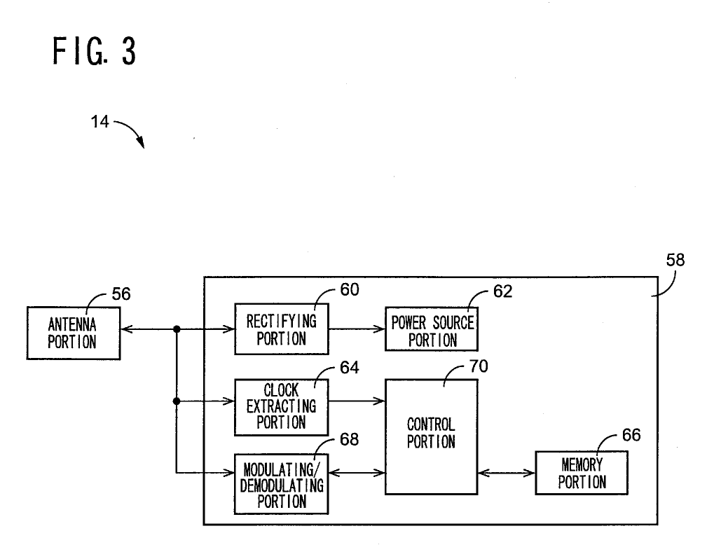

Referring further to the block diagram of FIG. 3, there is shown an arrangement of a circuit element 14s of the radio-frequency tag 14. As shown in FIG. 3, the circuit element 14s includes an antenna portion 56 for signal transmission and reception to and from the radio-frequency tag communication device 12, and an IC-circuit portion 58 operable to process the signal (interrogating wave Fc) received by the antenna portion 56. The IC-circuit portion 58 includes: a rectifying portion operable to rectify the interrogating wave Fc received from the radio-frequency communication device 12; a power source portion 62 operable to store an energy of the interrogating wave Fc rectified by the rectifying portion 60; a clock extracting portion 64 operable to extract a clock signal from the carrier wave of the interrogating wave Fc received by the antenna portion 56, and to apply the extracted clock signal to a control portion 70; a memory portion 66 functioning as an information storage portion operable to store desired information; a modulating/demodulating portion 68 connected to the antenna portion 56 and operable to effect modulation and demodulation of signals; and the above-indicated control portion 70 operable to control the circuit element 14s through the rectifying portion 60, clock extracting portion 64 and modulating/demodulating portion 68. The control portion 70 is arranged to implement basing control operations such as an operation to store the desired information in the memory portion 66 through radio communication with the radio-frequency tag communication device 12, and an operation to command the modulating/demodulating portion 68 to modulate the interrogating wave Fc received by the antenna portion 56, on the basis of the information signal stored in the memory portion 66, for generating the reply wave Fr to be transmitted as a reflected wave from the antenna portion 55 toward the radio-frequency tag communication device 12.

Referring back to the block diagram of FIG. 2, the transmitted-information generating portion 42 of the DSP 34 is arranged to generate predetermined transmitted data in the form of a transmitted information signal used by the transmitted-signal generating portion 18 to generate the transmitted signal by modulating the carrier wave generated by the carrier generating portion 16. The generated transmitted information signal is supplied to the transmitted-signal generating portion 18, so that the transmitted-signal generating portion 18 modulates the carrier wave according to the transmitted information signal, to generate the transmitted signal which includes the transmitted information signal. The generated transmitted signal is transmitted as the interrogating wave Fc from the transmitter antenna element 20 toward the radio-frequency tag 14.

The antenna switching control portion 44 is arranged to control the antenna switching portion 24 to select at least one of the plurality of receiver antenna elements 22 which receives the reply wave Fr transmitted from the radio-frequency tag 14. Namely, the reply wave Fr received by the selected receiver antenna element 22 is applied to the canceling portion 26. Preferably, the antenna switching portion 24 is controlled by the antenna switching control portion 44, so as to select one of the receiver antenna elements 22 which receives the reply wave Fr from the radio-frequency tag 14. More preferably, the antenna switching portion 24 is controlled so as to sequentially select the receiver antenna elements 22 so that the reply waves Fr which are transmitted a plurality of times from the radio-frequency tag 14 are received by the respective different receiver antenna elements 22. That is, the antenna switching control portion 44 controls the switching control portion 24, to sequentially select the receiver antenna elements 22, at respective different timings of transmission of the interrogating wave Fc from the transmitter antenna element 20, so that the sequentially selected receiver antenna elements 22 sequentially receive the reply waves Fr transmitted sequentially from the radio-frequency tag 14 in response to the respective interrogating waves Fc.

The received-signal processing portion 46 is arranged to process the received signal received from the A/D converter 32, and to store the processed received signal in the received-information memory portion 48. The received-signal processing portion 46 is further arranged to extract the phase information from the received signal received from the A/D converter 32, and to store the extracted phase information in the received-information memory portion 48. The received-signal processing portion 46 is further arranged to process the received signal or phase information read out from the received-information memory portion 48.

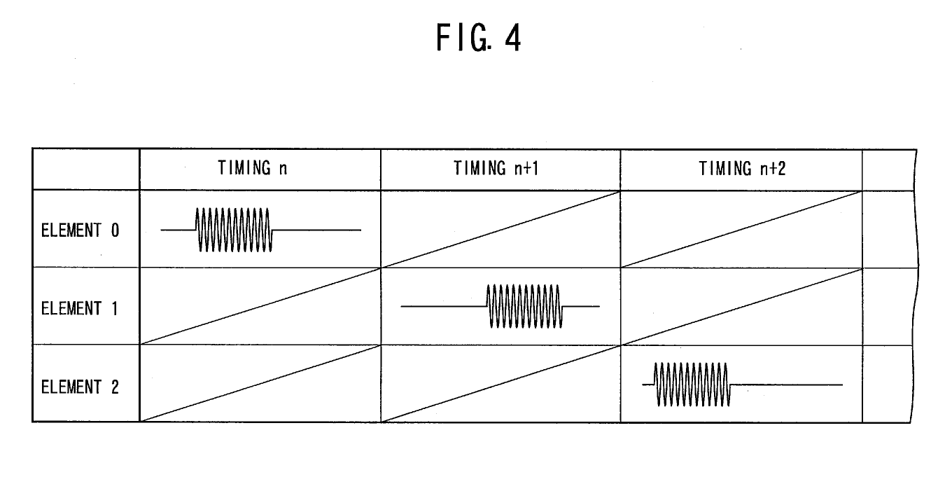

The received-information memory portion 48 stores the received signal received from the transmitter antenna elements 22 through the received-signal processing portion 46, or the phase information extracted by the received-signal processing portion 46. For example, the received-information memory portion 48 stores respective sets of information received at respective timings n, (n+1) and (n+2). In the example of FIG. 4, the information corresponding to the timing n is received by the receiver antenna element 22a, and the information corresponding to the timing (n+1) is received by the receiver antenna element 22b, while the information corresponding to the timing (n+2) is received by the receiver antenna element 22c. As described above, the radio-frequency tag 14 transmits the reply waves Fr in response to the respective interrogating waves Fc transmitted from the transmitter antenna element 20 at respective different timings, and the receiver antenna elements 22 are sequentially selected at the respective timings of transmission of the interrogating wave Fc, to sequentially receive the reply waves Fr sequentially transmitted from the radio-frequency tag 14. The sets of information sequentially received by the respective different receiver antenna elements 22 are stored in the received-information memory portion 48, as indicated in FIG. 4.

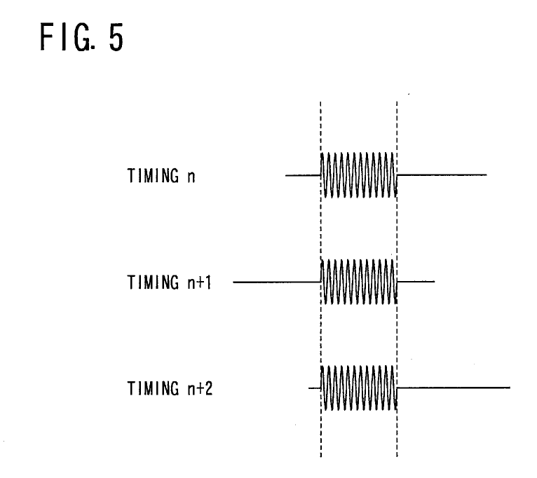

The received-information combining portion 50 is arranged to read out the received sets of information from the received-information memory portion 48. For instance, the received-information combining portion 50 is arranged to first establish alignment of the start positions of the sets of information which correspond to the respective timings n, (n+1) and (n+2) and which have been read out from the received-information memory portion 48, as indicated in FIG. 5, and to then combine together the aligned sets of information. The alignment of the start positions of the sets of information received at the different timings n, (n+1) and (n+2) by the respective receiver antenna elements 22a, 22b, 22c makes it possible to combine together the sets of information into composite information which is equivalent to composite information obtained by combining together the three sets of information which correspond to the respective timings n, (n+1) and (n+2) and which are received at the same timing by the respective three receiver antenna elements 22a, 22b, 22c. The received-information combining portion 50 preferably includes a weight control portion 52 operable to control weights to be given to the respective sets of information when the sets of information are read out from the received-information memory portion 48, so that the received sets of information are subjected to an adaptive array processing according to the controlled weights. That is, the phases and amplitudes of the sets of information are controlled according to the weights given by the weight control portion 52, and the sets of information are then combined together into a composite signal which corresponds to the directivity of reception of the receiver antenna device consisting of the plurality of receiver antenna elements 22. The composite signal thus obtained is subjected to AM modulation, and the AM-demodulated composite signal is subjected to FM demodulation, whereby the information signal modulated by the radio-frequency tag 14 is demodulated, namely, read by the received-information combining portion 50. Further, the direction in which the desired communication object in the form of the radio-frequency tag 14 is located can be detected by combining together the sets of phase information included in the received sets of information.

The canceling control portion 54 is arranged to control the canceling portion 26 on the basis of the composite signal obtained by the received-information combining portion 50. Preferably, the canceling control portion 54 changes the settings of the cancel-signal-phase control portion 36 and cancel-signal-amplitude control portion 38, so as to eliminate an error of a result of demodulation of the composite signal obtained by the received-information combining portion 50. In other words, the canceling control portion 54 functions as a receiver-circuit control portion operable to control a receiver circuit operable to process the received signals received by the receiver antenna elements 22. In this respect, it is noted that the conventional radio-frequency tag communication device requires a plurality of receiver circuits corresponding to respective receiver antenna elements, and accordingly requires a plurality of receiver-circuit control portions corresponding to the respective receiver antenna elements, to eliminate the leakage signal component included in the received signal received by each of the receiver antenna elements. While the conventional radio-frequency tag communication device is arranged such that the received signals received by the respective receiver antenna elements are concurrently processed, the present radio-frequency tag communication device 12 is arranged such that the plurality of receiver antenna elements 22 are sequentially selected by the antenna switching portion 24, for sequentially receiving the reply waves Fr sequentially transmitted from the radio-frequency tag 14, and the sets of information sequentially received by the respective receiver antenna elements 22 are first temporarily stored in the received-information memory portion 48, then read out from the received-information memory portion 48 and combined together by the received-information combining portion 50, so that the sets of information (received signals) sequentially received by the respective receiver antenna elements 22 can be processed by the single canceling portion 26 (as shown in FIG. 2), rather than a plurality of canceling portions corresponding to the respective receiver antenna elements 22. Further, the present radio-frequency tag communication device 12 requires the single intermediate-signal generating portion 30 and the single A/D converter 32, rather than a plurality of those generating portions and A/D converting portions corresponding to the respective receiver antenna elements 22.

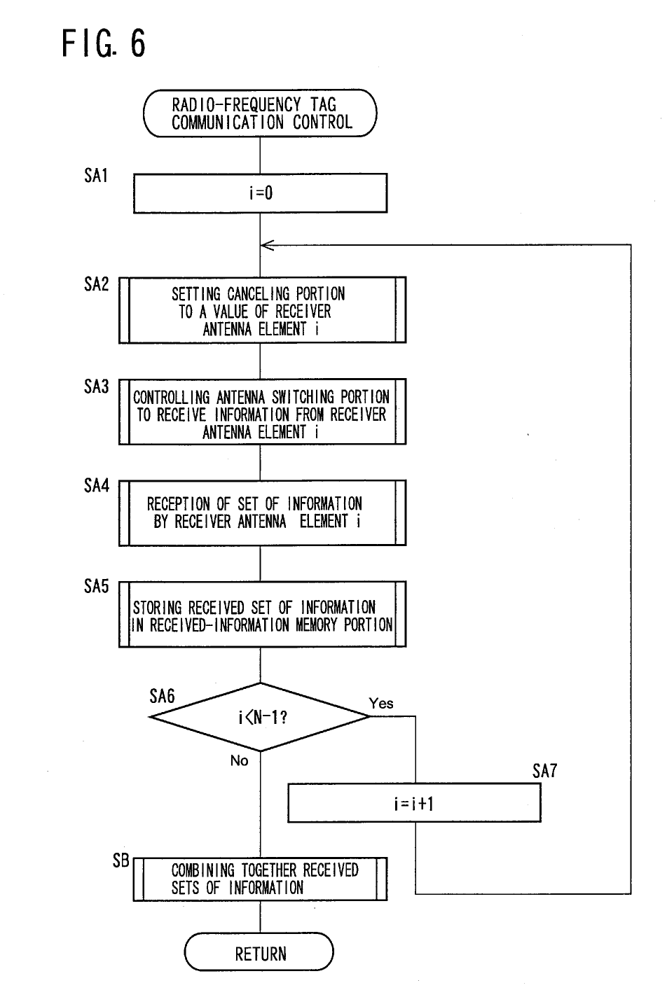

Referring to the flow chart of FIG. 6, there will be described a radio-frequency tag communication control routine executed by the DSP 34 of the radio-frequency tag communication device, to effect radio communication with the radio-frequency tag 14. This control routine is repeatedly executed with a predetermined cycle time.

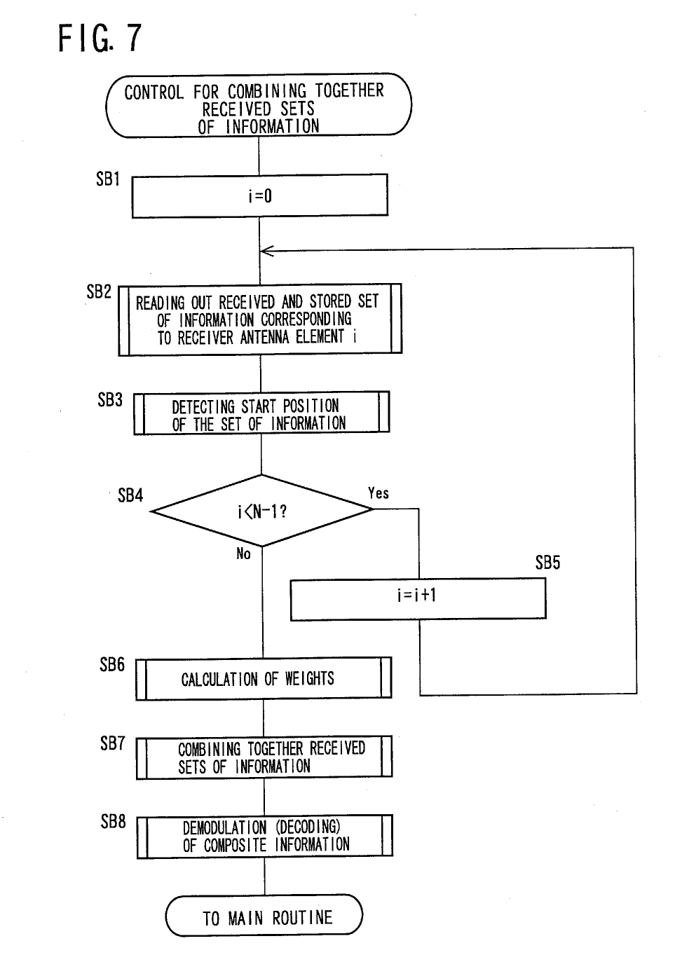

The radio-frequency tag communication control routine of FIG. 6 is initiated with step SA1 to reset a variable “i” to 0. The control flow then goes to step SA2 corresponding to the function of the canceling control portion 54, to set the canceling portion 26 to a value of the receiver antenna element 22 corresponding to the variable “i”. Step SA2 is followed by step SA3 corresponding to the function of the antenna switching control portion 44, to control the antenna switching portion 24 so that the information (received signal) received by the receiver antenna element 22 corresponding to the variable “i” is applied to the canceling portion 26. Then, the control flow goes to step SA4 in which the reply wave Fr transmitted from the radio-frequency tag 14 in response to the interrogating wave Fc from the transmitter antenna element 20 is received by the receiver antenna element 22 corresponding to the variable “i”, and applied to the DSP 34 through the canceling portion 26, intermediate-signal generating portion 30 and A/D converter 32. The control flow then goes to step SA5 corresponding to the function of the received-information memory portion 48, to store in the received-information memory portion 48 the received set of information or the phase information received from the above-indicated receiver antenna element 22 through the canceling portion 26, intermediate-signal generating portion 30 and A/D converter 32. Step SA6 is then implemented to determine whether the variable “i” is smaller than (N−1). If an affirmative determination (Yes) is obtained in step SA6, the control flow goes to step SA7 to increment the variable “i” by 1, and goes back to step SA2 and the following steps. If a negative determination (No) is obtained in step SA6, this indicates that the reply waves Fr have been received by all of the receiver antenna elements 22. In this case, the control flow goes to step SB to combine together the received sets of information received by all receiver antenna elements 22, as described below in detail by reference to the flow chart of FIG. 7, and the control routine of FIG. 6 is terminated.

The flow chart of FIG. 7 illustrates details of step SB of the flow chart of FIG. 6, namely, a control for combining together the sets of information received by the plurality of receiver antenna elements 22.

The control routine of FIG. 7 is initiated with step SB1 to reset the variable “o” to 0. The control flow then goes to step SB2 to read out the set of information corresponding to the variable “i” from the received-information memory portion 48. Step SB2 is followed by step SB3 to detect the start position of the set of information read out in step SB2, so that the start positions of the plurality of sets of information read out from the received-information memory portion 48 are aligned with each other after the last set of information has been read out. Then, step SA4 is implemented to determine whether the variable “i” is smaller than (N−1). If an affirmative decision (Yes) is obtained in step SB4, the control flow goes to step SB5 to increment the variable “i” by 1, and the control flow goes back to step SB2 and the following steps. If a negative decision (No) is obtained in step SB4, this indicates that all sets of information have been read out from the received-information memory portion 48, such that the start positions of the sets of information are aligned with each other. Namely, the sets of information sequentially received by the receiver antenna elements 22 and read out from the received-information memory portion 48 are arranged in a manner identical with sets of information concurrently received by all receiver antenna elements 22. If the negative decision is obtained in step SB4, therefore, the control flow goes to step SB6 corresponding to the function of the weight control portion 42, to calculate the weights to be given to the respective sets of information read out in step SB2, and to effect an adaptive array processing of the received sets of information. Step SB7 is then implemented to combine together the sets of information subjected to the adaptive array processing in step SB6. The control flow then goes to step SB8 in which composite information (composite signal) obtained by combining together the sets of information in step SB7 is subjected to AM demodulation, and the AM-demodulated composite information is subjected to FM decoding, so that the information modulated by the radio-frequency tag 14 and included in the reply wave Fr is read by the DSP 34. The control routine of FIG. 7 is terminated after step SB8, and the control flow goes back to the control routine of FIG. 6. It will be understood that the steps SB6 through SB8 correspond to the function of the received-information combining portion 50.

The present first embodiment constructed as described above is arranged such that the radio-frequency receiver device 35 includes: the antenna switching portion 24 operable to select at least one of the plurality of receiver antenna elements 22 which receives information transmitted from the desired communication object in the form of the radio-frequency tag 14; the received-information memory portion 48 (step SA5) operable to store sets of information received by the receiver antenna elements 22 sequentially selected by the antenna switching portion 26; and the received-information combining portion 50 (steps SB6 through SB8) operable to read out the sets of information from the received-information memory portion 48, and to combine together the sets of information read out from the received-information memory portion 48. In the present embodiment, the sets of information are sequentially received by the sequentially selected receiver antenna elements 22, so that the required number of receiver circuits of the radio-frequency receiver device 35 connected to the receiver antenna elements 22 can be reduced. Accordingly, the present radio-frequency receiver device 35 arranged to combine together the sequentially received sets of information can be simplified in construction, but is capable of controlling the directivity of reception of the sets of information.

The present embodiment is further arranged such that the antenna switching portion 24 selects one of the plurality of receiver antenna elements 22 which receives the information from the radio-frequency tag 14 (desired communication object) at one time, so that the sets of information sequentially transmitted from the communication object are sequentially received by the plurality of receiver antenna elements 22. This arrangement minimizes the number of the receiver circuits required by the radio-frequency receiver device 35.

The first embodiment is further arranged such that the received-information combining portion 50 includes the weight control portion 52 (step SB6) operable to control weights to be given to the respective sets of information read out from the received-information memory portion 48, and is operable to effect an adaptive array processing of the sets of information. Accordingly, the sets of information can be efficiently received from the radio-frequency tag 14.

The first embodiment is further arranged such that the antenna switching portion 24 sequentially selects the plurality of receiver antenna elements 22 so that the sets of information sequentially transmitted from the radio-frequency tag 14 are sequentially received by the sequentially selected receiver antenna elements 22. In this arrangement, the composite information obtained by the received-information combining portion 50 by combining together the sets of information sequentially received by the sequentially selected receiver antenna elements 22 is equivalent to composite information obtained by combining together sets of information which are concurrently received by the receiver antenna elements 22.

The first embodiment is further arranged such that the received-information memory portion 48 stores sets of phase information included in the respective sets of information received by the plurality of receiver antenna elements 22. In this arrangement, only the phase information is subjected to the adaptive array processing, and the volume of information to be stored in the received-information memory portion 48 can be reduced.

The first embodiment is further arranged such that the radio-frequency receiver device 35 comprises only one receiver circuit operable to process the sets of information received by the plurality of receiver antenna elements 22, even where the plurality of receiver antenna elements 22 are provided. Accordingly, the radio-frequency receiver device 35 can be simplified in construction.

The first embodiment is further arranged such that the radio-frequency receiver device 35 includes only one receiver circuit, that is, only one canceling portion 26, only one intermediate-signal generating portion 30 and only one A/D converter 32, for processing the sets of information received by the plurality of receiver antenna elements 22. Accordingly, the radio-frequency receiver device 35 can be most simplified in construction.

The first embodiment is further arranged such that the desired communication object is the radio-frequency tag 14 capable of transmitting the reply signal in response to the signal received from the radio-frequency communication device 12 provided with the radio-frequency receiver device 35. In this arrangement, the radio-frequency receiver device 35 included in the radio-frequency communication device 12 operable for radio communication with the radio-frequency tag can be simplified in construction, but is capable of controlling the directivity of reception of the sets of information from the radio-frequency tag 14.

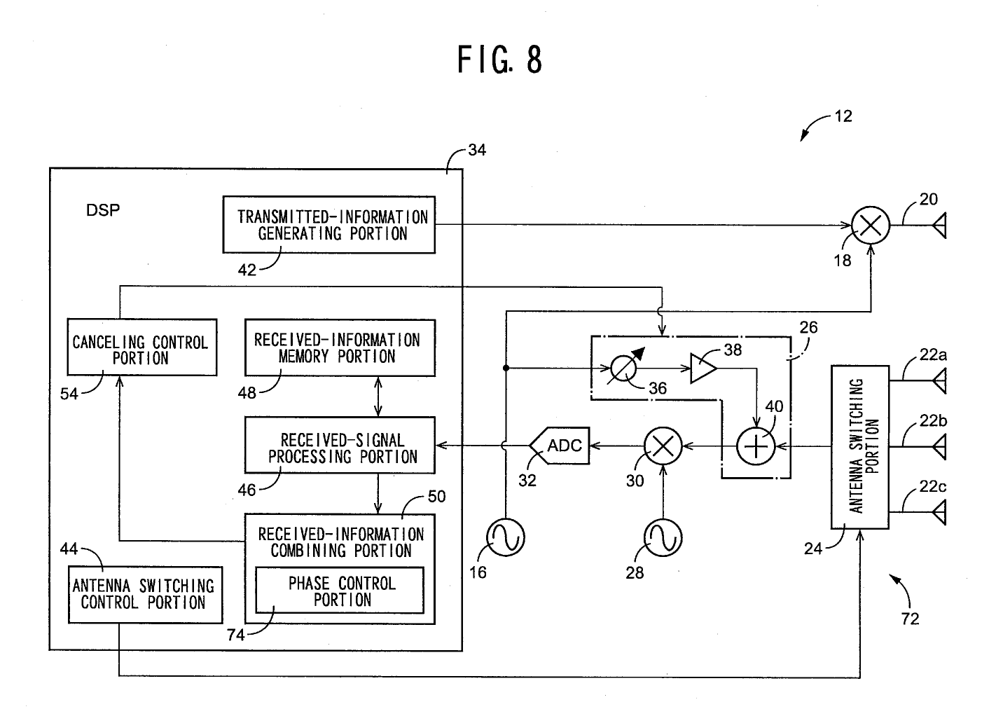

Other embodiments of the present embodiments will be described by reference to FIGS. 8-33. In the embodiments, the same reference signs as used in the first embodiment will be used to identify the functionally corresponding elements, which will not be described redundantly.

### Embodiment 2

Referring to the block diagram of FIG. 8, there is shown an arrangement of the radio-frequency tag communication device 12 including a radio-frequency receiver device 72 constructed according to a second embodiment of this invention. As shown in FIG. 8, this received-information combining portion 50 of the DSP 34 of the radio-frequency tag communication device 12 includes a phase control portion 78 in place of the weight control portion 52 provided in the first embodiment. The phase control portion 78 is operable to read out the received sets of information stored in the received-information memory portion 48, and control the phases of the read out sets of information, so that the received sets of information are subjected to a phased array processing. For example, radio communication with the radio-frequency tag 14 to detect the direction or position of the radio-frequency tag 14 can be effected by simply controlling the phases of the sets of information received by the receiver antenna elements 22. The phased array processing can be completed in a shorter length of time, than the adaptive array processing practiced in the first embodiment, so that the direction or position of the radio-frequency tag 14 can be detected in a shorter time. Further, the direction in which the radio-frequency tag 14 is located can be detected by combining together the sets of phase information included in the respective sets of information received by the receiver antenna elements 22. In this respect, it is noted that the received-information memory portion 48 is preferably arranged to store only the sets of phase information included in the sets of information received by the receiver antenna elements 22.

In the second embodiment described above, the received-information combining portion 50 includes the phase control portion 74 arranged to read out the sets of phase information from the received-information memory portion 48, and to control the phases of the received sets of information, and is operable to effect the phased array processing of the read out sets of information. Accordingly, the directivity of reception of the sets of information from the desired communication object in the form of the radio-frequency tag 14 can be suitably controlled.

While the first and second embodiments of this invention have been described, these embodiments may be modified as needed.

In the first and second embodiments, the received-signal processing portion 46, received-information memory portion 48, received-information combining portion 50 and weight control portion 52 or phase control portion 72 are provided as functional means of the DSP 34. However, those portions may be independent control devices. Further, the functions of those portions 46-52, 72 may be performed by either digital signal processing or analog signal processing.

In the first and second embodiments, the radio-frequency receiver device 35 includes only one receiver circuit which is operable to process the received signals (sets of information) received by the receiver antenna elements 22 and which includes the canceling portion 26, intermediate-signal generating portion 30 and A/D converter 32. However, the radio-frequency receiver device 35 may include a plurality of receiver circuits corresponding to the respective receiver antenna elements 22, like the conventional radio-frequency receiver device.

In the radio-frequency tag communication device 12 according to the first and second embodiments, the transmitter antenna element 20 for transmitting the transmitted signal (interrogating wave Fc) toward the radio-frequency tag 14, and the plurality of receiver antenna elements 22 for receiving the reply signal (reply wave Fr) transmitted from the radio-frequency tag 14 in response to the transmitted signal are provided as separate transmitter and receiver antenna devices. However, the radio-frequency communication device 12 may use a plurality of transmitter/receiver antenna elements arranged to transmit the transmitted signal toward the radio-frequency tag 14 and to receive the reply signal transmitted from the radio-frequency tag 14 in response to the transmitted signal. In this modification, the plurality of transmitter/receiver antenna elements are sequentially selected to sequentially receive the reply signals sequentially transmitted from the radio-frequency tag 14, so that the sequentially received reply signals are sequentially received by the single receiver circuit.

### Embodiment 3

Referring to FIG. 3, there is shown a general arrangement of a radio-frequency tag communication system S including a radio-frequency communication device in the form of an interrogator 100 constructed according to a third embodiment of this invention, and the radio-frequency tag 14.

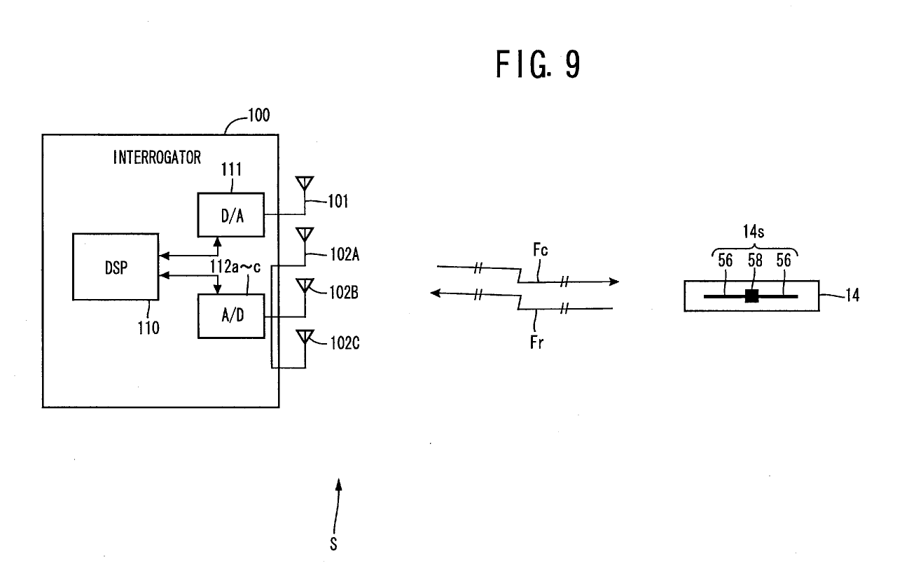

Although the radio-frequency tag communication system S shown in FIG. 9 includes only one interrogator 100 and only one radio-frequency tag 14, this system S may include a plurality of interrogators and a plurality of radio-frequency tags. Namely, the radio-frequency tag communication system S is a so-called RFID (radio-frequency identification) system consisting of at least one interrogator 100 and at least one radio-frequency tag 14. As described above by reference to FIG. 3, the radio-frequency tag 14 which is a communication object for radio communication with the interrogator 100 has a circuit element 14S which includes an antenna portion 56 and an IC-circuit portion 58.

The interrogator 100 has directivity of transmission and reception in a predetermined plane, which directivity is variable for signal transmission and reception with maximum electric power, to and from the antenna portion 56 of the circuit element 14s of the radio-frequency tag 14. The interrogator 100 includes: one transmitter antenna element 101 serving as a transmitter antenna device; three receiver antenna elements 102A, 102B and 102C serving as a receiver antenna device; a DSP (digital signal processor) 110 operable to obtain an access to the IC-circuit portion 58 of the circuit element 14s of the radio-frequency tag 14 through the transmitter and receiver antenna elements 101, 102A-102C, for reading and writing information from and on the IC-circuit portion 58, and to perform digital signal processing operations for outputting the digital transmitted signal (transmitted wave Fc) and demodulating the reply signal (reflected wave Fr) received from the radio-frequency tag 14; a transmitted-signal D/A converting portion 111 operable to convert the digital transmitted signal received from the DSP 110, into an analog signal to be applied to the transmitter antenna element 101; and three received-signal A/D converting portions 112a, 112b and 112c (hereinafter collectively referred to as “received-signal A/D converting portions 112”, unless otherwise specified) operable to convert the received signals received from the receiver antenna elements 102A-102C, into digital signals to be applied to the DSP 110.

When the circuit element 14s of the radio-frequency tag 14 receives the transmitted signal in the form of the transmitted wave Fc from the interrogator 100, the received transmitted wave Fc is modulated according to a predetermined information signal, into the reply signal in the form of the reflected wave Fr, and the reflected wave Fr is received and demodulated by the interrogator 100. Thus, the radio communication is effected between the interrogator 100 and the radio-frequency tag 14.

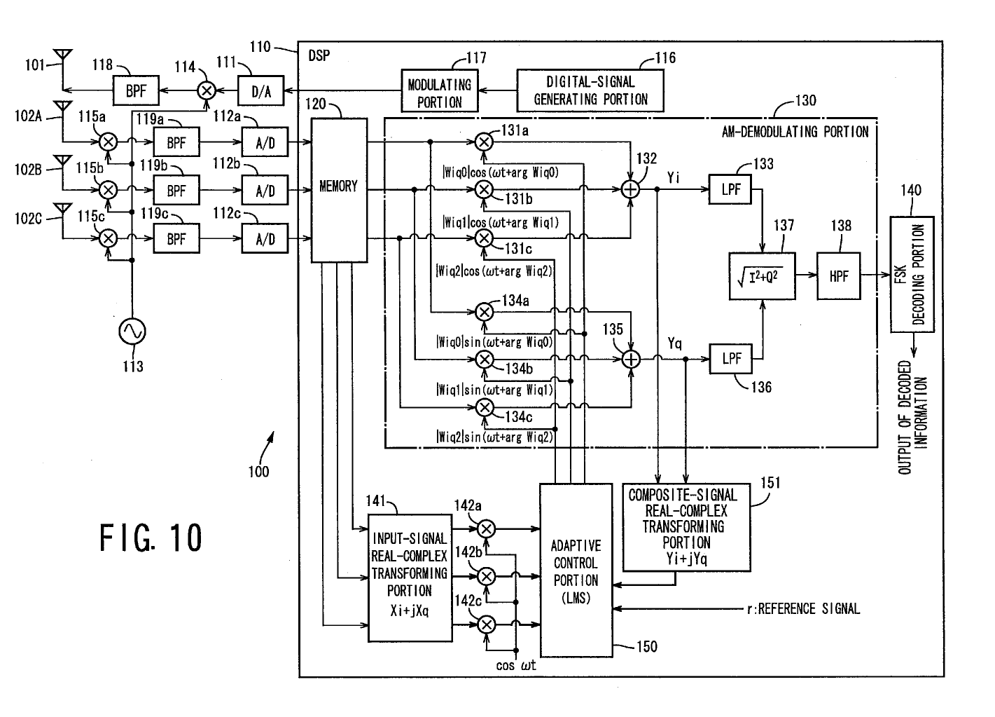

Referring next to the block diagram of FIG. 10, there are shown functional elements of the interrogator 100. In FIG. 10, thick solid lines indicate flows of complex-number signals, while thin solid lines indicate flows of real-number signals.

As shown in FIG. 10, the interrogator 100 further includes, in addition to the above-described transmitter and receiver antenna elements 101, 102A-102C, DSP 110, transmitted-signal D/A converting portion 111 and received-signal A/D converting portion 112: a frequency-converting-signal generating portion 113 operable to generate predetermined frequency converting signal; an up-converter 114 operable to increase the frequency of the analog transmitted signal received from the transmitted-signal D/A converting portion 111, by an amount corresponding to the frequency of the frequency converting signal generated by the frequency-converting-signal generating portion 113, and to apply the frequency-increased analog transmitted signal to the transmitter antenna element 101; three down-converters 115a, 115b and 115c (hereinafter collectively referred to as “down-converters 115”, unless otherwise specified) each operable to reduce the frequency of the received signal received from each receiver antenna element 102, by an amount corresponding to the frequency of the frequency converting signal generated by the frequency-converting-signal generating portion 113, and to apply the frequency-reduced received signal to the corresponding received-signal A/D converting portion 112; a band pass filter 118 operable to remove an unnecessary component from the frequency-increased analog transmitted signal received from the up-converter 114; and three band pass filters 119a, 119b and 119c each operable to remove an unnecessary component from the frequency-reduced received signal received from the corresponding down-converter 115. The band pass filters 118, 119 may be replaced by direct modulation circuits known in the art.

The DSP 110 is a so-called microcomputer system which incorporates a CPU, a ROM and a RAM and which operates to signal processing operations according to control programs stored in the ROM, while utilizing a temporary data storage function of the RAM.

The DSP 110 includes: a digital-signal generating portion 116 operable to generate the digital transmitted signal to be transmitted to the circuit element 14s of the radio-frequency tag 14; a modulating portion 117 operable to modulate the digital transmitted signal received from the digital-signal generating portion 116, on the basis of the predetermined information signal (transmitted information), and to apply the modulated digital transmitted signal to the transmitted-signal D/A converting portion 111; a memory 120 serving as a memory portion for storing the received signals received by the receiver antenna elements 102; an AM-demodulating portion 130 and an FSK-decoding portion 140 which are operable to demodulate the received signals read out from the memory 120, for reading predetermined information signals included in the received signals (signals modulated by the circuit element 14s); an input-signal real-complex transforming portion 141 operable to transform the received signals (real-number signals) read out from the memory 120, into complex signals; three multiplying portions 142a, 142b and 142c operable to multiply the complex signals by a predetermined coefficient (cos ωt in this example); an adaptive control portion (LMS control portion=least mean square control portion) 150 operable to receive products (the complex signals multiplied by the coefficient) from the multiplying portions 142, and to determine, on the basis of the products, weights to be given to the received signals read out from the memory 120 by the AM-demodulating portion 130; and a composite-signal real-complex transforming portion 151 operable to transform composite signals (real-number signals) received from the AM-demodulating portion 130, into complex signals.

The AM-demodulating portion 130 is preferably arranged to effect orthogonal IQ demodulation, namely, to convert each of the received signals into an I-phase (in-phase) signal and a Q-phase (quadrature-phase) signal, and to combine together a composite I-phase signal Yi and a composite Q-phase signal Yq, for thereby demodulating the received signal. The I-phase signal and the Q-phase signal have a phase difference of 90°.

The AM-demodulating portion 130 includes: three I-phase converting portions 131a, 131b and 131b operable to convert the received signals received by the respective receiver antenna elements 102A, 102B and 102C, into the I-phase signals; an I-phase-signal combining portion 132 operable to combine together the I-phase signals received from the I-phase converting portions 131a-131c, for obtaining the composite I-phase signal Yi; an I-phase LPF (low pass filter) 133 operable to pass a predetermined frequency component (frequency not higher than a predetermined threshold) of the composite I-phase signal Yi received from the I-phase-signal combining portion 132; three Q-phase converting portions 134a, 134b and 134b operable to convert the received signals received by the respective receiver antenna elements 102A, 102B and 102C, into the Q-phase signals; a Q-phase-signal combining portion 135 operable to combine together the Q-phase signals received from the Q-phase converting portions 134a-134c, for obtaining the composite Q-phase signal Yq; a Q-phase LPF (low pass filter) 136 operable to pass a predetermined frequency component (frequency not higher than a predetermined threshold) of the composite Q-phase signal Yq received from the Q-phase-signal combining portion 135; a demodulated-signal generating portion 137 operable to combine together the frequency component received from the I-phase LPF 133 and the frequency component received from the Q-phase LPF 136, for obtaining a square root of (I²+Q²), to thereby obtain a demodulated signal; and a HPF (high pass filter) 138 operable to pass a predetermined frequency component (frequency not lower than a predetermined threshold) of the demodulated signal received from the demodulated-signal generating portion 137.

The I-phase converting portions 131a, 131b and 131c and the Q-phase converting portions 134a, 134b and 134c cooperate to function as a phase-and-amplitude control portion operable to control the phase and amplitude of the received signals, according to the weights received from the adaptive control portion 150.

The composite I-phase signal Yi generated by the I-phase combining portion 132 and the composite Q-phase signal Yq generated by the Q-phase combining portion 135 are transformed by the composite-signal real-complex transforming portion 151 into complex number signals to be applied to the adaptive control portion 150.

The AM-demodulated signal generated by the HPF 138 is decoded by the FSK-decoding portion 140 into decoded information (information corresponding to the information demodulated by the radio-frequency tag 14).

The multiplying portions 142a, 142b and 142c are provided to correlate the weights to be determined by the adaptive control portion 150, with the received signals currently read out from the memory 120 by the I-phase converting portions 131 and Q-phase converting portions 134 to multiply the read out received signals by the determined weights for obtaining the composite I-phase and Q-phase signals Yi, Yq in the form of the real-number signals.

In the interrogator 100 constructed as described above, the digital transmitted signal generated by the digital-signal generating portion 116 is modulated by the modulating portion 117 on the basis of the predetermined transmitted information, and the modulated digital transmitted signal is converted by the transmitted-signal D/A converting portion 111 into the analog transmitted signal the frequency of which is increased by the up-converter 114, by the amount corresponding to the frequency of the frequency converting signal generated by the frequency-converting-signal generating portion 113. The analog transmitted signal the frequency of which is increased by the up-converter 114 is applied to the transmitter antenna element 101, and transmitted as the transmitted wave Fc toward the radio-frequency tag 14.

When the transmitted wave Fc transmitted from the transmitter antenna element 101 of the interrogator 100 is received by the antenna portion 56 of the circuit element 14s of the radio-frequency tag 14, the received transmitted wave Fc is demodulated by the modulating/demodulating portion 68 (shown in FIG. 3). Further, a part of the transmitted wave Fc is rectified by the rectifying portion 60 into an electric energy to be stored in the power source portion 62. This electric energy is used by the control portion 70 to generate the reply signal on the basis of the predetermined information signal stored in the memory portion 66. On the basis of the reply signal, the modulating/demodulating portion 68 modulates the received transmitted wave Fc into the reflected wave Fr to be transmitted from the antenna portion 56 toward the interrogator 100.

When the reflected wave Fr transmitted from the antenna portion 56 of the circuit element 14s is received by each of the receiver antenna elements 102A, 102B, 102C of the interrogator 100, and applied to the corresponding down-converter 115 so that the frequency of the reflected wave Fr is reduced by the amount corresponding to the frequency of the frequency converting signal generated by the frequency-converting-signal generating portion 113. The frequency-reduced signal (received signal) is converted by the corresponding received-signal A/D converting portion 112 into the digital received signal, which is stored in the memory 120.

The received signals read out from the memory 120 are applied to the AM-demodulating portion 130, so that the received signals are converted by the I-phase converting portions 131a, 131b, 131c and the Q-phase converting portions 134a, 134b, 134c, into the I-phase signals and the Q-phase signals which have the phase difference of 90°. The I-phase signals are combined together by the I-phase-signal combining portion 132 to obtain the composite I-phase signal Yi, while the Q-phase signals are combined together by the Q-phase signal combining portion 135 to obtain the composite Q-phase signal Yq.

The frequency component of the composite I-phase signal Yi which is passed through the LPF 133 and the frequency component of the composite Q-phase signal Yq are combined together by the demodulated-signal generating portion 137, so as to obtain the root square of (I²+Q²), whereby the demodulated signal is generated. The frequency component of the demodulated signal which is passed through the HPF 138 is applied as an AM-demodulated wave to the FSK-decoding portion 140, to obtain the decoded information.

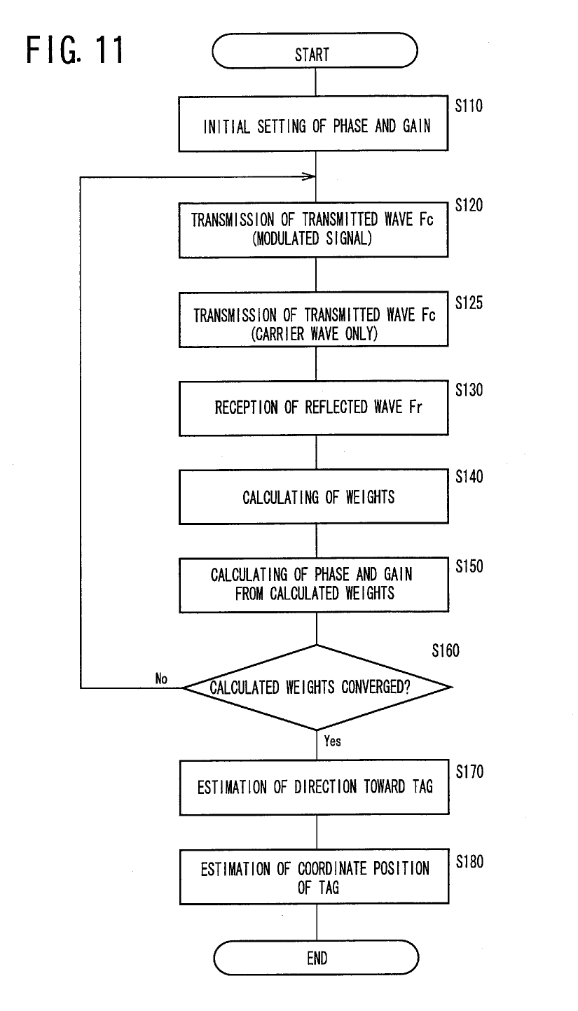

Referring to the flow chart of FIG. 11, there will be described a control routine executed by the DSP 100 to perform an adaptive processing operation.

The control routine of FIG. 11 is initiated with step S110 to set the phase and gain (amplitude) of the I-phase and Q-phase signals to predetermined initial values. These phase and gain are set by control signals that are applied from the adaptive control portion (LMS control portion) 150 to the I-phase converting portions 131a, 131b, 131c and the Q-phase converting portions 134a, 134b, 134c.

Then, the control flow goes to step S120 in which the digital transmitted signal generated by the digital-signal generating portion 116 is modulated by the modulating portion 117, and the modulated digital transmitted signal is converted by the transmitted-signal D/A converting portion 111 into the analog transmitted signal, which is transmitted as the transmitted wave Fc from the transmitter antenna element 101 toward the circuit element 14s of the radio-frequency tag 14.

After the transmitted wave Fc obtained by modulation of the digital transmitted signal by the modulating portion 116 has been transmitted, step S125 is implemented to transmit only the carrier wave for supplying the circuit element 14s with an electric energy.

Step S125 is followed by step S130 in which the receiver antenna elements 102A, 102B, 102C receive the reflected wave Fr transmitted from the circuit element 14s of the radio-frequency tag 14 in response to the transmitted wave Fc. The received reflected wave Fr is converted into the digital received signal by each A/D converting portion 112a, 112b, 112c, and the received signal is stored in the memory 120. The operations in steps S125 and S130 are performed for one sample of the reflected wave Fc.

The directivity of reception of each receiver antenna element 102 is controlled to maximize the sensitivity of reception of the received signal. Described in detail, the amplitude and phase of the received signal received by each receiver antenna element 102 are controlled to maximize the sensitivity of reception in the direction toward the radio-frequency tag 14, on the basis of the composite I-phase and Q-phase signals Yi, Yq which have been generated by the I-phase combining portion 132 and Q-phase combining portion 135 and which have been transformed by the composite-signal real-complex transforming portion 151. Namely, the phases and amplitudes of the received signals are controlled such that the amplitude of the component modulated by the circuit element 14s and received by each receiver antenna element 102 is increased to a value close to the amplitude of a reference signal (target output signal). Thus, the accuracy of demodulation by the AM-demodulating portion 130 is maximized. To this end, phase/amplitude control signals to be applied from the adaptive control portion 150 to the I-phase converting portions 131 and the Q-phase converting portion 134 are controlled to set the weights to be given to the received signals received by the respective receiver antenna elements 102. These weights are calculated until the calculated weights are converged or stabilized.

Therefore, step S130 is followed by step S140 to determine the weights corresponding to the receiver antenna elements 102A, 102B, 102C, so that the phase/amplitude control signals indicative of the determined weights are applied to the respective I-phase converting portions 131a, 131b, 131c and to the respective Q-phase converting portions 134a, 134b, 134c. The control flow then goes to step S150 in which the gain and amplitude (gain) are set by each of the I-phase converting portions 131 and Q-phase converting portions 134.

The calculated weight values are stored in a suitable memory such as the RAM in the DSP 110. Step S150 is followed by step S160 to determine whether the calculated weight values are converged to almost constant optimum values. Steps S120 through S150 are repeatedly implemented until an affirmative determination (Yes) is obtained in step S160. Each time the weight values are calculated and stored in the memory in step S140, the newly calculated weight values are compared with the last calculated values. If a difference of the newly calculated weight values with respect to the last calculated values is smaller than a predetermined value, it is determined that the calculated weights are converged or stabilized, and the affirmative determination is obtained in step S160. The adaptive control portion 150 changes the weights corresponding to the receiver antenna elements 102, until the amplitude of the reflected wave Fr as received by the receiver antenna elements 102 is maximized, that is, until the sensitivity of reception of the reflected wave Fc is maximized. If an interference signal is mixed in the received reflected wave Fc, the weights are changed to minimize the interference signal. Steps S120 through S160 are repeatedly implemented as long as the calculated weight values unstably change.

When the affirmative determination is obtained in step S160 with the weight values being stabilized, the control flow goes to step S170 to estimate the direction in which the radio-frequency tag 14 is located. In this respect, it is noted that a source of generation of an interference signal and the radio-frequency tag 14 may be located in almost the same direction, and that the receiver antenna elements 102 may have a maximal value of sensitivity of reception of the received signals, in two or more directions. In this sense, the operation in step S170 to find the direction in which the radio-frequency tag 14 is considered to be an operation to estimate that direction.

In step S170, the direction in which the radio-frequency tag 14 is located is estimated on the basis of a manner in which the calculated weights are converged. Then, step S180 is implemented to estimate the coordinate position of the radio-frequency tag 14, on the basis of the strength of the received reflected wave Fc upon convergence of the weights.

In the manner described above, the adaptive control portion 150 effects an adaptive array control of the directivity of reception of the receiver antenna elements 102, so as to maximize the sensitivity of reception of the reflected wave Fc from the antenna portion 56 of the circuit element 14s of the radio-frequency tag 14, whereby the accuracy of the demodulating processing operation by the AM-demodulating portion 130 is maximized to permit detection of the circuit element 14s with a high degree of sensitivity. The composite I-phase signal Yi and the composite Q-phase signal Yq demodulated by the AM-demodulating portion 130 according to the control signals received from the adaptive control portion 150 are finally decoded by the FSK-decoding portion 130 into the decoded information. Thus, the information included in the received signals received by the receiver antenna elements 102, that is, the information modulated by the circuit element 14s can be efficiently read by the DSP 110.

There will next be described a manner of transformation of the signals received by the receiver antenna elements 102 into complex signals which are used by the adaptive control portion 150 to determine the above-described weights.

Namely, for effecting the adaptive control, the adaptive control portion 150 requires an analytic signal including the phase information and amplitude information of each received signal, that is, a complex equation (1): X(t)=Xi(t)+jXq(t).

Usually, an output of an A/D converter which receives a signal received by an antenna consists of only a real-number portion (first member of the above-indicated equation (1)), and does not include an imaginary-number portion (second member of the equation (1)). Therefore, it is necessary to generate the real number portion (by transformation of the received signal into a complex signal).

In the present third embodiment, the transformation of each received signal into the complex signal is implemented in a simple manner based on a fact that a periodic waveform such as a sine wave has an imaginary-number signal the phase of which is delayed by 90° with respect to a real-number signal. That is, two sets of data of the received signal which have a phase difference of 90° are read out from the memory 120 as a set of real number data and imaginary number data, and this set of real and imaginary number data is utilized to implement the transformation into the complex signal.

FIG. 12 is a view schematically explaining a method for the transformation of the received signal into the complex signal according to the principle of the present third embodiment. In the example of FIG. 12, a periodic signal (sine wave) having a frequency f (period T=1/f) is transmitted from the antenna portion 56 of the circuit element 14s of the radio-frequency tag 14, and this sine wave signal is received by the receiver antenna elements 102 and sampled at a rate of 4nf (n; positive integer), that is, at an interval of ¼nf=T/4n. The thus sampled sets of data are sequentially stored in the memory 120.

In the waveform shown in FIG. 12, signal values at five points that are spaced apart from each other by an interval of T/4 (where n=1) are respectively Xi(0), Xi(1), Xi(2), Xi(3) and Xi(4). Since the value of the imaginary-number portion of the analytic signal is equal to a value of the real-number portion the phase of which is delayed by 90° with respect to that of the imaginary-number portion, the values Xi(0), Xi(1), Xi(2) and Xi(3) are respectively equal to the imaginary-number portions of the real-number portions Xi(1), Xi(2), Xi(3) and Xi(4). Accordingly, the values X(1), X(2), X(3) and X(4) of the analytic signal are represented by the following equations:
X(1)=Xi(1)+jXi(0)
X(2)=Xi(2)+jXi(1)
X(3)=Xi(3)+jXi(2)
X(4)=Xi(4)+jXi(3)

Therefore, the values are represented by the following general equation:
X(t)=Xi(t)+jXi(t−1), where t≧n

The general equation indicated above represents the value X(t) where n is equal to 1. Where n is an arbitrary integer, the value X(t) is represented by the following equation:
X(t)=Xi(t)+jXi(t−n), where t≧n

In the present third embodiment, the sets of data sequentially sampled at a rate of 4f are sequentially stored in the memory 120, and the last set of data and the set of data which has been stored the n number of sampling cycles prior to the last set of data are readable from the memory 120.

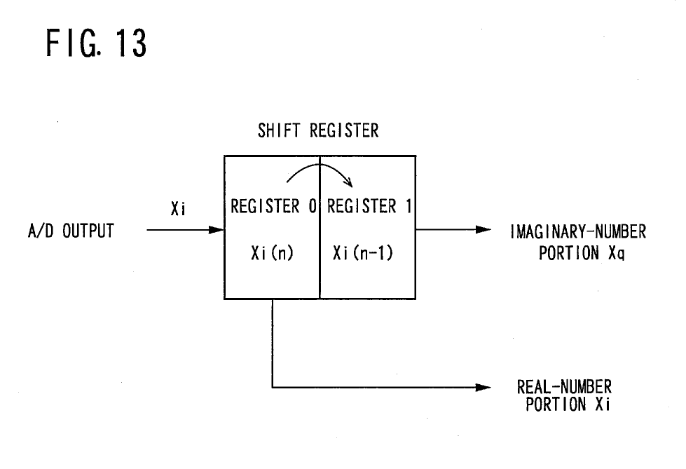

FIG. 13 indicates an example of the functional arrangement of the memory 120 where n is equal to 1.

In the example of FIG. 13, the memory 120 is a two-stage shift register device consisting of a register 0 and a register 1. That is, when a new set of data is written in the register 0, the set of data presently stored in this register is shifted into the register 1. As a result, the sets of signal data generated by the received-signal A/D converting portions 112 are written into the register 0 at the rate of 4f (where n=1), namely at the interval equal to ¼ of the period, and the value of the last set of data presently stored in the register 0 is set as the real-number portion Xi, while the value of the preceding set of data presently stored in the register 1 is set as the imaginary-number portion Xq. These real-number portion Xi and imaginary-number portion Xq corresponding to the last and preceding sets of data are applied to the input-signal real-complex transforming portion 141, so that the complex signal is obtained by transformation from those sets of data.

While the foregoing description applies to the case where n is equal to 1, the memory 120 and the input-signal real-complex transforming portion 141 perform similar functions where n is equal to 2 or larger.

It will be understood from the foregoing description that the radio-frequency tag 14 serves as a signal transmitter device operable to transmit a modulated signal, and that the memory 120 serves as a memory portion operable to sequentially sample the sets of data of the modulated signals received by the plurality of antenna elements, at a rate of 4nf (where n is a positive integer), and sequentially store the sampled sets of data, such that the last sampled set of data and a preceding set of data sampled an n-number of sampling cycles prior to the last sampled set of signal data are readable from the memory portion. It will also be understood that the input-signal real-complex transforming portion 141 serves as a transforming portion operable to obtain data of a complex signal by transformation from the last sampled set of data and the preceding set of data which are respectively used as a real-number portion and an imaginary-number portion of the complex signal.

It will further be understood that the adaptive control portion 150, I-phase converting portions 131a-131c, Q-phase converting portions 134a-134c, I-phase-signal combining portion 132 and Q-phase-signal combining portion 135 cooperate with each other to constitute a control portion operable to change a directivity of the plurality of antenna elements on the basis of the data of the complex signal obtained by said transforming portion, such that the plurality of antenna elements have a maximum sensitivity of reception of the modulated signal from the desired communication object. It will also be understood that the adaptive control portion 150 constitutes a weight determining portion operable to receive a signal based on a composite signal obtained by combining together the sets of data stored in the memory portion, a predetermined target output signal and the data of the complex signal, and to determine weights to be given to the respective modulated signals that are combined together to generate the composite signal, such that the composite signal approaches the target output signal. It will also be understood that the I-phase converting portions 131a-131c, Q-phase converting portions 134a-134c, I-phase-signal combining portion 132 and Q-phase-signal combining portion 135 cooperate with each other to constitute a composite-signal generating portion operable to generate the composite signal by using the weights determined by the weight determining portion.

It will also be understood that ht multiplying portions 142a-142c constitute a coefficient multiplying portion operable to multiply the data of the composite signal obtained by the transforming portion, by a predetermined coefficient, and to apply the composite signal multiplied by the coefficient, to the control portion. It will further be understood that the I-phase LPF 133, Q-phase LPF 136 and demodulated-signal generating portion 137 of the AM-demodulating portion 130 cooperate to constitute a demodulating portion operable to demodulate the composite signal generated by the composite-signal generating portion.

There will be described an operation and advantages of the radio-frequency communication device in the form of the interrogator 100 constructed as described above according to the third embodiment of this invention.

In the present third embodiment, the received signals sampled at the rate of 4nf are stored in the memory 120, and the last sampled set of data of the received signals and the preceding set of data which is sampled n-number of sampling cycles prior to the last sampled set of data and the phase of which is delayed by 90° with respect to that of the last sampled set of data are applied to the input-signal real-complex transforming portion 141. The principle of this third embodiment is based on the fact that the real-number component and the imaginary-number component of a sine wave signal or any other periodic signal have a correlation that the phase of the imaginary-number component is delayed by 90° with respect to that of the real-number component. The input-signal real-complex transforming portion 141 uses the last sampled set of data as the real-number portion, and the preceding set of data (the phase of which is delayed the n-number of sampling cycles with respect to the last sampled set of data) as the imaginary-number portion, to generate the complex signals which are applied to the adaptive control portion 150 to perform the adaptive control of the directivity of the plurality of receiver antenna elements 102 so as to maximize the sensitivity of reception of the received signals from the antenna portion 56 of the circuit element 14s of the radio-frequency tag 14.

Thus, the imaginary-number portion of each complex signal used to perform the adaptive control can be obtained by simply using the preceding set of data the phase of which is delayed with respect to that of the last sampled set of data. Accordingly, the arithmetic operation required to perform the adaptive control can be made simpler in the radio-frequency communication device according to the present third embodiment, than in the conventional device arranged to practice the Hilbert transformation, so that the amount of arithmetic operation performed by the central processing unit (CPU) of the DSP 110 can be reduced, and the present radio-frequency communication device has a high degree of operating reliability.

The composite signals Yi and Yq which are generated by the I-phase combining portion 132 and the Q-phase combining portion 135 and which are to be applied to the demodulating portion 133, 136, 137 are also applied to the adaptive control portion 150 through the composite-signal real-complex transforming portion 151. This arrangement makes it possible to reduce an operational delay due to the number of taps of the I-phase LPF 133, Q-phase LPF 136, and HPF 138, and simplify the required arithmetic operation and reduce the required amount of the arithmetic operation, unlike an arrangement in which the weights are determined on the basis of the composite signals demodulated by the modulating portion.

The third embodiment described above may be modified without departing from the principle of this embodiment.

(1) AM-Demodulating Portion Separate from the Phase-and-Amplitude Control Portion

In the arrangement of FIG. 10, the I-phase converting portions 131a-131c and the Q-phase converting portions 134a-134c which are functional portions of the AM-demodulating portion 130 function as a phase-and-amplitude control portion operable to control the phase and amplitude of the received signals on the basis of the weights determined by the adaptive control portion 150. However, the radio-frequency communication device may be modified to use a phase-and-amplitude control portion separate from the AM-demodulating portion.

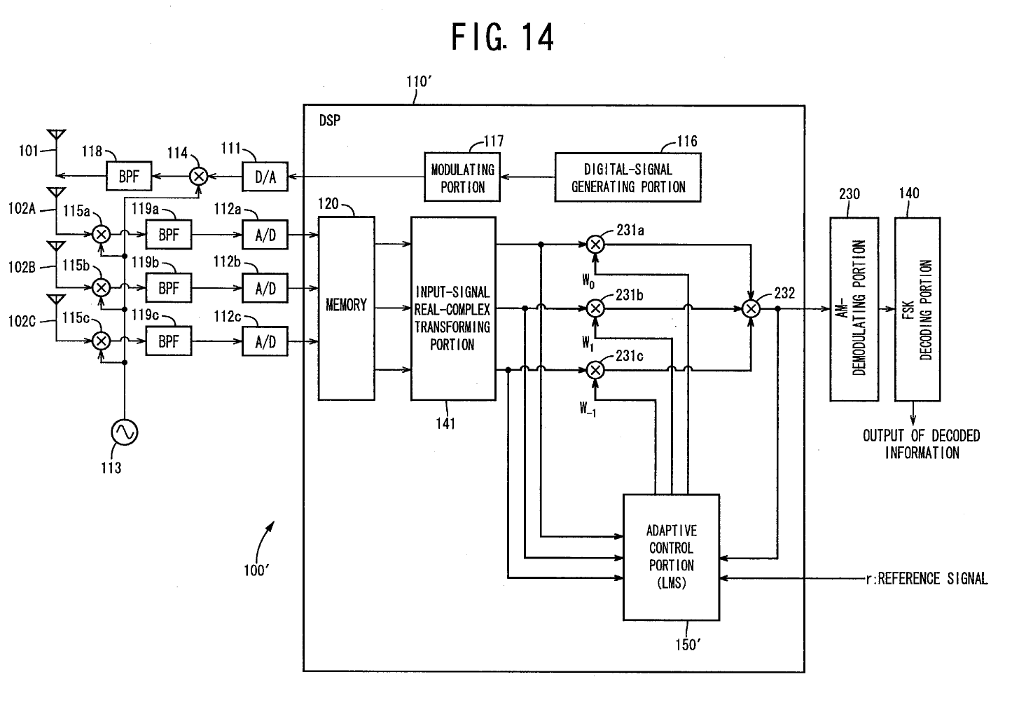

Referring to the block diagram of FIG. 14, there is shown an arrangement of an interrogator 100′ according to on example of such a modification as indicated above. The block diagram of FIG. 14 corresponds to that of FIG. 10. The same reference signs as used in FIG. 10 are used in FIG. 14 to identify the functionally corresponding elements, which will not be described. In FIG. 14, thick solid lines indicate flows of complex-number signals, while thin solid lines indicate flows of real-number signals.

The interrogator 100′ shown in FIG. 14 includes a DSP 110′ which functions as the phase-and-amplitude control portion only, and an AM-demodulating portion 230 which is separate from this phase-and-amplitude control portion.

In the DSP 110′, the received signals (in the form of real-number signals) read out from the memory 120 are transformed by the input-signal real-complex transforming portion 141 into the complex signals in the form of complex-number signals, which are applied to multiplying portions 231a, 231b and 231c and an adaptive control portion 150′. The adaptive control portion 150′ functionally corresponds to the adaptive control portion 150 of FIG. 10. Described in detail, the amplitude and phase of the received signal received by each receiver antenna element 102 are controlled to maximize the sensitivity of reception in the direction toward the radio-frequency tag 14, on the basis of the composite signal which has been obtained by an adding portion 232 by combining together the complex signals generated by the multiplying portions 231. Namely, the phases and amplitudes of the received signals are controlled such that the amplitude of the component modulated by the circuit element 14s and received by each receiver antenna element 102 is increased to a value close to the amplitude of a reference signal (target output signal). Thus, the accuracy of demodulation by the AM-demodulating portion 230 is maximized. To this end, phase/amplitude control signals to be applied from the adaptive control portion 150′ to the multiplying portions 231 are controlled to set the weights to be given to the received signals received by the respective receiver antenna elements 102. These weights are calculated until the calculated weights are converged or stabilized. The complex signals generated by the input-signal real-complex transforming portion 141 are multiplied by the multiplying portions 231, by the respective weights represented by the phase-amplitude control signals received from the adaptive control portion 150′, and the multiplied complex signals are combined together by the adding portion 232 into the composite signal to be applied to the AM-demodulating portion 230.

The memory 120 is arranged to sample the sine wave signals received by each receiver antenna element 102, at the rate of 4nf, and to store the sampled signals such that the last sampled set of data of the sine wave signals and the preceding set of data sampled the n-number of sampling cycles prior to the last sampled set of data are read out from the memory 120 as the real-number portion Xi and the imaginary-number portion Xq to be applied to the input-signal real-complex transforming portion 141. Those sets of data are transformed by the input-signal real-complex transforming portion 141 into the composite signal to be applied to the corresponding multiplying portion 231.

The AM-demodulating portion 230 functionally corresponds to the AM-demodulating portion 130 of FIG. 10. Namely, the composite signal received from the DSP 110′ is converted into an I-phase (In phase) signal Yi and an Q-phase (Quadrature phase) signal Yq, which are combined together into a composite signal, to thereby effect orthogonal IQ demodulation of the received signals. The composite signal generated by the AM-demodulating portion 230 is received by the FSK-decoding portion 140.

It will be understood from the foregoing description of the modified interrogator 100′ that the adaptive control portion 150′ serves as a weight determining portion operable to receive a signal based on a composite signal obtained by combining together the sets of data stored in the memory portion, a predetermined target output signal and the data of the complex signal, and to determine weights to be given to the respective modulated signals that are combined together to generate the composite signal, such that the composite signal approaches the target output signal.

It will also be understood that the multiplying portions 231a-231c and adding portion 232 cooperate with each other to constitute a composite-signal generating portion operable to generate the composite signal by using the complex signals obtained by the transforming portion by transformation from the last sampled sets of data read out from the memory portion, and the weights determined by the weight determining portion.

It will also be understood that the AM-demodulating portion 230 serves as a demodulating portion operable to demodulate the composite signal generated by the composite-signal generating portion.

Like the interrogator 100 of FIG. 10, the present modified interrogator 100′ of FIG. 14 is arranged to reduce the required amount of arithmetic operation to be performed by the central processing unit ‘CPU) of the DSP 110’, and therefore has a high degree of operating reliability.

(2) Modified Memory

In the interrogator 100 of the third embodiment of FIG. 10 and the modified interrogator 100′ described above, the memory 120 is a shift register device. However, the memory 120 may be replaced by a two-stage memory having a first memory portion (memory portion 0) and a second memory portion (memory portion 1) which are selectively and alternately used to the last sample set of data.

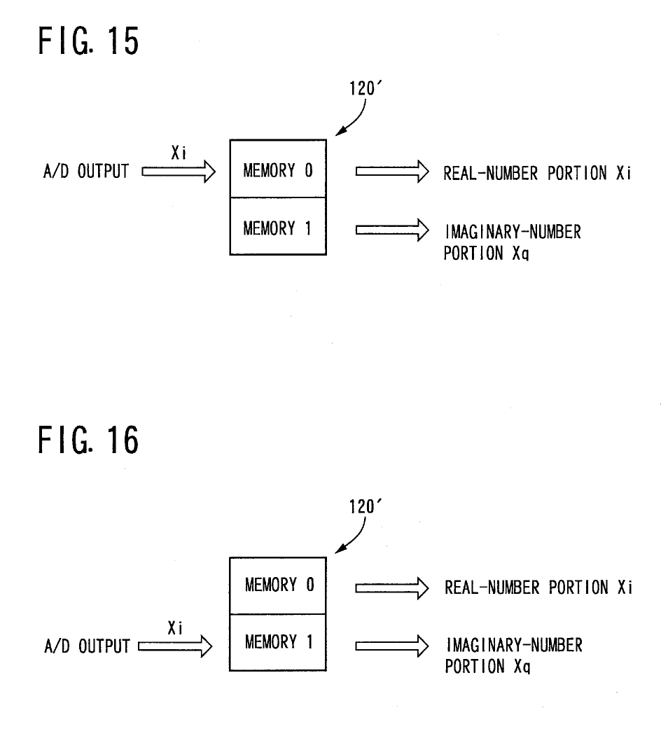

FIGS. 15 and 16 show an example of such a two-stage memory in the form of a memory 120′ having a memory portion 0 and a memory portion 1, which are alternately used to store the last sampled set of data of the received signal received from each received-signal A/D converting portion 112. The memory portion 120′ is alternately placed in a first state and a second state. When the memory 120′ is in the first state, the last sampled set of data is stored in the memory portion 0 as indicated in FIG. 15, and is read out as the real-number portion Xi from this memory portion 0 into the input-signal real-complex transforming portion 141, while the preceding set of data sampled the n-number of sampling cycles prior to the last sampled set of data is read out as the imaginary-number portion Xq from the memory portion 1 into the input-signal real-complex transforming portion 141. When the memory 120′ is placed in the second state, the last set of data is stored in the memory portion 1 as indicated in FIG. 15, and is read out as the real-number portion Xi from this memory portion 1 into the input-signal real-complex transforming portion 141, while the preceding set of data is read out as the imaginary-number portion Xq from the memory portion 0 into the input-signal real-complex transforming portion 141.

The memory 120′ has substantially the same function as the memory 120.

(3) Other Modifications

In the embodiment of FIG. 10 and the modifications of FIG. 14-16, the memory 120, 120′, AM-demodulating portion 130, FSK-decoding portion 140 and adaptive control portion 150, 150′ are functional elements of the DSP 110, 110′. However, those elements may be independent control devices separate from the DSP 110, 110′.

The interrogator 100, 100′ described above uses the transmitter antenna element 101 (for transmitting the transmitted wave Fc toward the radio-frequency tag 14) and the receiver antenna elements 102 (for receiving the reflected wave Fr transmitted from the radio-frequency tag 14), which are provided independently of each other. However, the interrogator may use a transmitter/receiver antenna device arranged to transmit the transmitted wave Fc toward the radio-frequency tag 14 and to receive the reflected wave Fr from the radio-frequency tag 14. In this case, the interrogator uses a transmission/reception switching device such as a circulator, to enable the transmitter/receiver antenna device to function selectively as a transmitter antenna device or a receiver antenna device.

While the interrogator 100, 100′ is used in the radio-frequency communication system S of FIG. 9, the interrogator 100, 100′ may be suitably used in a radio-frequency tag fabricating apparatus arranged to produce radio-frequency tags on which desired information is written, and a radio-frequency tag reader/write arranged to write and read desired information on and from the radio-frequency tags.

### Embodiment 4

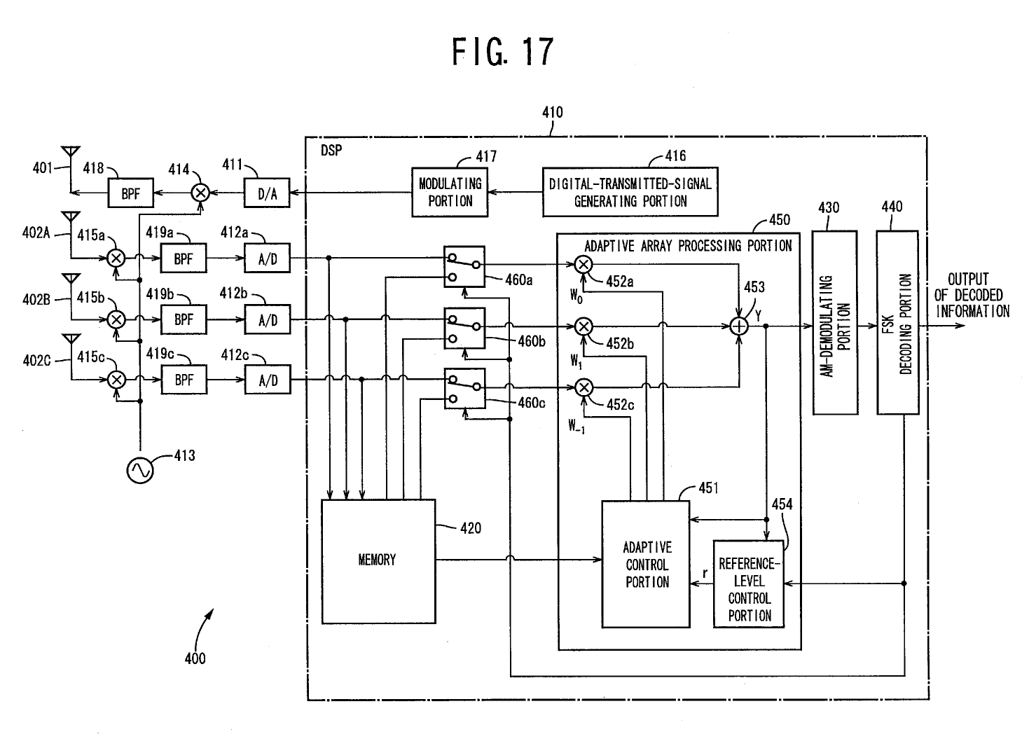

Referring next to FIG. 17, there is shown an arrangement of an interrogator 400 of a radio-frequency tag communication system, which is constructed according to a fourth embodiment of this invention. The interrogator 400 may be suitably used in the radio-frequency communication system S of FIG. 3 or any other radio-frequency communication system such as an RFID system, as an interrogator capable of radio communication with the desired communication object such as the radio-frequency tag 14 of FIG. 3 described above with respect to the first embodiment.

The interrogator 400 has directivity of transmission and reception in a predetermined plane, which directivity is variable for signal transmission and reception with maximum electric power, to and from the antenna portion 56 of the circuit element 14s of the radio-frequency tag 14. The interrogator 100 includes: one transmitter antenna element 401 serving as a transmitter antenna device; three receiver antenna elements 402A, 402B and 402C serving as a receiver antenna device; a DSP (digital signal processor) 410 operable to obtain an access to the IC-circuit portion 58 of the circuit element 14s of the radio-frequency tag 14 through the transmitter and receiver antenna elements 401, 402A-402C, for reading and writing information from and on the IC-circuit portion 58, and to perform digital signal processing operations for outputting the digital transmitted signal (transmitted wave Fc) and demodulating the reply signal (reflected wave Fr) received from the radio-frequency tag 14; a transmitted-signal D/A converting portion 411 operable to convert the digital transmitted signal received from the DSP 110, into an analog signal to be applied to the transmitter antenna element 101; and three received-signal A/D converting portions 412a, 412b and 412c (hereinafter collectively referred to as “received-signal A/D converting portions 412”, unless otherwise specified) having a sampling function and operable to convert the received signals received from the receiver antenna elements 402A-402C, into digital signals to be applied to the DSP 410, and to sample the received signals at a predetermined rate or interval.

When the circuit element 14s of the radio-frequency tag 14 receives the transmitted signal in the form of the transmitted wave Fc from the interrogator 400, the received transmitted wave Fc is modulated according to a predetermined information signal, into the reply signal in the form of the reflected wave Fr, and the reflected wave Fr is received and demodulated by the interrogator 400. Thus, the radio communication is effected between the interrogator 400 and the radio-frequency tag 14.

As shown in FIG. 17, the interrogator 400 further includes, in addition to the above-described transmitter and receiver antenna elements 401, 402A-402C, DSP 410, transmitted-signal D/A converting portion 411 and received-signal A/D converting portion 412: a frequency-converting-signal generating portion 413 operable to generate a predetermined frequency converting signal; an up-converter 414 operable to increase the frequency of the analog transmitted signal received from the transmitted-signal D/A converting portion 411, by an amount corresponding to the frequency of the frequency converting signal generated by the frequency-converting-signal generating portion 413, and to apply the frequency-increased analog transmitted signal to the transmitter antenna element 401; three down-converters 415a, 415b and 415c (hereinafter collectively referred to as “down-converters 415”, unless otherwise specified) each operable to reduce the frequency of the received signal received from each receiver antenna element 402, by an amount corresponding to the frequency of the frequency converting signal generated by the frequency-converting-signal generating portion 413, and to apply the frequency-reduced received signal to the corresponding received-signal A/D converting portion 412; and a band pass filter 418 and three band pass filters 419a, 419b, 419c, each of which is operable to remove an unnecessary component from the analog transmitted signal received from the corresponding up-converter 414 or down-converter 415.

The DSP 410 is a so-called microcomputer system which incorporates a CPU, a ROM and a RAM and which operates to signal processing operations according to control programs stored in the ROM, while utilizing a temporary data storage function of the RAM. The DSP 410 includes: a digital-signal generating portion 416 operable to generate the digital transmitted signal to be transmitted to the circuit element 14s of the radio-frequency tag 14; a modulating portion 417 operable to modulate the digital transmitted signal received from the digital-signal generating portion 416, on the basis of the predetermined information signal (transmitted information), and to apply the modulated digital transmitted signal to the transmitted-signal D/A converting portion 411; a memory 420 serving as a memory portion for storing the received signals received by the receiver antenna elements 402; an adaptive array processing portion 450 operable to perform an adaptive array processing operation by giving suitably determined weights to the respective received signals received by the receiver antenna elements 402; an AM-demodulating portion 430 operable to demodulate an output signal of the adaptive array processing portion 450, for reading predetermined information signals included in the received signals (signals modulated by the circuit element 14s); an FSK-coding portion 440 operable to decode the demodulated signal; and three circuit switching portions 460a, 460b and 460c each of which is operable according to a command signal received from the FSK-decoding portion 440, to select either the received signal received from the memory 420, or the received signal received from the corresponding receiver antenna element 402, for applying the selected received signal to the adaptive array processing portion 450.

The memory 420 is preferably a temporary storage device arranged to store the received signals received by the receiver antenna elements 402, for a predetermined period of time not shorter than a demodulation delay time (which will be described), and not to store the received signals after the predetermined period of time has passed. For example, the memory 420 is a RAM or a hard disk.

The adaptive array processing portion 450 includes: an adaptive control portion (LMS control portion: least mean square control portion) 451 operable to control weights to be given to the respective received signals read out from the memory 420, according to a least mean square method; three multiplying portions 452a-452c operable to multiply the received signals received from the circuit switching portions 460, by the weights controlled by the adaptive control portion 451; and an adding portion 453 operable to combine together the outputs of the multiplying portions 460; and a reference-level control portion 454 operable to set a level r of a reference signal (target output signal), which will be described.

The adaptive control portion 451 is arranged to control the amplitude and phase of the received signal received by each receiver antenna element 402, so as to maximize the sensitivity of reception in the direction toward the radio-frequency tag 14, on the basis of the composite signal which has been obtained by the adding portion 453. Namely, the phases and amplitudes of the received signals are controlled such that the amplitude of the reflected wave Fr received from the circuit element 14s and received by each receiver antenna element 402 is maximized to a value close to the level r of the reference signal set by the reference-level control portion 454. To this end, phase/amplitude control signals to be applied from the adaptive control portion 451 to the multiplying portions 452 are controlled to set the weights to be given to the received signals received by the respective receiver antenna elements 402A, 402B and 402C. These weights are calculated until the calculated weights are converged or stabilized. Thus, the accuracy of demodulation by the AM-demodulating portion 430 can be maximized. The received signals received by the multiplying portions 452 and subjected to the adaptive array processing according to the control signals generated by the adaptive control portion 451 are combined together by the adding portion 453, and a composite signal generated by the adding portion 453 is applied to the AM-demodulating portion 430.

The AM-demodulating portion 430 is preferably arranged to effect orthogonal IQ demodulation, namely, to convert each of the received signals into an I-phase (in-phase) signal and a Q-phase (quadrature-phase) signal, and to combine together a composite I-phase signal Yi and a composite Q-phase signal Yq, for thereby demodulating the received signal. The I-phase signal and the Q-phase signal have a phase difference of 90°.

In the interrogator 400 constructed as described above, the digital transmitted signal generated by the digital-signal generating portion 416 is modulated by the modulating portion 417 on the basis of the predetermined transmitted information, and the modulated digital transmitted signal is converted by the transmitted-signal D/A converting portion 411 into the analog transmitted signal the frequency of which is increased by the up-converter 414, by the amount corresponding to the frequency of the frequency converting signal generated by the frequency-converting-signal generating portion 413. The analog transmitted signal the frequency of which is increased by the up-converter 414 is applied to the transmitter antenna element 401, and transmitted as the transmitted wave Fc toward the circuit element 14s of the radio-frequency tag 14.

When the transmitted wave Fc transmitted from the transmitter antenna element 401 of the interrogator 400 is received by the antenna portion 56 of the circuit element 14s of the radio-frequency tag 14, the received transmitted wave Fc is demodulated by the modulating/demodulating portion 68 (shown in FIG. 3). Further, a part of the transmitted wave Fc is rectified by the rectifying portion 60 into an electric energy to be stored in the power source portion 62. This electric energy is used by the control portion 70 to generate the reply signal on the basis of the predetermined information signal stored in the memory portion 66. On the basis of the reply signal, the modulating/demodulating portion 68 modulates the received transmitted wave Fc into the reflected wave Fr to be transmitted from the antenna portion 56 toward the interrogator 400.

When the reflected wave Fr transmitted from the antenna portion 56 of the circuit element 14s is received by each of the receiver antenna elements 402A, 402B, 402C of the interrogator 400, and applied to the corresponding down-converter 415 so that the frequency of the reflected wave Fr is reduced by the amount corresponding to the frequency of the frequency converting signal generated by the frequency-converting-signal generating portion 413. The frequency-reduced signal (received signal) is converted by the corresponding received-signal A/D converting portion 412 into the digital received signal, which is stored in the memory 420.

Before the DSP 410 detects the start point (leading edge) of an input information signal, that is, in a first cycle of operation of the DSP 410, each of the circuit switching portions 460 is placed in a first state of FIG. 17 in which the output of the corresponding received-signal A/D converting portion 412, that is, the received signal received by the corresponding receiver antenna element 402 is applied to the AM-demodulating portion 430 through the circuit switching portion 460, while the output of the memory 420 is not applied to the AM-demodulating portion 420 through the circuit switching portion 460. When the digital received signals are applied from the received-signal A/D converting portion 412 to the AM-demodulating portion 430 through the circuit switching portion 460 placed in this first state, the received signals are converted into the I-phase signals and the Q-phase signals which have the phase difference of 90°, as described above with respect to the third embodiment. The I-phase signals received by the three receiver antenna elements 402 are combined together by the adding portion 453, to obtain the composite I-phase signal a predetermined frequency component of which is passed through a low pass filter (not shown), while the Q-phase signals received by the receiver antenna elements 402 are combined together by the adding portion 453, to obtain the composite Q-phase signal a predetermined frequency component of which is passed through a low pass filter (not shown). These frequency components of the composite I-phase and Q-phase signals are combined together, so as to obtain the root square of (I²+Q²), whereby the demodulated signal is generated. A predetermined frequency component of the demodulated signal which is passed through a high pass filter (not shown) is applied as an AM-demodulated wave to the FSK-decoding portion 440, to obtain the decoded information.

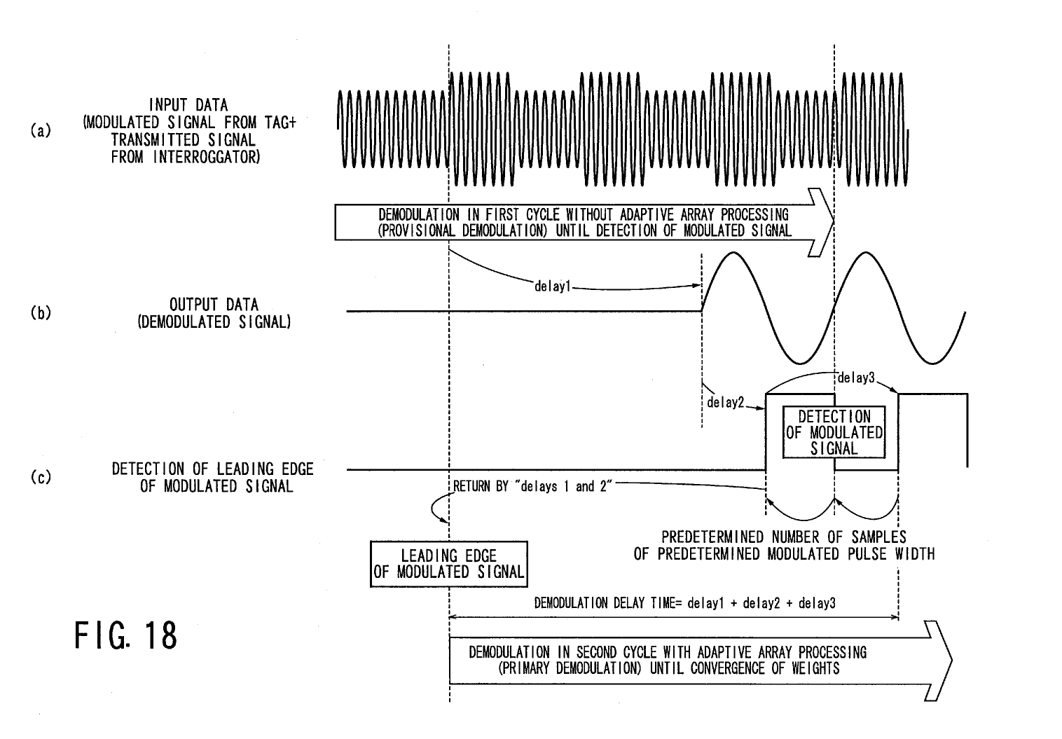

Referring to FIG. 18, there will be explained an operation of the adaptive array processing portion 450 to detect the start point of the input information signal.

The reflected wave Fr (received signal) which is transmitted from the circuit element 14s of the radio-frequency tag 14 and which is received by each receiver antenna element 402 is a composite signal consisting of the transmitted wave Fc (transmitted signal) transmitted from the transmitter antenna 401 and the modulated signal generated by the circuit element 14s (sub carrier wave modulated by the circuit element 14s according to the predetermined information signal). FIG. 18 indicates, at (a), input data (reflected wave Fr or received signal) of the interrogator 400. The modulated signal generated by the circuit element 14s corresponds to portions of the input data which have comparatively large amplitudes. The input data or received signal is demodulated by the AM-demodulating portion 430 into the demodulated signal, which is the output data of the AM-demodulating portion 430 as indicated at (b) in FIG. 18. The phase and amplitude of the output data correspond to those of the modulated signal generated by the circuit element 14s. The demodulation of the modulated signal by the AM-demodulating portion 430 requires a predetermined length of time. Accordingly, there exists a predetermined initial delay from the moment of reception by the AM-demodulating portion 430 of the received signal including the demodulated signal received from the circuit element 14s, to the moment at which the demodulated signal corresponding to the modulated signal is generated by the AM-demodulating portion 430.

The present fourth embodiment is arranged to perform the adaptive array processing operation corresponding to this initial delay. To this end, the FSK-decoding portion 440 functions as an edge detecting portion operable to detect the start point of the modulated signal. That is, the leading edge or start point of the modulated signal which is generated by the circuit element 14s and which is included in the received signal is detected on the basis of the output signal (decoded signal) of the FSK-decoding portion 440. For instance, the FSK-decoding portion 44 is arranged to determine whether an interval of changes of the amplitude or phase of the decoded signal is held within a predetermined range. If the interval of changes deviates from the predetermined range after initiation of control of the weights by the adaptive array processing portion 450, the setting of the adaptive array processing portion 450 is initialized, and the edge detecting portion is commanded to detect the leading edge or start point of the modulated signal.

In the control to detect the start point of the modulated signal (received signal), a determination is made as to whether a predetermined number of signal pulses having a predetermined width has been detected. If the affirmative determination is obtained, it is determined that the point at which the affirmative determination is obtained corresponds to the leading edge or start point of the modulated signal generated by the circuit element 14s. This determination or detection of the start point requires a predetermined time including operating delays of the low pass filter and high pass filter indicated above, so that there exists the above-indicated predetermined initial delay between the moment of reception of the modulated signal by the AM-demodulating portion 430 and the moment of detection of the start point of the modulated signal. When the start point of the modulated signal is detected, the FSK-decoding portion 440 which functions as the edge detecting portion commands the circuit switching portions 460 to connect the memory 420 to the AM-demodulating portion 430, so that the sampled sets of data of the received signal after the detection of the start point of the modulated signal are read out from the memory 420 are applied to the AM-demodulating portion 430 through the circuit switching portions 460. Described more specifically, the first set of data to be read out from the memory 420 and applied to the AM-demodulating portion 430 corresponds to a moment which is prior to the moment of detection of the start point, by a time length which is a sum of a first delay time “delay 1” due to the demodulation in the first cycle (provisional demodulation), a second delay time “delay 2” due to the detection of the start point of the modulated signal (including in the demodulated signal), and a third delay time “delay 3” corresponding to the predetermined number of samples of signal pulses having the predetermined width, which are counted to detect the start point. For example, the above-indicated sum of the delay times corresponds to about 100 samples of the signal pulses. The demodulation of the received signals read out from the memory 420 is referred to as the primary demodulation as distinguished from the provisional demodulation indicated above. The initial delay takes place at the time of detection of the start point, and does not take place while the weights to be given to the respective sets of data read out from the memory 420 are updated by the adaptive control portion 451 of the adaptive array processing portion 450.

After the moment of detection of the start point or leading edge of the modulated signal, namely, after the second and following cycles of control operation of the DSP 410, the primary demodulation is effected by the AM-demodulating portion 430 while the circuit switching portions 460 are placed in the second state in which the sets of data of the received signals read out from the memory 420 are applied to the AM-demodulating portion 430 through the circuit switching portions 460. In the primary demodulation, the above-indicated first set of data and the following sets of data are subjected to the adaptive array processing operation by the adaptive array processing portion 450.

In the adaptive array processing operation by the adaptive array processing portion 450, the weights to be given to the respective sets of received signals read out from the memory 420 are controlled or updated to control the directivity of the receiver antenna elements 402, for maximizing the sensitivity of reception of the received signals in the direction in which the circuit element 14s of the radio-frequency tag 14 is located. Described in detail, the amplitude and phase of the received signal received by each receiver antenna element 402 are controlled on the basis of the received signals read out from the memory 420, such that the amplitude of the modulated signal (reflected wave) received from the circuit element 14s and received by each receiver antenna element 402 is increased to a value close to the amplitude of the reference signal, so that the accuracy of demodulation by the AM-demodulating portion 430 is maximized. In this adaptive array processing operation, the received signals received from the receiver antenna elements 402 through the received-signal A/D converting portions 412 are not applied to the AM-modulating portion 430, as described above.

The received signals subjected to the adaptive array processing operation according to the control signals generated by the adaptive array processing portion 450 and demodulated into the demodulated signals by the AM-demodulating portion 430 are finally decoded into the decoded signal by the FSK-decoding portion 440.

The interrogator 400 according to the present fourth embodiment is characterized by the adaptive array processing portion arranged to perform the adaptive array processing operation.

Namely, the adaptive array processing portion 450 is arranged to control and updates the weights such that the level of each received signal multiplied by the controlled weight approaches a target signal level which is the level of the reference signal. Thus, the level of the reference signal, rather than the waveform of the reference signal used in the conventional adaptive array processing operation, is used to control the weights so that the controlled weight can be converged or stabilized in a relatively short time.

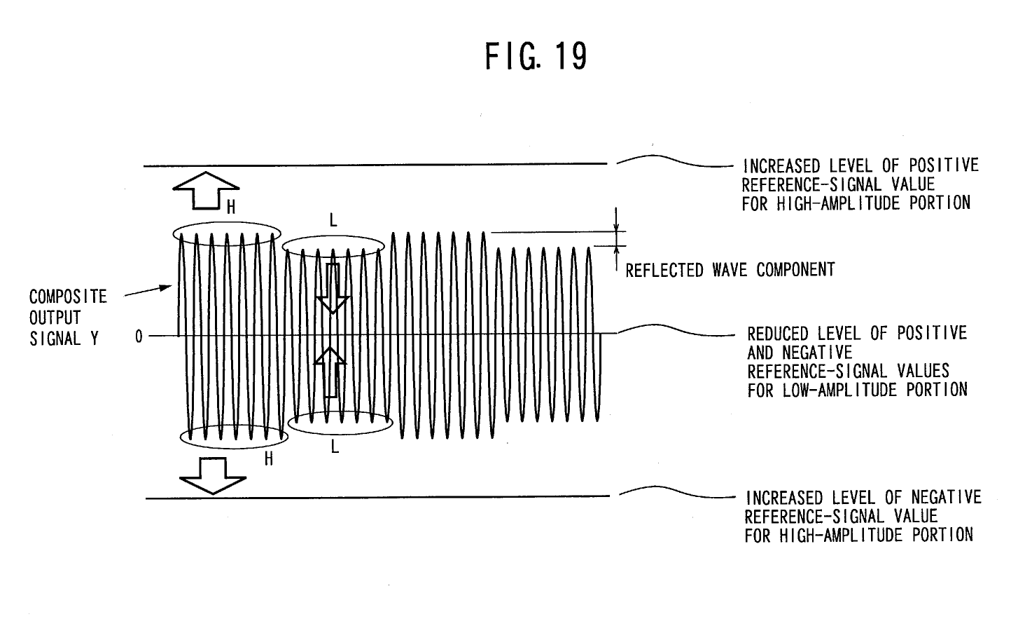

FIG. 19 schematically shows the method of the adaptive array processing by the adaptive array processing portion 450 in the present fourth embodiment.

As shown in FIG. 19, a composite output signal Y of the adding portion 453 (adaptive array processing portion 450) obtained by combining together the received signals received by the receiver antenna elements 402 consists of a portion corresponding to the reflected wave Fr from the circuit element 144s and having a high amplitude (as represented by an envelope of sine-wave pulses; indicated at “H” in FIG. 19), and the other portion having a low amplitude (indicated at “L” in FIG. 19). The envelope of the multiple sine-wave pulses represents a generally rectangular waveform of the reflected wave Fr transmitted from the radio-frequency tag 14. This rectangular waveform has an amplitude corresponding to a difference between the above-indicated high and low amplitudes (“H” and “L”). For efficient detection of the reflected wave Fr, the rectangular waveform is required to have a high degree of rectangularity. To this end, the adaptive array processing portion 450 is arranged to update the weights such that the level of the high-amplitude portion of the composite output signal Y is increased while the level of the low-amplitude portion is reduced.

Described more specifically, the level of a positive component (located above an amplitude centerline 0 indicated in FIG. 19) of the high-amplitude portion (H) of the composite output signal Y is set to an increased level (an increased absolute value of the amplitude of the positive component of the high-amplitude portion), while the level of a negative component (located below the amplitude centerline 0 of the high-amplitude portion (H) is set to an increased level (an increased absolute value of the amplitude of the negative component of the high-amplitude portion). The weights are updated such that the levels of the positive and negative components of the high-amplitude portions of the composite output signal Y coincide with or approach those increased absolute values, as indicated by relatively short white arrows in FIG. 19. These increased absolute values are considered to be increased levels of positive and negative values of a target signal.

On the other hand, the level of a positive component (located above the amplitude centerline 0) and the level of a negative component (located below the amplitude centerline 0) of the low-amplitude portion of the composite output signal Y are set to reduced levels (reduced absolute values of the amplitudes of the positive and negative components of the low-amplitude portion). The weights are updated such that the levels of the positive and negative components of the low-amplitude portion of the composite output signal Y coincide with or approach those reduced absolute values, as indicated by relatively long white arrows in FIG. 19. These reduced absolute values are considered to be reduced levels of the positive and negative values of the target signal.

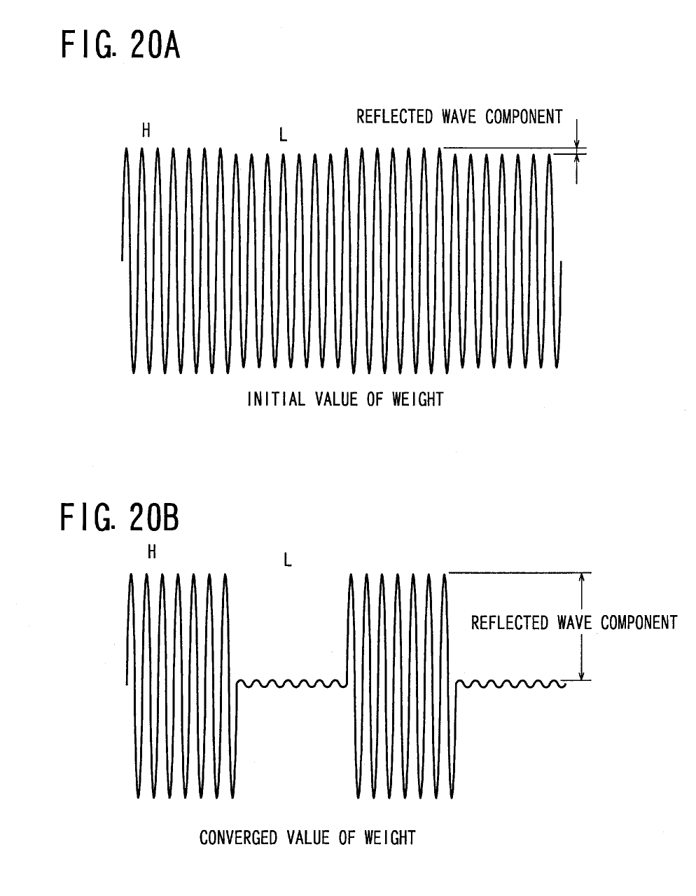

Referring to FIGS. 20A and 20B, there will be explained an example of a behavior of convergence of the weight as the weight is updated. In the example shown, an initial value of the weight does not cause a large difference between the level (H) of the high-amplitude portion and the level (L) of the low-amplitude portion of the composite output signal Y, as shown in FIG. 20A, so that the reflected wave component of the received signal which corresponds to the difference cannot be distinctively detected, and is easily influenced by a noise. However, the weight is updated by the adaptive array processing portion 450, until the weight is converged or stabilized to an optimum value, so that the difference between the levels (H, L) of the high-amplitude and low-amplitude portions of the composite output signal Y is increased to a sufficiently large value as indicated in FIG. 20B, as a result of the weight being updated so as to control the directivity of the receiver antenna elements 402 such that the null of the directivity is oriented in the direction toward a source of the noise or interfering wave, while the main beam of the directivity is oriented in the direction toward the radio-frequency tag 14. Accordingly, the ratio of the reflected wave component of the composite output signal Y is increased, and the rectangularity of the envelope of the sine-wave pulses indicated above is increased, whereby the composite output signal Y can be demodulated with a reduced influence of the noise.

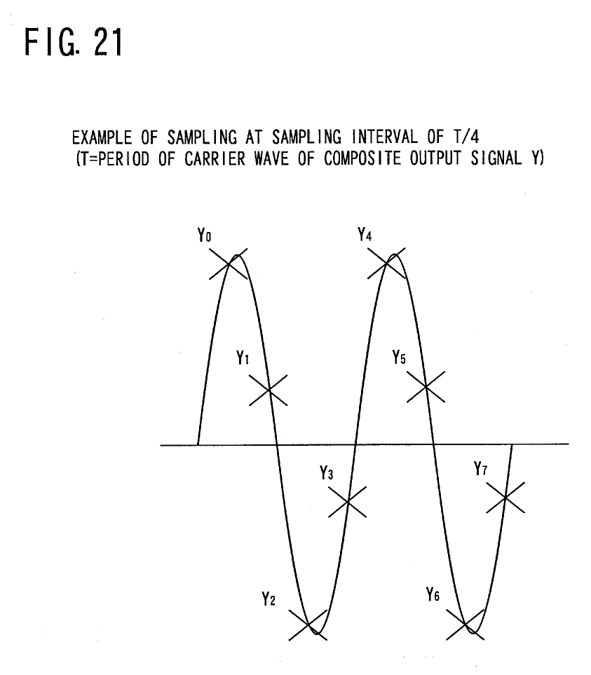

FIG. 21 shows an example of sampling of the received sine-wave signal by the received-signal A/D converting portion 412 during the adaptive array processing operation in which the levels of the reference signal for the composite output signal Y are set to the above-described increased levels of the target signal. The received-signal A/D converting portion 412 is arranged to sample the received signal (sine-wave signal) at a predetermined interval of (½n)T (where n=positive integer), on the assumption that the signal transmitted from the transponder in the form of the radio-frequency tag 14 (more precisely, from the antenna portion 56) is a periodic sine-wave signal having a frequency f (period T=1/f).

For example, the received-signal A/D converting portion 412 samples the sine-wave signal received by the corresponding receiver antenna element 402, at the interval of T/4 (one quarter of the period T), that is, obtains samples Y1, Y2, Y3, Y4, Y5, Y6, Y7, . . . such that four samples are obtained during the period T.

The waveform of the sampled sine-wave signal as shown in FIG. 21 is applicable to both the high-amplitude portion and the low-amplitude portion of the received sine-wave signal.

Where the high-amplitude portion has the waveform as indicated in FIG. 21, the weight is updated to change the levels of the even-numbered samples Y0, Y2, Y4 and Y6, so that the level of the positive-value samples Y0 and Y4 coincides with or approaches the increased level (absolute value) of the positive value of the reference signal (target signal), while the level of the negative-value samples Y2 and Y6 coincides with or approaches the increased level (absolute value) of the negative value of the reference signal.

Where the low-amplitude portion of the received sine-wave signal has the waveform as indicated in FIG. 21, the weight is updated to change the levels of the even-numbered samples Y0, Y2, Y4 and Y6, so that the level of the positive-value samples Y0 and Y4 coincides or approaches the reduced level (absolute value) of the positive value of the reference signal, while the level of the negative value samples Y2 and Y6 coincides with or approaches the reduced level (absolute value) of the negative value of the reference signal.

The weight may or may not be updated to also change the levels of the odd-numbered samples Y1, Y3, Y5 and Y7. Where the levels of the odd-numbered samples are also changed, the levels of the positive and negative values of reference signal (target signal) may be suitably set, in addition to the levels for the even-numbered samples.

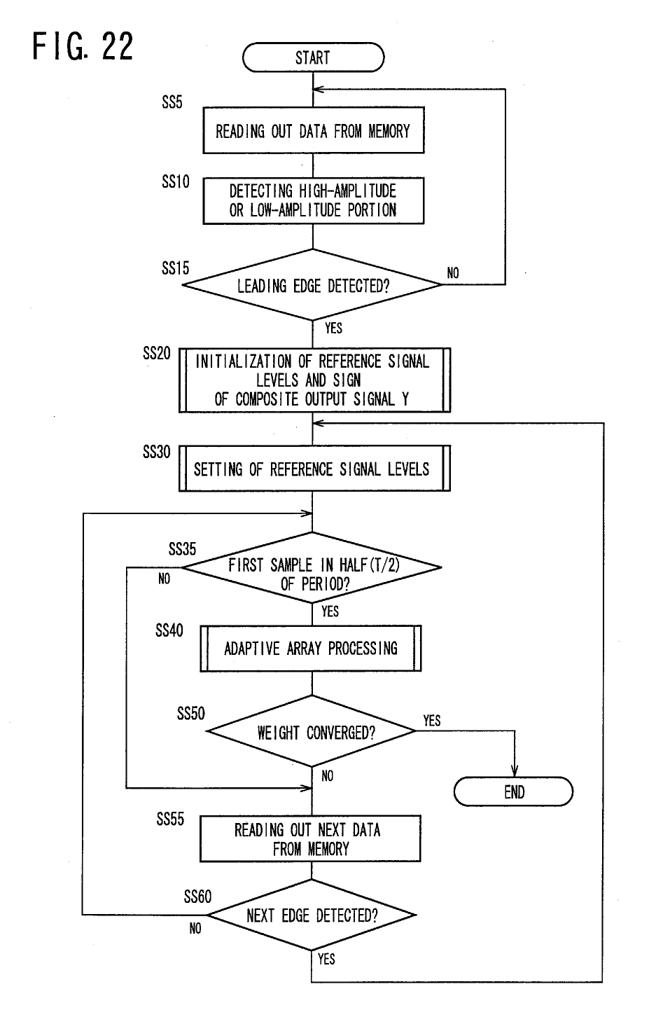

Referring to the flow chart of FIG. 22, there will be described an adaptive array processing routine executed by the adaptive array processing portion 420, on the basis of the received signals read out from the memory 420.

The adaptive array processing routine of FIG. 22 is initiated with step SS5 in which the adaptive control portion 451 reads out the set of data of the received signal from the memory 420.

Then, the control flow goes to step SS10 to determine whether the set of data of the received signal read out into the adaptive control portion 451 corresponds to the high-amplitude portion (H) or the low-amplitude portion (L) of the composite output signal Y. This determination may be made in a suitable manner, for instance, by comparing an average amplitude of the set of data with a threshold value.

Step SS10 is followed by step SS15 in which the reference-level control portion 454 determines whether the leading or first edge of the demodulated signal (the first rising edge or falling edge of the rectangular waveform of the demodulated signal) has been detected. This determination is made on the basis of the signal received from the FSK-decoding portion 440. Steps SS5 and SS10 are repeatedly implemented until an affirmative determination is obtained in step SS15. When the affirmative determination is obtained in step SS15, the control flow goes to step SS20.

In step SS20, the levels of the positive and negative values of the reference signal and the sign (positive or negative) of the composite output signal Y subjected to the adaptive array processing operation are initialized or set to predetermined initial values before the sampled set of data of the received signal read out from the memory 420 is subjected to the adaptive array processing operation by the adaptive array processing portion 451, according to the levels of the reference sign set by the reference-level control portion 454. The manner of the initialization will be described in detail.

The control flow then goes to step SS30 in which the reference-level control portion 454 sets the levels of the reference signal (target signal) used by the adaptive control portion 451 to calculate or determine the weights. These reference signal levels are set on the basis of the presently set levels and sign of the composite output signal Y, as described below in detail.

Step SS30 is followed by step SS35 in which the adaptive control portion 451 determines whether the identification number of the sampled set of data of the received signal read out from the memory 420 is equal to one of the predetermined identification numbers of the samples selected for the adaptive array processing operation. For example, the adaptive control portion 451 determines whether the sample read out from the memory 420 is the first sample (e.g., sample Y0, Y2, Y4 or Y6) in each half (T/2) of the period T of the received sine-wave signal. This determination is made to assure that the increased or reduced level of the positive value of the reference signal is set for the positive component of the high-amplitude or low-amplitude portion of the received sine-wave signal in each period T, and the increased or reduced level of the negative value of the reference signal is set for the negative component of the high-amplitude or low-amplitude portion in each period T, and to assure that a predetermined number of samples exist between the two samples for which the increased or reduced levels of the positive and negative values of the reference signal are set. If an affirmative determination is obtained in step SS35, the control flow goes to step SS40. If a negative determination is obtained in step SS35, the control flow goes to step SS55 while skipping steps SS40 and SS50.

In step SS40, the adaptive control portion 451 calculates the weight so that the levels of the high-amplitude portion (H) of the composite output signal Y coincide with or approach the levels of the reference signal set for the high-amplitude portion in step SS30, while the levels of the low-amplitude portion (L) coincide with or approach the levels of the reference signal set for the low-amplitude portion in step SS30. Accordingly, the composite output signal Y obtained by the adding portion 453 is controlled according to the calculated weight, so that the amplitude and phase of the received signal received by each receiver antenna element 402 are controlled to control the directivity of the receiver antenna elements 402, that is, to maximize the sensitivity of reception of the received signal in the direction in which the radio-frequency tag 14 is located.

In step SS50, the adaptive control portion 451 determines whether the weight calculated for the adaptive array processing operation in step SS40 has been converged or stabilized. If an affirmative determination is obtained in step SS50, the present adaptive array processing routine is terminated. If a negative determination is obtained in step SS50, the control flow goes to step SS55.

In step SS55 which is identical with step SS5, the adaptive control portion 451 reads out the next set of data of the received signal from the memory 420.

The control flow then goes to step SS70 in which the reference-level control portion 454 determines whether the next edge of the demodulated signal (the next rising edge or falling edge of the rectangular waveform of the demodulated signal) has been detected. Steps SS35 through SS55 are repeatedly implemented as long as a negative determination is obtained in step SS60. If an affirmative determination is obtained in step SS60, the control flow goes back to step SS30 to set the levels of the reference signal, and the following steps described above.

As described above, steps SS35, SS40, SS50, SS55 and SS60 are repeatedly implemented to repeatedly calculate the weight until the levels of the high-amplitude portion (or the low-amplitude portion) of the received sine-wave signal corresponding to the two adjacent edges of the rectangular demodulated signal coincide with the increased levels (or reduced levels) of the reference signal set in step SS30. When the next edge of the demodulated signal is detected, that is, when the affirmative determination is obtained in step SS60, the levels of the reference signal are changed in step SS30, from the levels for the high-amplitude portion to the levels for the low-amplitude portion, or vice versa, and the weight is updated in step SS40 so that the levels of the low-amplitude portion (or the high-amplitude portion) of the received sine-wave signal corresponding to the next two adjacent edges are reduced (or increased) to the reduced levels (or increased levels) set in step SS30. Thus, the weight is changed so as to increase the difference between the amplitude of the high-amplitude portion (H) and the amplitude of the low-amplitude portion (L), as indicated in FIGS. 19 and 20, whereby the sensitivity of reception of the received signals is improved.

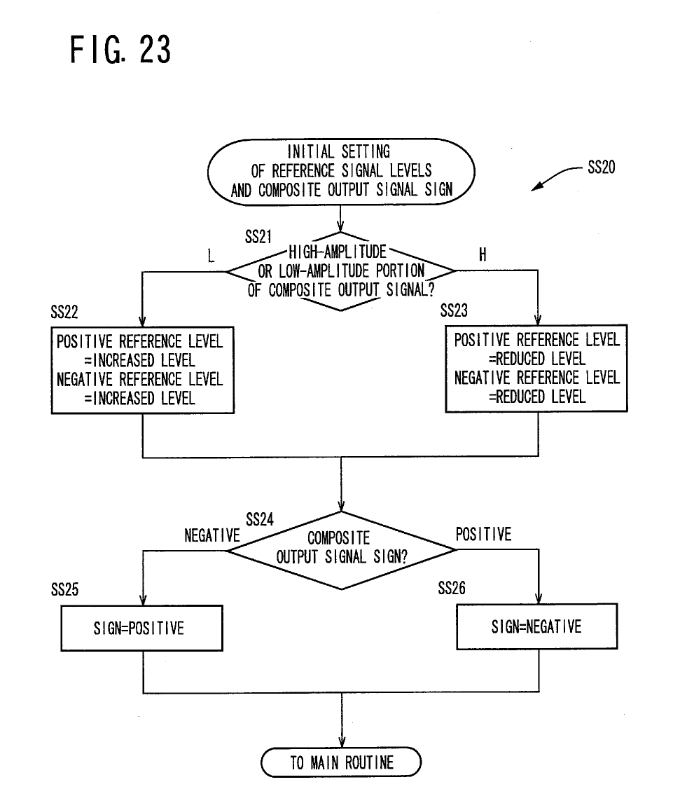

Referring to the flow chart of FIG. 23, there will be described in detail step SS20 of FIG. 22 implemented by the adaptive control portion 451 and the reference-level control portion 454 after the leading or first edge (rising or falling edge) of the rectangular modulated signal has been detected, that is, when the affirmative determination is obtained in step SS15.

An initial setting routine of FIG. 23 is initiated with step SS21 to determine whether the whether the value of the composite output signal Y after detection of the leading edge corresponds to the high-amplitude portion (H) or the low-amplitude portion (L). This determination may be made in a suitable manner, for instance, by comparing an average amplitude of the set of data with a threshold value.

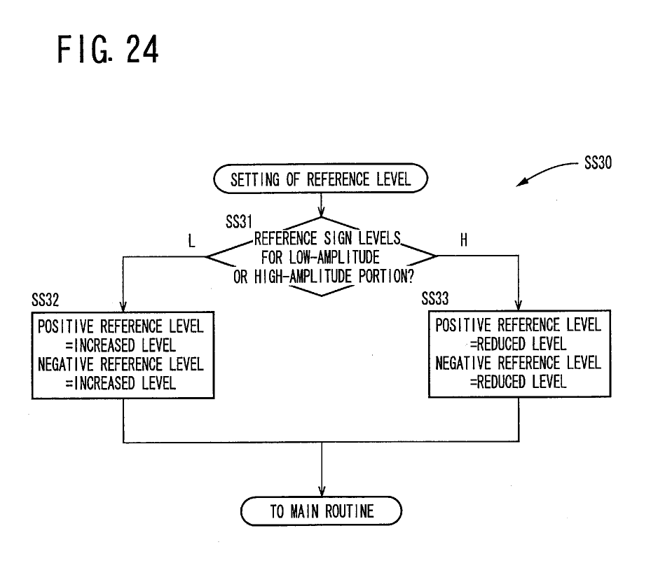

If the value of the composite output signal Y after detection of the leading edge corresponds to the low-amplitude portion, the control flow goes to step SS22 to set the predetermined increased levels as the positive and negative values of the reference signal for the positive and negative components of the high-amplitude portion. The predetermined increased levels are set for the high-amplitude portion when the value of the composite output signal Y corresponds to the low-amplitude portion, because a reference-level setting routine of FIG. 24 (described below) is formulated such that the levels of the positive and negative values of the reference signal are changed from the levels for the high-amplitude portion to the levels for the low-amplitude portions, or vice versa, in steps SS32 and SS33, as described in the following paragraphs [0205] and [0206].

If the value of the composite output signal Y after detection of the leading edge corresponds to the high-amplitude portion, on the other hand, the control flow goes to step SS23 to set the predetermined reduced levels as the positive and negative values of the reference signal for the positive and negative components of the low-amplitude portion.

Steps SS22 and SS23 are followed by step SS24 to determine whether the sign of the composite output signal Y after detection of the leading edge is positive or negative.

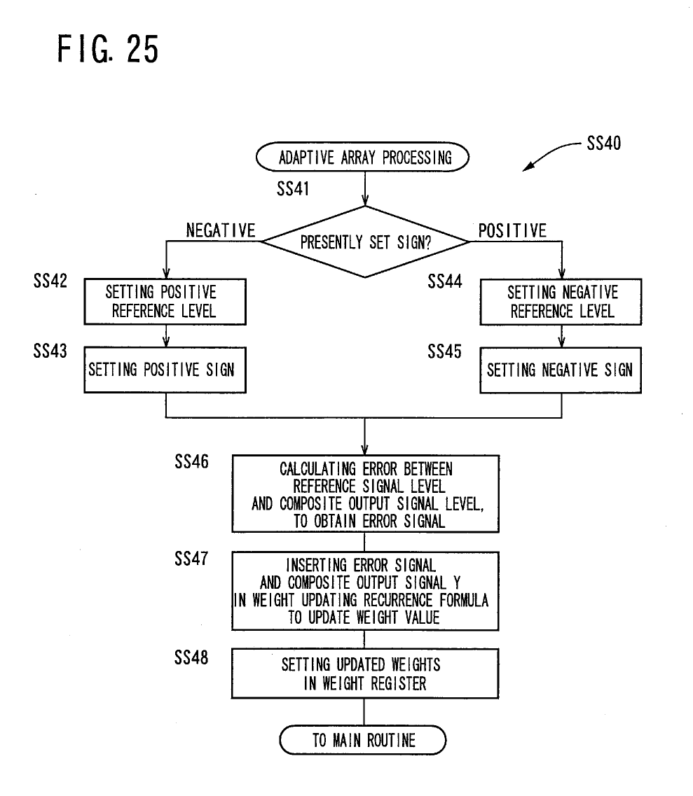

If the sign of the composite output signal Y is negative, the control flow goes to step SS25 to set the positive sign for the composite output signal Y, because an adaptive array processing routine of FIG. 25 (described below) is formulated such that the sign of the composite output signal Y is changed from the positive sign to the negative signs, or vice versa, in steps SS43 and SS45.

If the sign of the composite output signal Y is positive, on the other hand, the control flow goes to step SS26 to set the negative sign for the composite output signal Y.

Steps SS25 and SS26 are followed by step SS30 of the main control routine of FIG. 22.

Referring to the flow chart of FIG. 24, there will be described in detail step SS30 of FIG. 22 implemented by the reference-level control portion 454 after step SS25 or SS26 of FIG. 23 is implemented.

The reference-level control routine of FIG. 24 is initiated with step SS31 to determine whether the levels of the positive and negative values of the reference signal which are presently set are the levels for the high-amplitude portion or the low-amplitude portion.

If the presently set levels are the levels for the low-amplitude portion, the control flow goes to step SS32 to set the predetermined increased levels as the positive and negative values of the reference signal for the positive and negative components of the high-amplitude portion.

If the presently set levels are the levels for the high-amplitude portion, on the other hand, the control flow goes to step SS33 to set the predetermined reduced levels as the positive and negative values of the reference signal for the positive and negative components of the low-amplitude portion.

Steps SS32 and SS33 are followed by step SS35 of the main control routine of FIG. 22.

As described above, the reference-level setting routine of FIG. 24 (step SS30 of FIG. 22) is formulated such that the levels of the positive and negative values of the reference signal are changed from the levels for the presently detected low-amplitude or high-amplitude portion to the levels for the other amplitude portion. Therefore, when step SS30 is implemented after the next rising or falling edge of the rectangular demodulated signal is detected in step SS60, the levels of the reference signal are changed from the levels for the low-amplitude portion prior to the detection of the rising edge to the levels for the high-amplitude portion after the detection of the rising edge, or from the levels for the high-amplitude portion prior to the detection of the falling edge to the levels for the low-amplitude portion after the detection of the falling edge.

Further, the initial setting routine of FIG. 23 (step SS20) of FIG. 22) is formulated such that when step SS30 is implemented for the first time following the initial setting in step SS20, the levels of the reference signal are correctly set for the high-amplitude or low-amplitude portion of the composite output signal Y detected in step SS15.

Referring to the flow chart of FIG. 25, there will be described in detail step SS40 of FIG. 22 implemented by the adaptive control portion 451 and the reference-level control portion 454 when the affirmative determination is obtained in step SS35.

The adaptive array processing routine of FIG. 25 is initiated with step SS41 to determine whether the presently set sign of the composite output signal Y is the positive sign or negative sign.

If the presently set sign is the negative sign, the control flow goes to step SS42 to set the level for the positive value of the reference signal, and to step SS43 to set the positive sign of the composite output signal Y.

If the presently set sign is the positive sign, on the other hand, the control flow goes to step SS44 to set the level for the negative value of the reference signal, and to step SS45 to set the negative sign of the composite output signal Y.

Steps SS43 and SS44 are followed by step SS46.

Step SS46 is provided to calculate an error between the level of the composite output signal Y of the adding portion 453 to which the positive or negative sign has been assigned in step SS43 or SS45, and the level of the reference sign set in step SS42 or SS45, whereby an error signal representative of the calculated error is obtained.

Then, the control flow goes to step SS47 in which the error signal obtained in step SS46 and the composite output signal Y of the adding portion 453 (which is an input signal applied to the adaptive control portion 451) are inserted in a suitable weight updating recurrence formula (such as a least mean square algorithm), to update the weights to be given to the respective multiplying portions 452.

Step SS47 is followed by step SS48 to store the weights updated in step SS47, in a weight register provided in the adaptive control portion 451.

The phase control signals representative of the thus updated weights are applied from the adaptive control portion 451 to the respective multiplying portions 452, so that the received signals received by the respective receiver antenna elements 402 are multiplied by the multiplying portions 452, by the corresponding weights given by the adaptive control portion 451. As a result, the directivity of the receiver antenna elements 402 is controlled to maximize the reflected wave component of the received signals, that is, to maximize the sensitivity of reception of the reflected wave Fr included in the received signals.

As described above, the weights are updated to maximize the sensitivity of reception of the reflected wave Fr by repeatedly implementing steps SS35, SS40, SS50, SS55, SS60 (and step SS30), until the weights are updated and converged to optimum values at which the amplitudes of the high-amplitude and low-amplitude portions of the composite output signal Y are coincident with the presently set levels of the reference signal. When each of the weights is updated, the newly updated weight (newly obtained error signal value) is stored in a suitable memory (RAM of the DSP 410, for example), and compared with the weight previously stored in the memory. When an amount of change or difference between the newly updated weight value and the previously stored weight value becomes smaller than a predetermined threshold, it is determined that the weight has been converged to the optimum value. When the optimum weight values have been obtained, this indicates that the optimum directivity of the receiver antenna elements 402 has been obtained. In this case, the affirmative determination is obtained in step SS50, and the main control routine of FIG. 22 is terminated.

It will be understood from the foregoing description of the present fourth embodiment of this invention that the multiplying portions 460a-460c and the adding portion 453 of the adaptive array processing portion 450 cooperate with each other to constitute a weighted-signal generating portion operable to generate a weighted signal which is obtained by multiplying the received signals received by the plurality of receiver antenna elements 402 by respective weights for controlling a directivity of the receiver antenna elements 402 so as to maximize a sensitivity of reception of the received signals by the receiver antenna elements 402 in the direction toward the transponder in the form of the radio-frequency tag 14. It will also be understood that the adaptive control portion 451 constitutes a weight determining portion operable to determine the weights to be given to the weighted-signal generating portion such that a level of the weighted signal approaches a predetermined level of a target signal.

It will further be understood that the reference-level control portion 454 constitutes a target-signal-level setting portion operable to set the predetermined level of the target signal, while the FSK-decoding portion 440 constitutes an edge detecting portion operable to detect a rising or falling edge of an envelope of the received signals received by the plurality of receiver antenna elements 402.

It will also be understood that the received-signal A/D converting portions 412 constitute a sampling portion operable to obtain samples of the received signals received by the receiver antenna elements 402, at a predetermined time interval, such that the sampled received signals are sequentially applied to the weight determining portion, while the memory 420 constitutes a memory portion operable to store sets of data of the sampled received signals such that the sets of data are readable from the memory portion.

There will be described advantages of the interrogator 400 constructed according to the fourth embodiment described above.

In the interrogator 400, the received signals received by the receiver antenna elements 402 from the transponder in the form of the radio-frequency tag 14 are multiplied by the multiplying portions 452 of the adaptive array processing portion 450, by the weights determined by the adaptive control portion 451, for controlling the directivity of the receiver antenna elements 402 so as to maximize the sensitivity of reception of the received signals by the receiver antenna elements 402 in the direction toward the circuit element 14s of the radio-frequency tag 14. Thus, the adaptive array processing portion 450 is arranged to perform the so-called “adaptive control”. In the fourth embodiment, the weights are determined such that the levels of the positive and negative components of the high-amplitude portion of the composite output signal Y which is obtained by the adding portion 453 by combining together the received signals multiplied by the weights approach the predetermined increased levels of the positive and negative values of the reference signal (target signal), while the levels of the positive and negative components of the low-amplitude portion of the composite output signal Y approach the predetermined reduced levels of the positive and negative values of the reference signal. The present adaptive control in which the levels of the composite output signal Y of the adding portion 453 are compared with the levels of the reference signal permits a shorter length of time before the weights are converged to the optimum values, than the conventional adaptive control in which the waveform of the demodulated signal obtained by demodulation of the received signals multiplied by the weights is compared with the waveform of the reference signal, to determine the weights such that the waveform of the demodulated signal approaches the waveform of the reference signal. The conventional adaptive control requires a large volume of arithmetic operation for obtaining the demodulated signal, thereby requiring a longer length of time before the weights are converged. Unlike the conventional adaptive control, the adaptive control according to the present embodiment requires only the initial delay (above-described delay+delay 2+delay 3) for detection of the start point of the input information signal, and does not cause a delay while the weights are updated, thereby making it possible to minimize the time required for updating the weights before the weights are converged to the optimum values. Accordingly, the present interrogator 400 permits significant reduction of the time for controlling the directivity of the receiver antenna elements 402, and has a high degree of operating reliability for radio communication with the transponder.

The levels of the reference signal are set by the reference-level control portion 454, when the edge of the composite output signal Y is detected by the FSK-decoding portion 440. Accordingly, the moments at which the adaptive control is initiated and terminated can be accurately recognized. Thus, the present interrogator 400 in which the levels of the composite output signal Y are compared with the levels of the reference signal assures a higher degree of accuracy of the adaptive control, than the conventional interrogator in which the waveform of the demodulated signal is compared with the waveform of the reference signal.

Further, the adaptive array processing operation by the adaptive array processing portion 450 is performed such that the composite output signal of the adding portion 453 (which is to be demodulated by the AM-demodulating portion 430) is applied to the adaptive control portion 451, to control and update the weights. This arrangement prevents an influence of a delay which would take place, due to the number of taps of the above-described low pass filter and high pass filter used in the adaptive array processing portion 450, where the demodulated signal is applied to the adaptive control portion 451.

Various modifications may be made to the fourth embodiment described above, without departing from the principle of the fourth embodiment. Some of the modifications will be described.

(1) First Modification Wherein Reference Signal Levels are Set for a Sample Having the Largest Absolute Value

In the fourth embodiment of FIGS. 1-25, the levels of the reference signal are respectively set for predetermined samples of the received signals obtained in each period T. That is, only when the leading sample in the half of the period T is detected in step SS35 of the main control routine of FIG. 22, the control flow goes to step SS40 (more precisely, step SS42 or SS44 of the adaptive array processing routine of FIG. 25), to set the levels of the reference sign. However, the reference signal levels may be otherwise set.

For instance, the increased level of the positive value of the reference signal (target signal) is set for the high-amplitude portion, or the reduced level of the positive value of the reference signal is set for the low-amplitude portion, for only the largest absolute positive value (e.g., first sample Y0 of the composite output signal Y obtained in the period T, as shown in FIG. 21), and the increased level of the negative value of the reference signal is set for the high-amplitude portion, or the reduced level of the negative value of the reference signal is set for the low-amplitude portion, for only the largest absolute negative value (e.g., third sample Y2 obtained in the period T, as shown in FIG. 21).

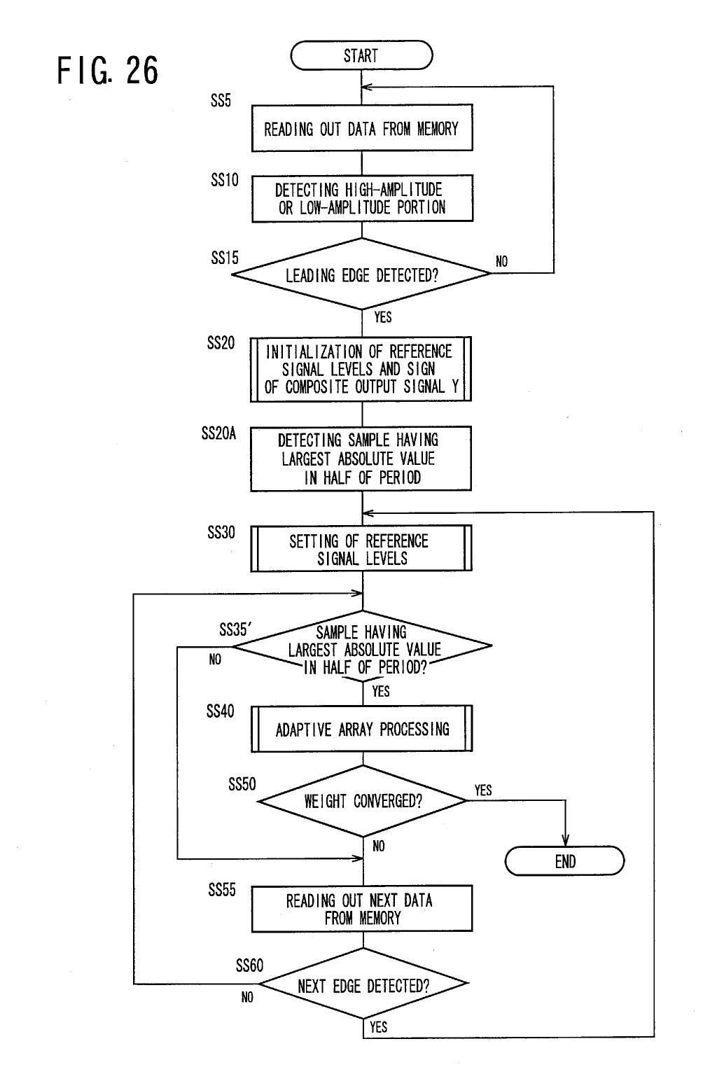

Referring to the flow chart of FIG. 26 corresponding to that of FIG. 22, there will be described an adaptive array processing operation performed by the adaptive array processing portion 450 as modified to set the levels of the reference signal (target signal) as described above. In FIG. 26, the step numbers used in FIG. 22 are used to identify the same steps.

In the main control routine of FIG. 26, step SS20A is inserted between steps SS20 and SS30. After the initial levels of the reference signal and the sign of the composite output signal Y are set in step SS20, the control flow goes to step SS20A.

In step SS20A, a sampled set of data of the received signal which has the largest absolute value in the half T/2 of the period T is detected, and the identification number of this sample is stored in a suitable memory.

Step SS20A is followed by step SS30 in which the levels of the reference signal are set. However, step SS30 is followed by step SS35′ rather than step SS35.

In step SS35′, a determination is made as to whether the set of data read out from the memory 42 is the sample which has the largest absolute value in the half period T/2 and the identification number of which is stored in the memory in step SS20A.

Only when an affirmative determination is obtained in step SS35′, the control flow goes to step SS40 to perform the adaptive array processing operation according to the levels of the reference signal set for the sample in question.

The levels of the reference signal may be set for one of samples which has the largest one of average absolute values of the samples obtained for a predetermined time period equal to a multiple of the period T.

(2) Modification Wherein Reference Signal Levels are Set for an Intermediate Sample

The adaptive control portion 451 and the reference-level control portion 454 may be arranged to zero the levels of the reference signal corresponding to a value (e.g., Y1 and Y3) intermediate or in the midpoint between the positive and negative values (e.g., Y0 and Y2; or Y2 and Y4) of the samples obtained in the period T, while the received signals received by the receiver antenna elements 402 are sampled by the received-signal A/D converting portions 412, at a time interval of (¼n)T (where n−1, 3, 5, . . . : n=1 in the example of FIG. 21).

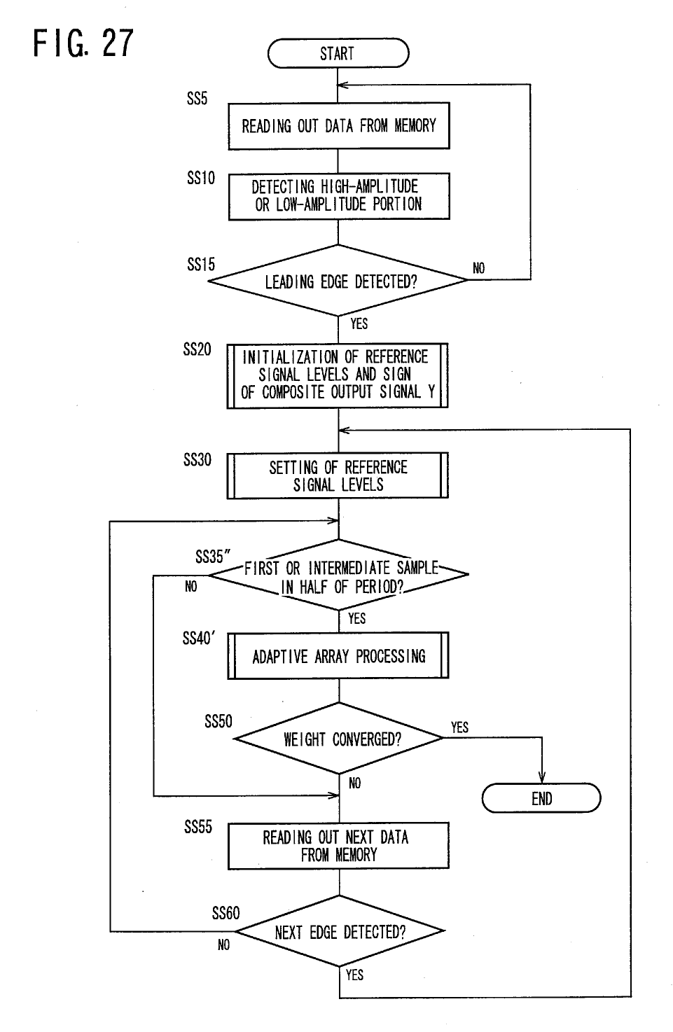

Referring to the flow chart of FIG. 27 corresponding to that of FIG. 22, there will be described an adaptive array processing operation performed by the adaptive array processing portion 450 as modified to set the levels of the reference signal (target signal) as described above. In FIG. 26, the step numbers used in FIG. 22 are used to identify the same steps.

In the main control routine of FIG. 27, steps SS35″ and SS40′ are implemented in place steps SS35 and SS40. Namely, step SS30 to set the reference signal levels is followed by step SS35′ in which the adaptive control portion 451 determines whether the identification number of the sampled set of data of the received signal read out from the memory 420 is equal to one of the predetermined identification numbers of the samples selected for the adaptive array processing operation. For example, the adaptive control portion 451 determines whether the sample read out from the memory 420 in step SS5 is the first sample (e.g., Y0, Y2, Y4, Y6, . . . shown in FIG. 21) or an intermediate sample (e.g., Y1, Y3, Y5, Y7, . . . ) obtained in each half T/2 of the period T.

The control flow goes to step SS40′ only when the affirmative determination is obtained in step SS35″.

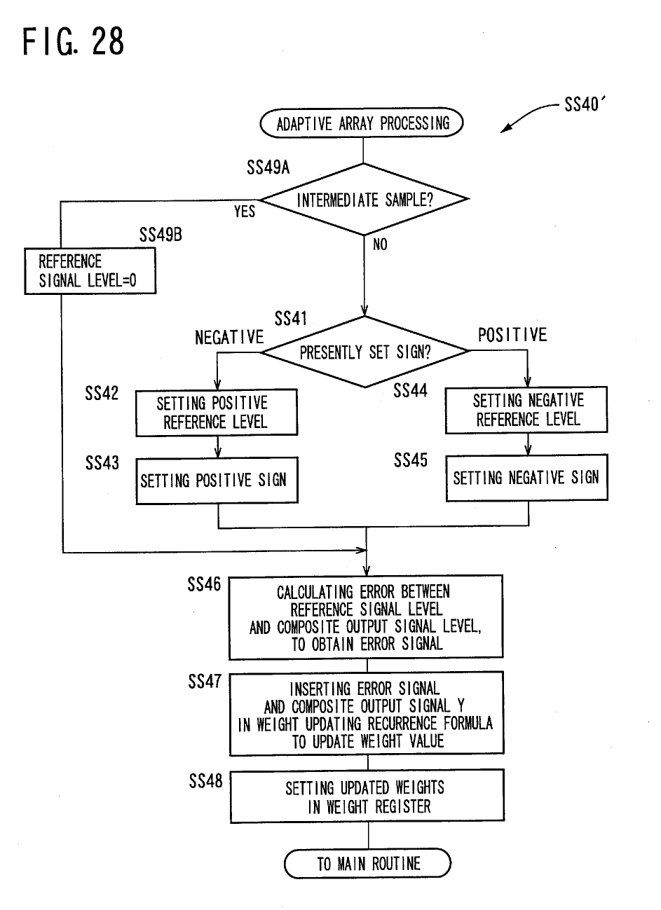

Referring to the flow chart of FIG. 28 corresponding to that of FIG. 25, there will be described in detail step SS40′ of FIG. 27 implemented by the adaptive control portion 451 and the reference-level control portion 454 when the affirmative determination is obtained in step SS35″. In FIG. 28, the step numbers used in FIG. 25 are used to identify the same steps.

In the adaptive array processing control routine of FIG. 28 executed when the affirmative determination is obtained in step SS35″ of FIG. 27, step SS49A is implemented before step SS41.

In step SS49A, the adaptive control portion 451 determines whether the sample read out from the memory 420 in step SS5 is the intermediate sample obtained in the half T/2 of the period T.

If the sample read out from the memory 420 is the first sample, that is, if a negative determination is obtained in step SS49A, the control flow goes to step SS41 and the subsequent steps, as described above by reference to FIG. 25.

If the read-out sample is the intermediate sample, that is, if an affirmative determination is obtained in step SS49A, the control flow goes to step SS49B to zero the reference signal level, and to step SS46. Accordingly, the weights are determined by using the increased and reduced levels of the reference signal for the first sample in the half T/2 of the period T, and the zero level of the reference signal for the intermediate sample.

(3) Modification Wherein Last Weight Values in Present Sampling Operation are Used as Initial Weight Values in Next Sampling Operation

In the embodiment of FIG. 22, steps SS35, SS40, SS50, SS55 and SS60 are repeatedly implemented until the weight determined or calculated for each of the multiplying portions 452 is converged to the optimum value. The adaptive array processing operation performed in step SS40 as the weight is updated from its initial value to the optimum value takes a comparatively long time, so that the sampling of an initial or preamble part of the received signal in which the desired information is included may be terminated before the weight is converged to the optimum value. In the main control routine of FIG. 22, the adaptive array processing operation is performed again with the weight set at the initial value. That is, the weight value calculated last in the present sampling operation, which is usually relatively close to the optimum value, is not used in the next sampling operation, whereby the weight calculated in the present sampling operation or adaptive array processing operation is not used as the initial value of the weight in the next sampling operation or adaptive array processing operation.

In the present modification, the weight value calculated last in the present sampling operation is utilized as the initial weight value in the next sampling operation, in the case where the sampling or reading of the preamble of the received signal is terminated before the weight is converged to the optimum value.

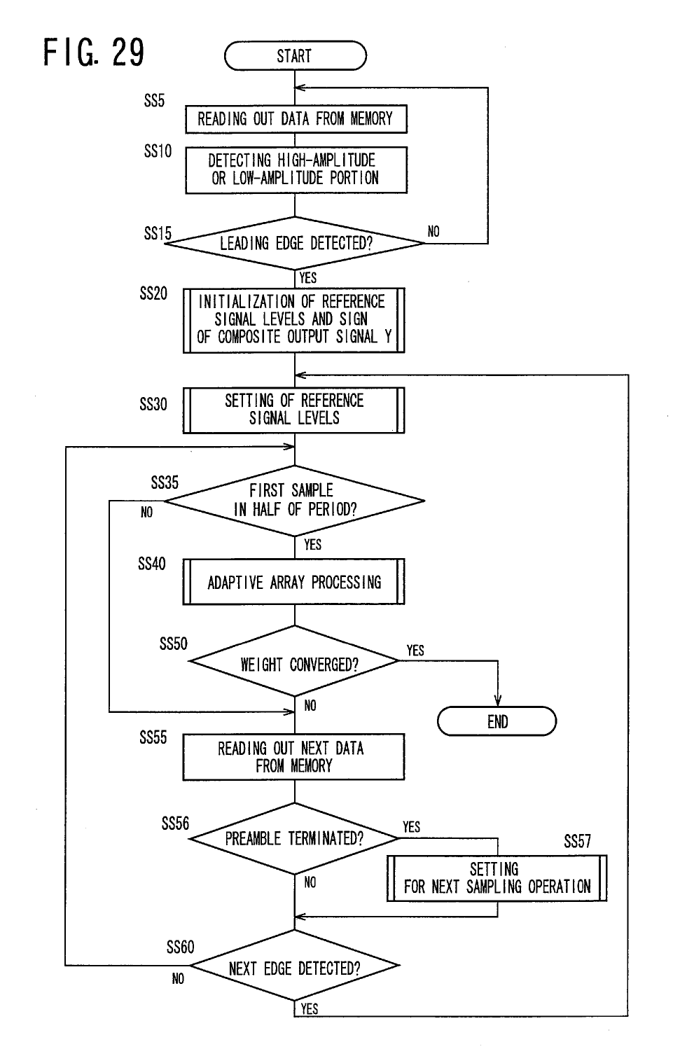

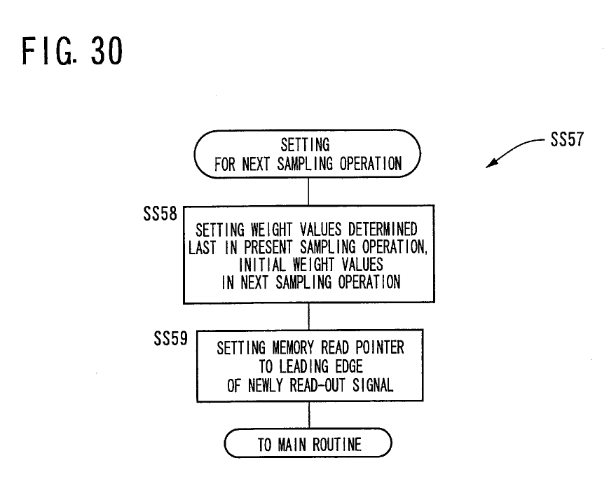

Referring to the flow chart of FIG. 29 corresponding to that of FIG. 22, there will be described an adaptive array processing operation performed by the adaptive array processing portion 450 modified as described above. In FIG. 30, the step numbers used in FIG. 22 are used to identify the same steps.

In the main control routine of FIG. 29, step SS56 is inserted between steps SS55 and SS60. That is, step SS56 is implemented after the next set of data of the received signal is read out from the memory 420.

In step SS56, the adaptive control portion 451 determines, on the basis of the set of data read out from the memory 420 in step SS55, whether the preamble of the sampling or reading of the received signal is terminated. For instance, the determination in step SS56 is based on a fact that the preamble of the received signal has a predetermined number of edges of the modulated signal. In this case, the determination in step SS56 is made by determining whether the predetermined number of edges of the modulated signal have been detected by the FSK-decoding portion 440, since the detection of the first falling edge (start point) of the modulated signal.

If a negative determination is obtained in step SS56, the control flow goes to step SS60 and the subsequent steps, as in the main control routine of FIG. 22.

If an affirmative determination is obtained in step SS56, the control flow goes to step SS57 to effect setting for the next sampling operation, so that the weight value calculated last in the present sampling operation is used as the initial weight value in the next sampling operation. Then, step SS60 and the following steps are implemented.

Referring to the flow chart of FIG. 30, there will be described in detail step SS57 implemented by the adaptive control portion 451.

The control routine of FIG. 30 is initiated with step SS58 in which the weight value calculated in the present sampling operation is set in a suitable memory as the initial value of the weight in the next sampling operation.

The control flow then goes to step SS59 in which a pointer used to specify an address of the memory 420 from which the set of data is read out is returned to the address corresponding to the first or leading edge of the modulated signal (namely, to the first rising edge corresponding to the start point of the preamble of the received signal). Step SS59 is followed by step SS60 of the main control routine of FIG. 29.

As a result of implementation of step SS59, the next edge of the modulated signal is detected, that is, the first edge of the preamble is detected in step SS60, so that the control flow goes back to steps SS30, SS35 and SS40 to initiate again the determination or calculation of the weight, beginning with the weight value set in the memory in step SS58. Thus, the weight value calculated last in the last sampling operation is utilized as the initial value of the weight, so that the weight is converged to the optimum value in a comparatively short time.

(4) Modification in which Phase of Low-Amplitude Portion is Reversed

In the main control routine of FIG. 22, the weights are determined or calculated such that the level of the positive value of the reference signal for the high-amplitude portion of the rectangular sine waveform defined by the envelope of the received signals (sine waveform of the composite output signal Y) increased to an increased absolute value, while the level of the positive value of the reference signal for the low-amplitude portion of the rectangular sine waveform is reduced to a reduced absolute value, so that the sine waveform has an increased degree of rectangularity.

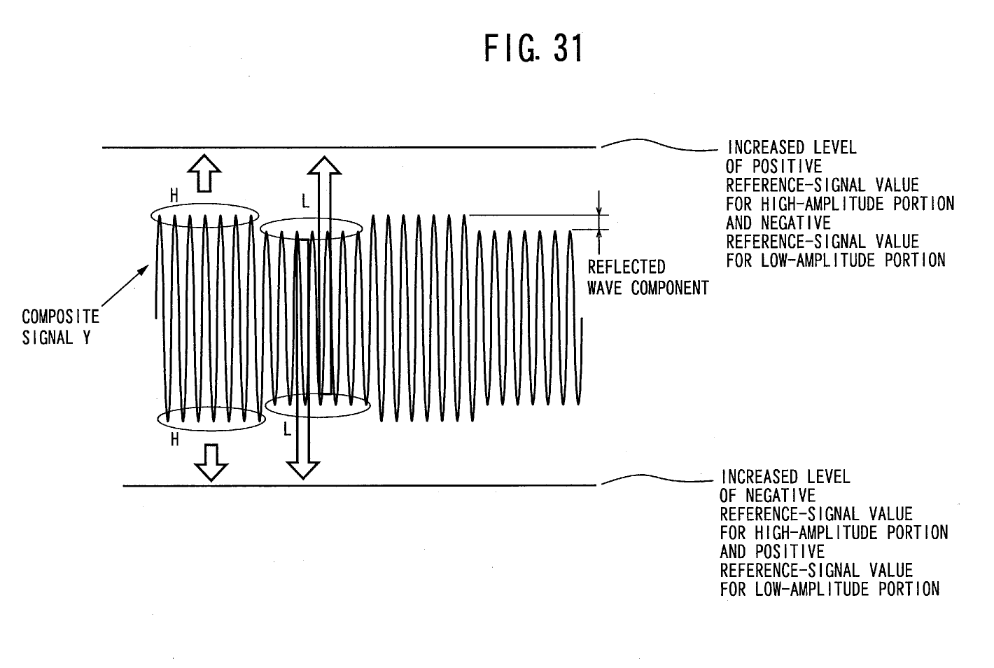

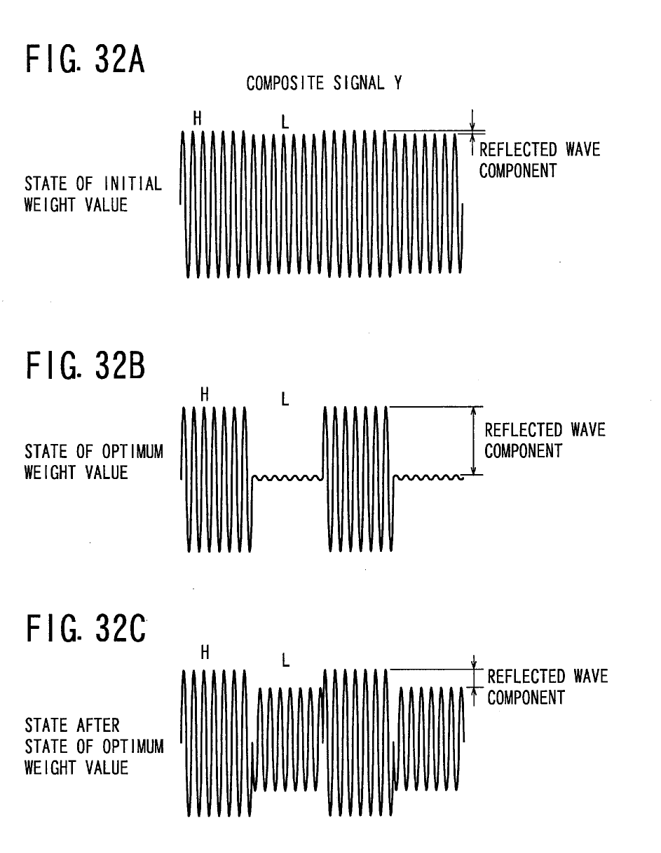

In the present modification, however, the weights are determined or calculated such that the level of the positive value of the reference signal for the low-amplitude portion is reduced toward the increased level of the negative value of the reference signal for the high-amplitude portion, while the level of the negative value of the reference signal for the low-amplitude portion is increased toward the increased level of the positive value of the reference signal for the high-amplitude portion, as indicated in FIG. 31 corresponding to FIG. 19. Thus, the phase of the low-amplitude portion is reversed with respect to that of FIG. 19. This arrangement permits a more rapid change of the composite output signal Y from a state of the initial weight value indicated in FIG. 32A to a state of the optimum weight value indicated in FIG. 32B, so that the directivity of the receiver antenna elements 402 can be optimized in a shorter time.

In the state of the optimum weight value of FIG. 32B, the composite output signal Y has the highest ratio of the reflected wave component, and therefore has the highest degree of rectangularity. If the levels of the positive and negative values of the reference signal for the low-amplitude portion of the composite output signal Y were respectively reduced and increased toward the negative values even after the state of the optimum weight value of FIG. 32B is established, the composite output signal Y would be changed to a state indicated in FIG. 32C in which the ratio of the reflected wave component is lower than the highest ratio in the state of the optimum weight value of FIG. 32B. To avoid this drawback, the main control routine is modified to monitor the radio of the reflected wave component of the composite output signal Y, and to terminate the determination or calculation of the weight when the ratio of the reflected wave component has been increased to a predetermined threshold value, that is, when the state of the optimum weight value of FIG. 32B has been established.

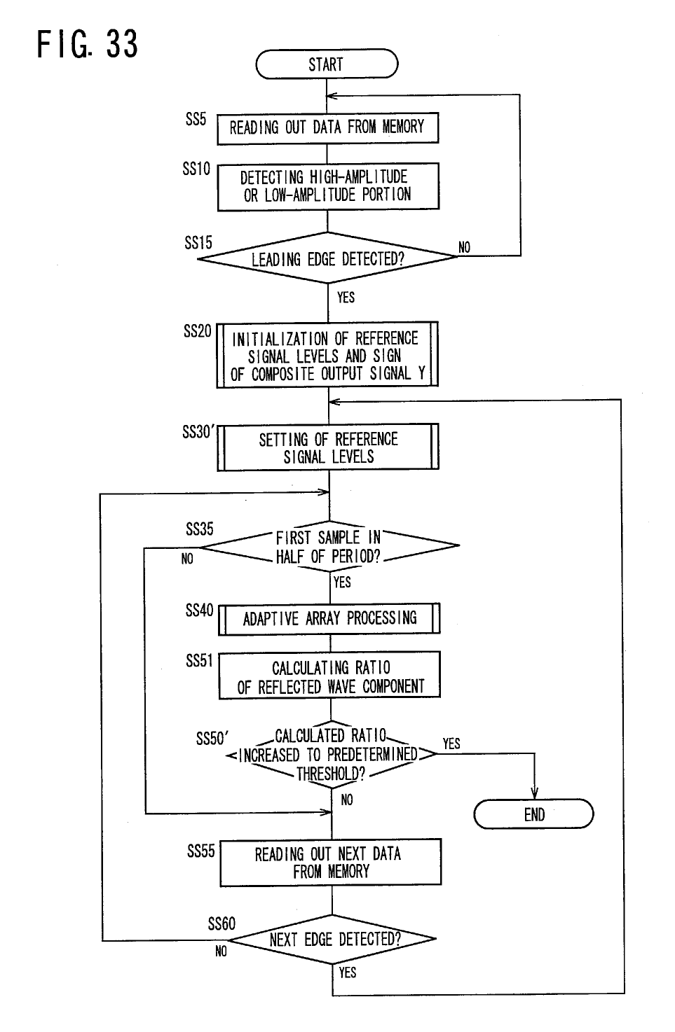

Referring to the flow chart of FIG. 33 corresponding to that of FIG. 22, there will be described an adaptive array processing operation performed by the adaptive array processing portion 450 modified as described above. In FIG. 33, the step numbers used in FIG. 22 are used to identify the same steps.

In the main control routine of FIG. 33, step SS30′ is implemented in place of step SS30. The levels of the positive and negative values of the reference signal for the low-amplitude portion of the composite output signal Y are respectively changed toward the negative and positive values, as described above by reference to FIG. 31, so that the phase of the low-amplitude portion is reversed with respect to the original phase.

Step SS30′ is followed by steps SS35 and SS40 described above by reference to FIG. 22. After step SS48 of FIG. 25 is implemented to set the calculated weight in the weight register, step SS51 is implemented.

In step SS51, the adaptive control portion 451 calculates, on the basis of the composite output signal Y received from the adding portion 453, the ratio of the reflected wave component of the composite output signal Y. Step SS51 is followed by step SS50′ to determine whether the calculated ratio of the reflected wave component has been increased to a predetermined threshold. If an affirmative determination is obtained in step S50′, the present main control routine is terminated, that is, the calculation of the weight is terminated. If a negative determination is obtained in step SS50′, the control flow goes to step SS55 and the subsequent steps.

In the modification of FIGS. 31-33, the weights to be given to the respective multiplying portions 452 are calculated such that the level of the positive value of the reference signal for the low-amplitude portion of the composite output signal Y is changed toward the negative value of the low-amplitude portion, while the level of the negative value of the reference signal for the low amplitude portion is changed toward the positive value of the low-amplitude portion which has the same absolute value as the negative value of the low-amplitude portion. Accordingly, the weights are converted to the optimum values more rapidly such that the amplitude of the low-amplitude portion is reduced, so that the directivity of the receiver antenna elements 402 can be optimized in a shorter time.

(4) Other Modifications

In the embodiment of FIGS. 17-25, the memory 420, AM-demodulating portion 430, FSK-decoding portion 440, adaptive control portion 451 and reference-level control portion 454 are functional elements of the DSP 410. However, those elements may be independent control devices separate from the DSP 410.

The interrogator 400 uses the transmitter antenna element 401 (for transmitting the transmitted wave Fc toward the radio-frequency tag 14) and the receiver antenna elements 402 (for receiving the reflected wave Fr transmitted from the radio-frequency tag 14), which are provided independently of each other. However, the interrogator may use a transmitter/receiver antenna device arranged to transmit the transmitted wave Fc toward the radio-frequency tag 14 and to receive the reflected wave Fr from the radio-frequency tag 14. In this case, the interrogator uses a transmission/reception switching device such as a circulator, to enable the transmitter/receiver antenna device to function selectively as a transmitter antenna device or a receiver antenna device.

While the interrogator 400 is used in the radio-frequency communication system S of FIG. 3, the interrogator 400 may be suitably used in a radio-frequency tag fabricating apparatus arranged to produce radio-frequency tags on which desired information is written, and a radio-frequency tag reader/write arranged to write and read desired information on and from the radio-frequency tags.

It is to be understood that the present invention may be embodied with various other changes which may occur to those skilled in the art, without departing from the spirit and scope of this invention.

1. A radio-frequency receiver device including a plurality of receiver antenna elements for receiving information from a desired communication object, said radio-frequency receiver device comprising:
an antenna switching portion configured to select at least one of said plurality of receiver antenna elements which receives a set of information transmitted from said desired communication object;
a received-information memory portion configured to store sets of information received by the plurality of receiver antenna elements sequentially selected by said antenna switching portion; and
a received-information combining portion configured to read out the sets of information from said received-information memory portion, and to combine together the sets of information read out from said received-information memory portion.

2. The radio-frequency receiver device according to claim 1, wherein said antenna switching portion selects one of said plurality of receiver antenna elements which receives the information from said desired communication objects at one time, so that the sets of information sequentially transmitted from the desired communication object are sequentially received by the plurality of receiver antenna elements.

3. The radio-frequency receiver device according to claim 1, wherein said received-information combining portion includes a phase control portion configured to control a phase of each of the sets of information read out from said received-information memory portion, and is configured to effect a phased array processing of said sets of information.

4. The radio-frequency receiver device according to claim 1, wherein said received-information combining portion includes a weight control portion configured to control weights to be given to the respective sets of information read out from said received-information memory portion, and is configured to effect an adaptive array processing of the sets of information.

5. The radio-frequency receiver device according to claim 1, wherein said antenna switching portion sequentially selects said plurality of receiver antenna elements so that the sets of information sequentially transmitted from said desired communication objects are sequentially received by the sequentially selected receiver antenna elements.

6. The radio-frequency receiver device according to claim 1, wherein said received-information memory portion stores sets of phase information included in the respective sets of information received by said plurality of receiver antenna elements.

7. The radio-frequency receiver device according to claim 1, further comprising at least one receiver circuit configured to process the sets of information received by said plurality of receiver antenna elements, and wherein a number of said at least one receiver circuit is smaller than a number of said plurality of antenna elements.

8. The radio-frequency receiver device according to claim 1, wherein said at least one receiver circuit is a single receiver circuit.

9. The radio-frequency receiver device according to claim 1, wherein said desired communication object is a radio-frequency tag capable of transmitting a reply signal in response to a transmitted signal received from a radio-frequency communication device provided with the radio-frequency receiver device.

10. A radio-frequency communication device comprising:
a plurality of antenna elements configured to receive in a non-contact fashion modulated signals which are transmitted from a signal transmitter device and which have a frequency f;
a memory portion configured to sequentially sample sets of data of said modulated signal received by said plurality of antenna elements or a signal obtained by conversion from said modulated signal and having a frequency fi, at a rate of 4nf or 4nfi (where n is a positive integer), and sequentially store the sampled sets of data, such that the last sampled set of data and a preceding set of data sampled an n-number of sampling cycles prior to the last sampled set of data are readable from said memory portion;
a transforming portion configured to obtain data of a complex signal by transformation from said last sampled set of data and said preceding set of data which are respectively used as a real-number portion and an imaginary-number portion of said complex signal; and
a control portion configured to change a directivity of said plurality of antenna elements on the basis of said data of the complex signal obtained by said transforming portion, such that said plurality of antenna elements have a maximum sensitivity of reception of said modulated signal from said signal transmitter device.

11. The radio-frequency communication device according to claim 10, wherein said control portion includes:
a weight determining portion configured to receive a signal based on a composite signal obtained by combining together the last sampled sets of data read out from said memory portion, a predetermined target output signal and the data of said complex signal, and to determine weights to be given to the respective sets of data that are combined together to generate said composite signal, such that said composite signal approaches said target output signal; and
a composite-signal generating portion configured to generate said composite signal by using said weights determined by said weight determining portion.

12. The radio-frequency communication device according to claim 10, wherein said memory portion is a shift register configured to store said last sampled set of data and said preceding set of data such that said last sampled and preceding sets of data are sequentially read out from said memory portion.

13. The radio-frequency communication device according to claim 10, wherein said memory portion has a first memory portion and a second memory portion, which alternately perform a first operation wherein said last sampled set of data is stored in said first memory portion such that said last sampled set of data is read out into said transforming portion as said real-number portion of said complex signal, while said preceding set of data is stored in said second memory portion such that said preceding set of data is read out into said transforming portion as said imaginary-number portion of said complex signal, and a second operation wherein said last sampled set of data is stored in said second memory portion such that said last sampled set of data is read out into said transforming portion as said real-number portion, while said preceding set of data is stored in said first memory portion such that said preceding set of data is read out into said transforming portion as said imaginary-number portion.

14. The radio-frequency communication device according to claim 11, wherein said composite-signal generating portion generates said composite signal by using said last sampled sets of data and said weights determined by said weight determining portion.

15. The radio-frequency communication device according to claim 14, further comprising a coefficient multiplying portion configured to multiply said data of the composite signal obtained by said transforming portion, by a predetermined coefficient, and to apply the composite signal multiplied by said coefficient, to said control portion.

16. The radio-frequency communication device according to claim 11, wherein said composite-signal generating portion generates said composite signal in the form of a complex signal by using the complex signals obtained by said transforming portion by transformation from said last sampled sets of data read out said memory portion, and said weights determined by said weight determining portion.

17. The radio-frequency communication device according to claim 14, further comprising a demodulating portion configured to demodulate said composite signal generated by said composite-signal generating portion.

18. An interrogator of a radio-frequency tag communication system, comprising:
a plurality of antenna elements configured to receive in a non-contact fashion modulated signals which are transmitted from an IC-circuit portion of a circuit element of a radio-frequency tag and which have a frequency f;
a memory portion configured to sequentially sample sets of data of said modulated signal received by said plurality of antenna elements or a signal obtained by conversion from said modulated signal and having a frequency fi, at a rate of 4nf or 4nfi (where n is a positive integer), and sequentially store the sampled sets of data, such that the last sampled set of data and a preceding set of data sampled an n-number of sampling cycles prior to the last sampled set of data are readable from said memory portion;
a transforming portion configured to obtain data of a complex signal by transformation from said last sampled set of data and said preceding set of data which are respectively used as a real-number portion and an imaginary-number portion of said complex signal; and
a control portion configured to change a directivity of said plurality of antenna elements on the basis of said data of the complex signal obtained by said transforming portion, such that said plurality of antenna elements have a maximum sensitivity of reception of said modulated signal from said signal transmitter device.

19. The interrogator according to claim 18, wherein said control portion includes:
a weight determining portion configured to receive a signal based on a composite signal obtained by combining together the last sampled sets of data read out from said memory portion, a predetermined target output signal and the data of said complex signal, and to determine weights to be given to the respective sets of data that are combined together to generate said composite signal, such that said composite signal approaches said target output signal; and
a composite-signal generating portion configured to generate said composite signal by using said weights determined by said weight determining portion.

20. An interrogator of a radio-frequency communication system, comprising:
a plurality of antenna elements configured to receive reply signals transmitted from a transponder;
a weighted-signal generating portion configured to generate a weighted signal by multiplying the received signals received by said plurality of antenna elements, by respective weights for controlling a directivity of said plurality of antenna elements so as to maximize a sensitivity of reception of the received signals by said plurality of antenna elements in a direction toward said transponder; and
a weight determining portion configured to determine said weights to be given to said weighted-signal generating portion such that a level of the weighted signal approaches a predetermined level of a target signal.

21. The interrogator according to claim 20, further comprising a target-signal-level setting portion configured to set said predetermined level of said target signal.

22. The interrogator according claim 21, further comprising an edge detecting portion configured to detect a rising or falling edge of an envelope of the received signals received by said plurality of antenna elements, and wherein said target-signal-level setting portion determines said predetermined level of said target signal according to a result of detection of said raising or falling edge by said edge detecting portion.

23. The interrogator according to claim 21, wherein said target-signal-level setting portion sets a plurality of levels of said target signal respectively corresponding to a plurality of levels of an envelope of said weighted signal, and said weight determining portion determines said weights such that said plurality of levels of said envelope respectively approach said plurality of levels of said target signal.

24. The interrogator according to claim 21, wherein said target-signal-level setting portion sets increased levels of said target signal corresponding to a high-amplitude portion of an envelope of said weighted signal, and reduced levels of said target signal corresponding to a low-amplitude portion of said envelope, and said weight determining portion determines said weights such that levels of said high-amplitude portion approach said increased levels of the target signal, while levels of said low-amplitude portion approach said reduced levels of the target signal.

25. The interrogator according to claim 24, wherein said target-signal-level setting portion sets, as said increased levels of the target signal, an increased level of a positive value of the target signal corresponding to a positive value of said high-amplitude portion and an increased level of a negative value of the target signal corresponding to a negative value of the high-amplitude portion, and as said reduced levels of the target signal, a reduced level of a positive value of the target signal corresponding to a positive value of said low-amplitude portion and a reduced level of a negative value of the target signal corresponding to a negative value of the low-amplitude portion, and said weight determining portion determines said weights such that the positive and negative values of the high-amplitude portion respectively approach said increased levels of the positive and negative values of the target signal, while the positive and negative values of the low-amplitude portion respectively approach said reduced levels of the positive and negative values of the target signal.

26. The interrogator according to claim 25, further comprising a sampling portion configured to obtain samples of said received signals received by said plurality of antenna elements from said transponder, at a predetermined time interval, such that the sampled received signals are sequentially applied to said weight determining portion, and wherein said weight determining portion determines said weights such that levels of the samples corresponding to said high-amplitude portion approach said increased levels of the positive and negative values of the target signal corresponding to the positive and negative values of said high-amplitude portion, while levels of the samples corresponding to said low-amplitude portion approach said reduced levels of the positive and negative values of the target signal corresponding to the positive and negative values of said low-amplitude portion.

27. The interrogator according to claim 26, further comprising a memory portion configured to store sets of data of said samples obtained by said sampling portion, such that the sets of data are readable from said memory portion.

28. The interrogator according to claim 26, wherein said sampling portion obtains said samples at a time interval of (½n) T, wherein “T” represents a period of said received signals received by said plurality of antenna elements from said transponder, and “n” represents a positive integer.

29. The interrogator according to claim 28, wherein said sampling portion obtaining samples of intermediate signals which are obtained by conversion form said received signals having the period T and which have a frequency lower than that of the received signals.

30. The interrogator according to claim 28, wherein said target-signal-level setting portion sets said increased or reduced level of the positive value of the target signal corresponding to a positive value of one of said samples, which one sample is obtained in said period T as said high-amplitude or low-amplitude portion, and said increased or reduced level of the negative value of the target signal corresponding to a negative value of another of said samples, which another sample is obtained in said period T as said high-amplitude or low-amplitude portion, such that a predetermined number of the samples exist between said one sample and said another sample.

31. The interrogator according to claim 30, wherein said target-signal-level setting portion determines whether each of said samples obtained in said period T has one of predetermined identification numbers of said one sample and said another sample, and sets said increased or reduced levels of the target signal in relation to said predetermined identification numbers.

32. The interrogator according to claim 30, wherein said target-signal-level setting portion sets said increased or reduced level of the positive value of the target signal corresponding to a largest one of average absolute values of the positive value of the samples obtained in said period T or for a predetermined time period equal to a multiple of said period, and said increased or reduced level of the negative value of the target signal corresponding to a largest one of average absolute values of the negative value of the samples obtained in said period or for said predetermined time period.

33. The interrogator according to claim 30, wherein said sampling portion obtains said samples at a time interval of (112n) T, and said target-signal-level setting portion zeroes the level of said target signal corresponding to a value intermediate or in the midpoint between the positive and negative values of the samples obtained in said period T.

34. The interrogator according to claim 21, wherein said target-signal-level setting portion sets the levels of positive and negative values of said target signal corresponding to respective positive and negative values of a low-amplitude portion of an envelope of said weighted signal, such that the levels of the positive and negative values of the target signal are respectively changed toward the negative and positive values of the low-amplitude portion, to substantially reverse the phase of said low-amplitude portion.

35. The interrogator according to claim 34, wherein said weight determining portion terminates determination of said weights when a ratio of a signal component which is reflected from said transponder and which is included in said weighted signal has been increased to a predetermined threshold.

36. The interrogator according to claim 20, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

37. The interrogator according to claim 21, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

38. The interrogator according to claim 22, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

39. The interrogator according to claim 23, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

40. The interrogator according to claim 24 wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

41. The interrogator according to claim 25, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

42. The interrogator according to claim 26, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

43. The interrogator according to claim 27, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

44. The interrogator according to claim 28, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

45. The interrogator according to claim 29, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

46. The interrogator according to claim 30, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

47. The interrogator according to claim 31, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

48. The interrogator according to claim 32, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

49. The interrogator according to claim 33, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

50. The interrogator according to claim 34, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.

51. The interrogator according to claim 35, wherein said transponder is a radio-frequency tag, further comprising a transmitter antenna device configured to transmit a transmitted signal toward said radio-frequency tag, and wherein said plurality of antenna elements cooperate to function as a receiver antenna device configured to receive a reply signal transmitted from said radio-frequency tag in response to said transmitted signal, whereby radio communication is effected between the interrogator and said radio-frequency tag.
